(19) United States
(12) Patent Application Publication
(10) Pub. No.: US 2018/0214247 A1
(43) Pub. Date: Aug. 2, 2018

(54) SYSTEMS AND METHODS FOR OBTURATION OF ROOT CANALS

(71) Applicant: SONENDO, INC., Laguna Hills, CA (US)

(72) Inventors: Manu Sharma, Ladera Ranch, CA (US); David Minassian, Orange, CA (US); Mehrzad Khakpour, Lagune Hills, CA (US); Bjarne Bergheim, Mission Viejo, CA (US); Daniel Alexander Hyman, Foothill Ranch, CA (US)

(21) Appl. No.: 15/787,456

(22) Filed: Oct. 18, 2017

Related U.S. Application Data
(60) Provisional application No. 62/409,766, filed on Oct. 18, 2016.
(60) Provisional application No. 62/511,915, filed on May 26, 2017.

(51) Int. Cl. A61C 5/50; A61C 5/40

(52) U.S. Cl. CPC A61C 5/50; A61C 1/087; A61C 5/40

(57) ABSTRACT

An apparatus for treating a tooth includes a delivery vessel configured to be inserted into a root canal of a tooth. The delivery vessel includes an internal lumen configured to permit the flow of an obturation material therein and at least one port positioned to supply the obturation material to the root canal from the internal lumen.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This application claims the benefit of U.S. Provisional Patent Application No. 62/409,766, filed Oct. 18, 2016, entitled “METHODS FOR OBTURATION OF ROOT CANALS,” and U.S. Provisional Patent Application No. 62/511,915, filed May 26, 2017, entitled “METHODS FOR OBTURATION OF ROOT CANALS,” each of which is hereby incorporated by reference herein in its entirety and for all purposes.

### BACKGROUND

### Field

The field relates generally to dentistry and endodontics, and to apparatus, methods, and compositions for filling treatment regions of teeth, including, e.g., root canals.

### Description of the Related Art

In conventional dental and endodontic procedures, the canal filling procedure, known as obturation, calls for the canals to be enlarged, using mechanical tools such as specialized files and drill bits. The enlargement procedure can often be painful for the patient and can result in post-procedure complications such as reinfection due to bacterial regeneration that require retreatment or even extraction, further increasing the burden on the patient in terms of pain, time, and cost. Furthermore, the enlargement of canal space inherently involves removal of tooth material, which can compromise the structural integrity of the tooth, leaving the tooth vulnerable to fracture or damage intra or post-procedure.

Following enlargement of the canals, gutta-percha points or cones are inserted into the canals, and mechanical force is applied to fix the gutta-percha points in a desired position. Differences between various techniques can include the number of gutta-percha points (single or multiple); whether heat is applied to the gutta-percha points or the gutta-percha points are introduced without heating (hot or thermoplastic versus cold); and whether the mechanical force is applied laterally or vertically. Prior to insertion of the gutta-percha points, the root canals are dried with paper points, and the gutta-percha points are coated in a paste known as a “sealer”. Complex anatomies, such as, for example, lateral canals, may be incapable of receiving gutta-percha material, and limits on the magnitude of mechanical force that can be applied to advance sealer into these complex anatomies can make filling difficult. The multi-step work flow performed for conventional obturation techniques also includes operation on the patient over an extended duration of time, approximately 10-15 minutes.

In other dental procedures, such as the filling of treated carious regions of the tooth, it can also be challenging to effectively and quickly fill the treated carious region. For example, in some procedures, a carious region may be located or may extend relatively deeply into the tooth from an exterior surface of the tooth. It can be challenging to fill and/or restore such regions using conventional procedures, and to do so in a timely manner.

As a result, there is an unmet need for dental filling procedures that are capable of filling canals with minimally or no enlargement of the canals, that include less workflow steps and increase clinical throughput, that are capable of obturating complex anatomies with a higher success rate, and/or that are capable of filling treated carious regions (including deep carious regions accessible by thin access holes in the exterior surface of the tooth).

### SUMMARY

Various non-limiting aspects of the present disclosure will now be provided to illustrate features of the disclosed apparatus, methods, and compositions. Examples of apparatus, methods, and compositions for endodontic treatments are provided.

In one embodiment, an apparatus for treating a tooth is disclosed. The apparatus can comprise a delivery vessel sized to be inserted into a treatment region of a tooth to deliver a filling material to the treatment region and a manifold coupled to a proximal portion of the delivery vessel. The manifold can comprise a chamber to receive the filling material therein. The manifold can be configured to connect to a device having an activation mechanism configured to apply sufficient pressure so as cause thinning of the filling material so as to allow the material to flow into the delivery vessel.

In another embodiment, an apparatus for treating a tooth is disclosed. The apparatus can comprise a delivery vessel sized to be inserted into a root canal of a tooth and configured to supply a filling material thereto. The delivery vessel can comprise an internal lumen configured to permit the flow of a filling material therein and at least one port positioned to supply the filling material to the root canal from the internal lumen.

In yet another embodiment, an apparatus for treating a tooth is disclosed. The apparatus can comprise a delivery vessel sized to be inserted into a treatment region of a tooth and a mixing system coupled to a proximal portion of the delivery vessel. The delivery vessel can be configured to supply a filling material to the treatment region of the tooth. The mixing system can be configured to mix a first component and a second component to form the filling material.

In yet another embodiment, an apparatus for treating a tooth is disclosed. The apparatus can comprise a delivery vessel sized to be inserted into a treatment region of a tooth. The delivery vessel can be configured to supply a filling material to the treatment region of the tooth. The delivery vessel can comprise a capillary and a reduction conduit having a distal end coupled to a proximal portion of the capillary. The reduction conduit can be defined by a stepped reduction in diameter between a first segment having a first diameter and a second segment having a second diameter smaller than the first diameter, wherein the first segment is positioned proximal to the second segment.

In yet another embodiment, an apparatus for treating a tooth is disclosed. The apparatus can comprise a delivery vessel sized to be inserted into a treatment region of the tooth. The delivery vessel can be configured to supply a filling material to the treatment region of the tooth. The delivery vessel can comprise a reduction conduit. The reduction conduit can be defined by a reduction in diameter between a first diameter at a proximal portion of the reduction conduit and a second diameter at a distal portion of the reduction conduit.

In yet another embodiment, an apparatus for treating a tooth is disclosed. The apparatus can comprise a delivery vessel sized to be inserted into a treatment region of a tooth, a manifold coupled to a proximal portion of the delivery vessel, and an access mechanism. The manifold can comprise a chamber to receive a filling material therein. The access mechanism configured to provide communication between the filling material and the chamber.

In yet another embodiment, an apparatus for treating a tooth is disclosed. The apparatus can comprise a delivery vessel sized to be inserted into a treatment region of a tooth, a chamber, and an activation mechanism. The delivery vessel can be configured to supply a filling material to the treatment region. The chamber can be configured to hold and supply at least one component of a filling material to the delivery vessel. The activation mechanism can be configured to apply sufficient pressure to the filling material so as to cause thinning of the filling material so as to allow the filling material to flow into the delivery vessel.

In yet another embodiment, a method for treating a tooth is disclosed. The method can comprise inserting a delivery vessel into a treatment region of a tooth and directing a filling material through the delivery vessel to obturate the treatment region. The delivery vessel can comprise an internal lumen configured to permit the flow of a filling material therein and at least one port positioned to supply the filling material to the treatment region from the internal lumen.

In yet another embodiment, a system for filling a treatment region of a tooth is disclosed. The system can comprise an activation mechanism. The activation mechanism can be configured to apply pressure to the filling material in a chamber. The activation mechanism can also be configured to apply a first pressure to the filling material during a first portion of a filling procedure and to apply a second pressure to the filling material during a second portion of the filling procedure, the first pressure different from the second pressure.

In yet another embodiment, an apparatus for treating a tooth is disclosed. The apparatus can comprise a delivery vessel sized to be inserted into a treatment region of a tooth. The delivery vessel can be configured to supply a filling material to the treatment region. The delivery vessel can comprise an internal lumen configured to permit the flow of a filling material therein and at least one port positioned to supply the filling material to the root canal from the internal lumen. The diameter of the internal lumen can be in a range of 50 microns to 450 microns, e.g., in a range of 200 microns to 250 microns. In some embodiments, the internal lumen can have a first diameter at a proximal end and a second diameter at a distal end. The first diameter can be in a range of 750 microns to 1,500 microns. The second diameter can be in a range of 200 microns to 250 microns.

### BRIEF DESCRIPTION OF THE DRAWINGS

The foregoing and other features, aspects, and advantages of the embodiments of the apparatus and methods of cleaning teeth are described in detail below with reference to the drawings of various embodiments, which are intended to illustrate and not to limit the embodiments of the invention. The drawings comprise the following figures in which:

FIG. 1 is a cross-sectional view schematically illustrating a root canal system of a tooth.

FIG. 2 is a schematic diagram of a system for filling treatment region of a tooth, in accordance with the embodiments disclosed herein.

FIG. 3A is a schematic side view of a delivery vessel for filling a treatment region of a tooth, in accordance with the embodiments disclosed herein.

FIG. 3B is a schematic side cross-sectional view of the delivery vessel shown in FIG. 3A.

FIG. 3C is a schematic side view of a delivery vessel for filling a treatment region of a tooth, in accordance with the embodiments disclosed herein.

FIG. 3D is a schematic cross-sectional view of a section of a delivery vessel for filling a treatment region of a tooth, in accordance with the embodiments disclosed herein.

FIG. 4A is a schematic side view of a housing of a system for filling a treatment region of a tooth, in accordance with the embodiments disclosed herein.

FIG. 4B is a schematic cross-sectional view of the housing of FIG. 4A.

FIG. 4C is a schematic side view of a housing of a system for filling a treatment region of a tooth, in accordance with the embodiments disclosed herein.

FIG. 4D is a schematic cross-sectional view of the housing of FIG. 4C.

FIG. 4E is a schematic cross-sectional view of a section of the housing of FIG. 4C.

FIG. 4F is a schematic perspective view of a section of the housing of FIG. 4C.

FIG. 4G is a schematic perspective view of a section of a housing, in accordance with the embodiments disclosed herein.

FIG. 4H is a schematic bottom view of a cap, in accordance with various embodiments disclosed herein.

FIG. 4I is a schematic cross-sectional side view of the cap of FIG. 4H

FIG. 5A is a schematic side view of a handpiece for filling a treatment region of a tooth, in accordance with the embodiments disclosed herein.

FIG. 5B is a schematic cross-sectional view of the handpiece of FIG. 5A.

FIG. 5C is a schematic cross-sectional side view of a section of the handpiece of FIG. 5A.

FIG. 5D is a schematic cross-sectional side view of a reducer conduit coupled to the handpiece of FIG. 5A.

FIG. 5E is a schematic side view of a system for filling a treatment region of a tooth including the handpiece of FIGS. 5A-5B.

FIG. 6 is a graph depicting shear-thinning measurements for obturation material, in accordance with the embodiments disclosed herein.

FIG. 7 is a graph depicting theoretical volume flow rates for obturation material, in accordance with the embodiments disclosed herein.

FIG. 8 is a graph depicting bending stress for a delivery vessel, in accordance with the embodiments disclosed herein.

FIG. 9 is a set of graphs depicting motor performance parameters for an obturation device, in accordance with the embodiments disclosed herein.

FIG. 10 is a set of graphs depicting additional motor performance parameters for an obturation device, in accordance with the embodiments disclosed herein.

FIG. 11 is a graph depicting force profiles for extruding an obturation material, in accordance with the embodiments disclosed herein

FIG. 12 is a graph depicting an example of base mass fraction distribution at a capillary outlet, in accordance with the embodiments disclosed herein.

FIG. 13 is a graph depicting base mass fraction standard deviation at a capillary outlet over time, in accordance with the embodiments disclosed herein.

FIG. 14 is a graph depicting mixing quality as a function of axial distance, in accordance with the embodiments disclosed herein.

FIG. 15 is a graph depicting cross-sectional planes at different axial locations of a system for filling a treatment region of a tooth, in accordance with the embodiments disclosed herein.

FIG. 16 is a graph depicting total base mass fraction at a capillary outlet over time, in accordance with the embodiments disclosed herein.

### DETAILED DESCRIPTION

Various embodiments disclosed herein describe devices, systems, and methods for filling a treatment region of a tooth, including, e.g., obturation of a treated root canal and filling or restoration of a treated carious region. Obturation, as referred to herein, can include holding and delivering flowable material into a range of molar, anterior, or pre-molar root canal systems to seal entries into the root canal systems. Upon delivery, the flowable material within the root canal system may be cured in various embodiments, e.g., cured by heating, exposure to light, and/or resting without application of energy to the tooth. Similarly, in various embodiments, a flowable filling or restorative material may be flowed into and/or onto the treated carious region to fill the treated region. In some embodiments, the filling or restorative region may be cured in any suitable manner.

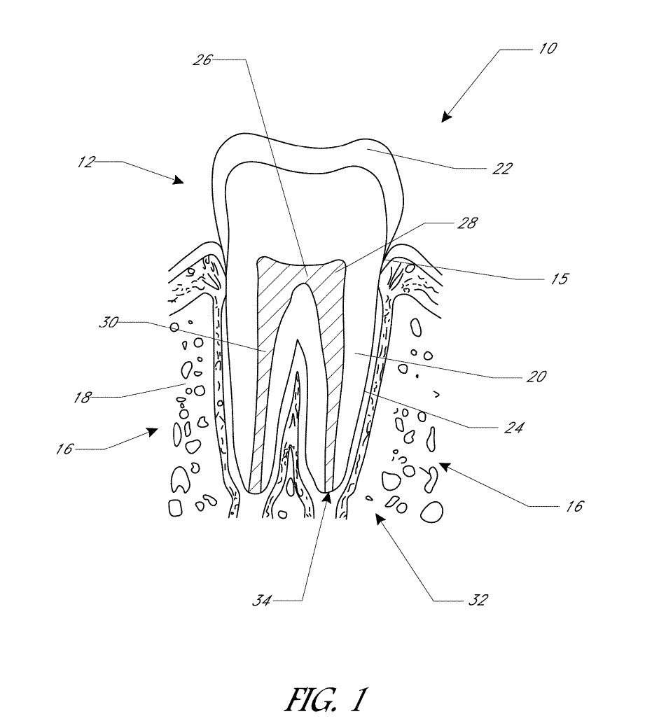

FIG. 1 is a cross-sectional view schematically illustrating an example of a typical human tooth 10, which comprises a crown 12 extending above the gum tissue 14 and at least one root 16 set into a socket (alveolus) within the jaw bone 18. The tooth 10 includes a hard layer of dentin 20 which provides the primary structure of the tooth 10, a very hard out layer of enamel layer 22 which covers the crown 12 to a cementoenamel junction 15 near the gum 14, and cementum 24 which covers the dentin 20 of the tooth 10 below the cementoenamel junction 15.

A pulp cavity 26 is defined within the dentin 20. The pulp cavity 26 comprises a pulp chamber 28 in the crown 12 and one or more root canals 30 extending toward an apex 32 of each root 16. The pulp cavity 26 and root canals 30 contain dental pulp, which is a soft, vascular tissue comprising nerves, blood vessels, connective tissue, odontoblasts, and other tissue and cellular components. The pulp provides innervation and sustenance to the tooth 10 through the epithelial lining of the pulp chamber 28 and the root canal space 30. Blood vessels and nerves enter/exit the root canal space 30 through a tiny opening, the apical foramen 34, near a tip of the apex 32 of the root 16. It should be appreciated that, although the tooth 10 illustrated herein is a molar, the embodiments disclosed herein can advantageously be used to treat any suitable type of tooth, including pre-molars, canines, incisors, etc.

### I. Overview of System and Methods

### A. Overview of Various System Components

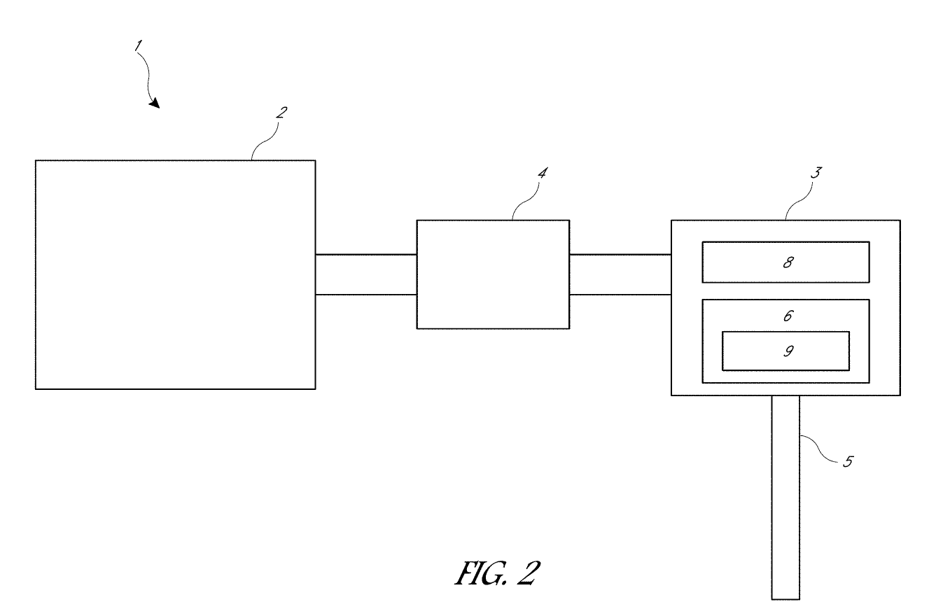

FIG. 2 is a schematic diagram of a system 1, in accordance with embodiments disclosed herein. The system 1 shown in FIG. 2 may be configured to perform various types of treatment procedures, including, e.g., obturation treatments, cleaning treatments, restoration treatments, etc. The system 1 shown in FIG. 2 can include components configured to supply a fluid, such as obturation material to the tooth, for example, to the root canal 30 of the tooth 10.

The system 1 shown and described herein can include components similar to or the same as the dental treatment system disclosed in U.S. Pat. No. 9,504,536 (“the '536 Patent”), the entire contents of which are incorporated by reference herein in their entirety and for all purposes. For example, the system 1 disclosed herein can be configured to engage with the system disclosed in the '536 Patent. In embodiments, the clinician can use the system 1 (or a different treatment system) to clean the root canal 30 prior to obturation. For example, as explained in the '536 Patent, the clinician can form an access opening in the tooth. In some embodiments, the clinician can clean the root canal 30 by positioning a fluid platform against the tooth. A pressure wave generator (such as a liquid jet, a laser, etc.) may be activated to propagate pressure waves throughout the treatment region to clean the root canal 30. In other embodiments, however, the clinician can clean the tooth using other methods and apparatus, such as using a drill, burr, or other mechanical instruments. In still other embodiments, the clinician can clean a carious region at or near an external surface of the tooth prior to filling and/or restoration.

As illustrated in FIG. 2, the system 1 can be used in filling procedures, including, e.g., obturation procedures to obturate or fill substantially all of a root canal system, for example, the root canals 30 of the tooth 10. In some embodiments, the system 1 can be used in procedures to fill a carious region in the tooth. The system 1 can include a console 2, a delivery vessel 5, and a handpiece 3. In some embodiments, the handpiece 3 can define a chamber 6 configured to receive and/or retain fluid or a flowable material, such as an obturation material or a restorative material, therein. In some embodiments, the chamber 6 is configured to receive or otherwise couple to a housing 9 for containing fluid, such as obturation material or restorative material, therein. The housing 9 can comprise a cartridge or other container suitable for housing a fluid therein. In some embodiments, the handpiece 3 can couple to the housing 9 or a chamber within the housing 9 via an engagement portion. In various embodiments, the housing 9 can comprise a housing or disposable component that can be disengaged from the system 1 after use. In some embodiments, the handpiece 3 further includes an activation mechanism 8 configured to drive the flow of fluid through the delivery vessel 5.

The delivery vessel 5 can be coupled to and/or disposed in or on the handpiece 3 in various embodiments. The delivery vessel 5 can electrically, mechanically, and/or fluidly connect to the handpiece 3. For example, in some embodiments, the delivery vessel 5 can removably couple to the handpiece 3. In such embodiments, the clinician may use the delivery vessel 5 one time (or a few times), and may dispose the delivery vessel 5 after each procedure (or after a set number of procedures). The handpiece 3 may be reused multiple times to removably couple (e.g., to connect and/or disconnect) to multiple delivery vessels 5 using suitable engagement features as discussed herein. In some embodiments, the delivery vessel 5 can be part of, disposed in, disposed on, or otherwise coupled to the housing 9. When the delivery vessel 5 is coupled to the handpiece 3, a fluid pathway may be established between the housing 9 and a distal end of the delivery vessel 5. The housing 9 can be part of, disposed in, disposed on, or otherwise coupled to the chamber 6 of the handpiece 3.

A system interface member 4 can electrically, mechanically, and/or fluidly connect the console 2 with the handpiece 3 and delivery vessel 5. For example, in some embodiments, the system interface member 4 can removably couple the handpiece 3 to the console 2. In such embodiments, the clinician may use the handpiece 3 one time (or a few times), and may dispose the handpiece 3 after each procedure (or after a set number of procedures). The console 2 and interface member 4 may be reused multiple times to removably couple (e.g., to connect and/or disconnect) to multiple handpieces 3 using suitable engagement features, as discussed herein. The interface member 4 can include various electrical and/or fluidic pathways to provide electrical, electronic, and/or fluidic communication between the console 2 and the handpiece 3. The console 2 can include a control system and various fluid and/or electrical systems configured to operate the handpiece 3 and/or delivery vessel 5 during a treatment procedure. The console 2 can also include a management module configured to manage data regarding the treatment procedure. The console 2 can include a communications module configured to communicate with external entities about the treatment procedures.

The handpiece 3 can include an activation mechanism 8 configured to drive the flow of fluid, into and through the delivery vessel 5. In some embodiments, the activation mechanism 8 can drive the flow of fluid into and through the delivery vessel 5 via a pressure differential. The activation mechanism 8 can include any type of pressure generator or pressure generator system that can move a fluid or gas including, but not restricted to: positive displacement, rotary, peristaltic, plunger, screw or cavity pumps. Such a pressure generator system can be electric, hydraulic, or pneumatic. Such a pressure generator or pressure generator system can be coupled to the chamber 6, the housing 9, and/or the delivery vessel 5 to apply a pressure to fluid within the chamber 6, the housing 9, and/or the delivery vessel 5 in order to cause the fluid to flow through the delivery vessel. The activation mechanism 8 can be configured to apply a high pressure to the filling material. The activation mechanism 8 can be configured to supply a pressure between 1-10,000 psi. In some embodiments, the activation mechanism 8 can be configured to supply a pressure of approximately 1,500 psi. In some embodiments, the activation mechanism 8 can be configured to supply a pressure of approximately 2,000 psi. In some embodiments, the activation mechanism 8 can be configured to supply a pressure of approximately 2,500 psi. In some embodiments, the activation mechanism 8 can be configured to supply a pressure greater than 50 psi, greater than 100 psi, greater than 200 psi, greater than 300 psi, greater than 400 psi 500 psi, greater than 536 psi, greater than 700 psi, greater than 800 psi, greater than 900 psi, greater than 1,000 psi, greater than 1,100 psi, greater than 1,200 psi, greater than 1,300 psi, greater than 1,400 psi, or greater than 2,000 psi. In some embodiments, the activation mechanism 8 can be configured to supply a pressure less than 1,000 psi, less than 1,500 psi, less than 2,000 psi, less than 2,500 psi, less than 3,000 psi, less than 4,000 psi, less than 5,000 psi, less than 6,000 psi, less than 7,000 psi, less than 8,000 psi, less than 9,000 psi, or less than 10,000 psi. In various embodiments, the activation mechanism 8 can be configured to apply a pressure in a range of 50 psi to 100 psi, in a range of 50 psi to 250 psi, in a range of 50 psi to 500 psi, in a range of 100 psi to 500 psi, in a range of 100 psi to 1,000 psi, in a range of 50 psi to 20,000 psi, in a range of 50 psi to 10,000 psi, in a range of 100 psi to 10,000 psi, in a range of 200 psi to 300 psi, in a range of 200 psi to 500 psi, in a range of 200 psi to 1,000 psi, in a range of 200 psi to 10,000 psi, in a range of 500 psi to 1,000 psi, in a range of 500 psi to 10,000 psi, in a range of 500 psi to 9,000 psi, in a range of 500 psi to 8,000 psi, in a range of 750 psi to 7,000 psi, in a range of 750 psi to 5,000 psi, in a range of 750 psi to 4,000 psi, in a range of 750 psi to 3,000 psi, in a range of 1,000 psi to 3,000 psi, or in a range of 1,200 psi to 2,500 psi.

In some embodiments, the system 1 can include a control system and various electrical systems configured to operate the activation mechanism 8. The control system can include various controllers that include processing electronics configured to control operation of the system. The control system can comprise one or more processors configured to execute instructions stored in a non-transitory computer-readable memory device in order to control the operation of the system. In various embodiments, the control system can be disposed in or on the console 2. In other embodiments, the control system can be disposed in or on the handpiece 3. For example, the control system control can include the ability to change the supplied pressure in order to meet desired performance parameters of fluid volume flow rate based upon fluid physiochemical properties. For example, as explained herein, the control system can comprise a motor controller configured to control the motor speed of a motor that is configured to apply pressure to the filling material by way of an intervening drive element. Any type of fluid could be delivered via this system including, but not restricted to: Newtonian fluids; and non-Newtonian fluids such as shear thinning (rheopectic), shear thickening (dilatant), thixotropic or Bingham plastic liquids. Knowledge of the fluids' viscoelastic and physiochemical properties can allow the control of volume flow rate via the pressure differential supplied by the activation mechanism 8 and the diameter and length of the delivery vessel 5. In some embodiments, the system 1 can be configured to deliver fluid to the treatment region at a flow rate of between 0.1 mL/min to 1 mL/min. In some embodiments, the system 1 can be configured to deliver fluid to the treatment region at a flow rate of between 0.1 mL/min to 0.3 mL/min, between 0.1 mL/min to 0.5 mL/min, or between 0.3 mL/min to 0.5 mL/min. Beneficially, such relatively high flow rates can fill the treatment region quickly as compared with other filling procedures.

The housing 9 can include one or more internal chambers configured to house a fluid, such as an obturation material, therein. In some embodiments, the housing 9 can be configured to receive or couple with one or more cartridges or containers configured to house fluid, such as an obturation material therein. For example, the housing 9 can include one or more recesses or chambers configured to receive a cartridge or container housing obturation material therein. The housing 9 can receive a portion of the activation mechanism 8 through an opening at a proximal end of the housing 9. In operation, the activation mechanism 8 can cause the fluid within the internal chamber of the housing 9 to flow from the housing 9 into the delivery vessel 5. In some embodiments, the housing 9 includes a drive element, such as a piston or plunger, capable of moving within the housing 9 to cause the flow of fluid therein. The plunger can create a seal along the sidewalls of the internal chamber of the housing 9 so that fluid is confined to the section of the internal chamber between the plunger and the interface between the housing 9 and the delivery vessel 5. The plunger can be positioned to receive a portion of the activation mechanism 8 to cause movement of the piston or plunger within the housing 9.

In some embodiments, the housing 9 and/or chamber 6 are configured to receive a fluid, such as a filling material (e.g., an obturation material or a restorative material), from one or more reservoirs. For example, one or more reservoirs housing a fluid may be positioned within the handpiece 3 or the console 2. Fluid can be drawn from the one or more reservoirs and into the chamber 6 and/or housing 9 prior to delivery through the delivery vessel 5. In some embodiments, one or more fluids can be drawn from different reservoirs within the system 1 to mix within the chamber 6 and/or housing 9. In some embodiments, the reservoirs may be connected to the chamber 6 and/or housing 9 through one or more supply lines. The supply lines can include one or more valves configured to open to permit the flow of fluid to the chamber 6 and/or housing 9.

In some embodiments, the delivery vessel 5 can comprise an internal lumen and one or more ports at a distal end of the delivery vessel 5. The delivery vessel 5 can be configured to supply a fluid, such as obturation material, to the tooth via the one or more ports. The internal lumen can be shaped and sized to allow for the flow of fluid, such as obturation material, therein. In some embodiments, the internal lumen can have a uniform cross-sectional area along the entire length of the delivery vessel 5.

A diameter of the internal lumen can be in a range of 10 microns to 450 microns, in a range of 10 microns to 400 microns, in a range of 25 microns to 400 microns, in a range of 50 microns to 450 microns, in a range of 50 microns to 400 microns, in a range of 50 microns to 350 microns, in a range of 50 microns to 300 microns, in a range of 100 microns to 400 microns, in a range of 100 microns to 350 microns, in a range of 100 microns to 300 microns, in a range of 125 microns to 350 microns, in a range of 125 microns to 300 microns, in a range of 125 microns to 250 microns, in a range of 10 microns to 200 microns, in a range of 30 microns to 150 microns, e.g., approximately 100 μm, in a range of 50 microns to 100 microns, in a range of 100 microns to 200 microns, in a range of 200 microns to 300 microns, or in a range of 300 microns to 400 microns. In some embodiments, the diameter of the internal lumen can be 150 μm, 180 μm, 200 μm, 220 μm, 250 μm, or 350 μm, or approximately 150 μm, 180 μm, 200 μm, 220 μm, 250 μm, or 350 μm.

Although dimensions and ranges of dimensions are provided for various diameters of delivery vessels disclosed herein, it should be appreciated, however, that the components of delivery vessel (e.g., capillaries and reduction conduits, etc.) may or may not be circular in cross-section. In various embodiments, delivery vessels can be polygonal, elliptical, or any other suitable cross-section. In such embodiments, the dimensions provided for the diameters described herein can correspond to major dimensions of the cross-sectional shape of the delivery vessels.

In some embodiments, the internal lumen can taper between a proximal end of the delivery vessel 5 and a distal end of the delivery vessel 5. In some embodiments, an outer diameter of the delivery vessel 5 can taper between a proximal end of the delivery vessel 5 and a distal end of the delivery vessel 5 to facilitate access to canal geometry of various sizes.

In some embodiments, the delivery vessel 5 can include one or more angles or curved segments. The angled or curved can facilitate access into deep regions of the root canal and/or complex root canal geometries. The delivery vessel 5 can also be of a sufficient flexibility to allow for navigation through any canal. For example, in some embodiments, the delivery vessel 5 can be sufficiently flexible to allow for insertion into deep regions of the root canal, which may be curved. For example, in some embodiments, a distal end of the delivery vessel 5 is pivotable relative to a proximal end of the delivery vessel 5 by at least 15°, at least 30°, at least 45°, at least 60°, at least 75°, at least 90°, at least 115°, at least 130°, at least 145°, at least 160°, at least 175° or at least 180°. In some embodiments, the delivery vessel 5 can have a bend radius of greater than 3 mm, greater than 5 mm, greater than 10 mm, or greater than 15 mm.

In some embodiments, the delivery vessel 5 can comprise a capillary device. In some embodiments, the delivery vessel 5 can include a series of capillary devices. In some embodiments, one or more capillary device in a series of capillary devices can be tapered to a different degree along the axial dimension in order to conform best with different root canal geometries.

In some embodiments, the delivery vessel 5 can include a reducer conduit and a capillary device. The reducer conduit can include an inlet opening at a proximal end, an outlet opening at a distal end, and an internal lumen extending between the inlet opening and the outlet opening. The proximal end of the reducer conduit can couple to chamber 6 and/or housing 9 to receive fluid from the chamber 6 and/or housing 9 into the inlet opening. A distal end of the capillary can couple to a proximal end of the reducer conduit to receive fluid from the outlet opening of the reducer conduit. The internal lumen of the reducer conduit may taper between the proximal end and the distal end. In some embodiments, the reducer conduit can include a series of segments. In some embodiments, each segment can be tapered to a different degree along the axial dimension. In some embodiments, each segment has a constant cross-section, and the constant cross-sections decrease between adjacent segments from the proximal end to the distal end of the reduction conduit. In some embodiments, the reduction conduit includes one or more tapered interfaces connecting adjacent segments. In some embodiments, the reduction conduit includes one or more stepped reductions in diameter between adjacent segments. In some embodiments, the delivery vessel 5 can include a plurality of reducer conduits.

In some embodiments, an outlet port can be positioned at the distal-most end of the delivery vessel 5. In some embodiments, one or more outlet ports can be positioned in a side wall of the delivery vessel near the distal end of the delivery vessel 5. The delivery vessel 5 can be positioned such that fluid flowing through the delivery vessel can flow out of the outlet(s) and into a treatment are area of the tooth.

In some embodiments, the distal-most end of the delivery vessel 5 can be capped or sealed. The cap or seal can prevent the flow of fluid out of the distal-most end of the delivery vessel 5. The cap or seal can be formed of a material having a sufficient thickness or durability to prevent puncture during insertion of the delivery vessel 5 into the tooth. In such embodiments, the delivery vessel can include ports located circumferentially, in order to direct the extrusion flow path. Furthermore, these ports could be located at different axial distances with different diameters in order to preferentially control and direct extruded material delivery to different depths inside the tooth.

An outer diameter of the delivery vessel 5 can sized and shaped to allow for the delivery of fluid, such as obturation material, to various regions within the root canal or other treatment region (such as a treated carious region of the tooth). For example, an outer diameter of the delivery vessel 5 can be sized and shaped to allow for delivery of a fluid, such as obturation material, within approximately 1 mm to 4 mm of the canal apex 14. In some embodiments, an outer diameter of the delivery vessel 5 can be sized and shaped to allow for delivery of a fluid, such as obturation material, within approximately 1 mm to 2 mm of the canal apex 14. In various embodiments, the outer diameter can be in a range of 50 μm to 400 μm, in a range of 50 μm to 350 μm, in a range of 50 μm to 300 μm, in a range of 100 μm to 400 μm, in a range of 100 μm to 350 μm, in a range of 150 μm to 350 μm, in a range of 200 μm to 400 μm, or in a range of 200 μm to 350 μm. In some embodiments, an outer diameter is less than or equal to approximately 250 μm. In some embodiments, the outer diameter is between 200 μm to 250 μm. In some embodiments, the outer diameter is between 250 μm to 300 μm. In some embodiments, the outer diameter is between 300 μm to 350 μm. In some embodiments, the outer diameter can be 150 μm, 180 μm, 200 μm, 250 μm, or 350 μm.

One or more of the components of system 1, for example, the handpiece 3, the housing 9, and/or the delivery vessel 5, can be biocompatible. In some embodiments, components of system 1, for example, the handpiece 3, the housing 9, and/or delivery vessel 5, can facilitate obturation in the presence of residual intrinsic fluids, such as blood, and/or residual external fluids, such as EDTA and water moisture.

The system 1, as shown in FIG. 2, can be used to fill or obturate the root canal 30, as shown in FIG. 1, with an obturation material. For example, the clinician can clean the root canal 30 in any suitable way, such as by using drills or files, or by using a pressure wave generator, in accordance with the embodiments described herein. When the root canal 30 is cleaned, the clinician can supply the obturation material in its flowable state to the pulp cavity 26, canals 30, or other internal chambers of the tooth 10 through the delivery vessel 5. In other embodiments, the system 1 can be used to fill or restore a treated carious region at or near an external surface of the tooth. For example, in some cases, the carious region may be disposed relatively deep under the surface of the tooth and can be accessed by way of a small access hole. In some embodiments, the delivery vessel can be sized so as to be inserted into the small access hole to fill the treated carious region. The embodiments disclosed herein may be used to fill or restore any suitable treatment region of the tooth.

The obturation material can be any suitable obturation material disclosed herein. In particular, the obturation material can have a flowable state in which the obturation material flows through the treatment region to fill the root canals 30 and/or pulp cavity 26. The obturation material can have a hardened state in which the obturation material solidifies after filling the treatment region.

In some embodiments, system 1 can monitor the dental obturation procedure. The system can comprise of electrical or mechanical hardware combined with software processing capable of sensing, providing feedback and control of the material flow rate. Other properties of interest such as material temperature, material viscosity or total injection time could also be monitored, and displayed visually as information for the user.

In some embodiments, the system 1 can facilitate filling of the root canal 30 after treatment of the root canal 30 with a file having a minimum file size of 15-04 and/or a maximum file size of 60-06.

In some embodiments, the system 1 can facilitate filling of the root canal 30 with minimal extrusion of obturation material through the apex 14 of the root canal.

In some embodiments, system 1 can facilitate performance of obturation procedures having a significant reduction in duration in comparison to conventional obturation techniques. For example, in some embodiments, the duration of an obturation procedure using the system 1 can be less than five minutes. In some embodiments, extrusion of material into the root canal 30 is performed over a duration of no longer than 60-90 seconds using the system 1.

In some embodiments, system 1 can facilitate filling of the root canal 30 with high homogeneity of the filled regions such that little or no voids or pockets exist in filled regions. In some embodiments, system 1 can facilitate filling of complex root canal regions of the root canal 30 including, but not limited to apical deltas, isthmuses, lateral canals, and strongly curved canals. In some embodiments, system 1 can facilitate sealing of the root canal. In some embodiments, the system 1 can facilitate total or near total filling of the root canal.

In some embodiments, the system 1 can be operated to provide continuous or near continuous flow of obturation material into the root canal 30. For example, the components of the system 1 disclosed herein can include features that operate to prevent or reduce clogging or other flow blockage phenomena within the system 1.

Various systems and devices are disclosed herein that can be used in addition to the described obturation devices to provide root canal treatment with minimal instrumentation. For example, various embodiments of pressure wave generators, including those disclosed in the '536 Patent, can be operated to perform cleaning procedures within a root canal prior to obturation.

In some embodiments, a radiation source, such as a laser, can be coupled to the delivery vessel 5. The radiation source can illuminate a root canal, to enhance visibility, for example, and/or to treat fluid delivered to the root canal, for example, to cure the fluid. In some embodiments, a pressure wave generator (e.g., the radiation source, a jet device, etc.) can generate pressure waves to assist in filling the root canal, in a similar manner as described in US 2015/0147718, which is hereby incorporated by reference herein in its entirety and for all purposes. In some embodiments, the pressure wave generator can generate pressure waves having a broadband power spectrum.

In some embodiments, the delivery vessel 5 is capable of both being a delivery vessel for filling material and a fiber optic light pipe transmitting electromagnetic radiation with wavelengths ranging from nanometers to microns. In such embodiments, the system 1 can comprise hardware and software for optical delivery, with variation or fixed software settings of light exposure time and intensity. The delivery of light could be used for visualization of the internal tooth structure or to cure photosensitive filling materials, for example, obturation materials.

In some embodiments, a delivery vessel can include a first lumen configured to deliver fluid to a treatment region of a tooth and a second lumen housing a fiber optic light pipe therein. In some embodiments, the fiber optic light pipe may be positioned adjacent to the delivery vessel. In some embodiments, the fiber optic light pipe may couple to an external surface of the delivery vessel.

In some embodiments, the system 1 may include a plurality of fiber optic light pipes. For example, in some embodiments, a plurality of fiber optic light pipes may be distributed around an internal lumen of the delivery vessel configured to deliver fluid to a treatment region of the tooth. Alternatively, a fiber optic annulus may surround or partially surround the internal lumen configured to deliver fluid to the treatment region.

In some embodiments, separate fiber optic light pipes are employed for visualization of the internal tooth structure and for curing photosensitive filling materials. For example, in some embodiments, a first fiber optic light pipe can be used for visualization of the internal tooth structure and a second fiber optic light pipe can be used for curing photosensitive filling materials. In some embodiments, a single fiber optic light pipe can be used to deliver light for both visualization of the internal tooth structure and for curing photosensitive filling materials.

### B. Overview of Treatment Procedures

Various embodiments disclosed herein may be used to obturate a root canal of a tooth after cleaning, and/or to fill a portion of a treatment region after cleaning, e.g., a treated carious region. Various methods can be used to clean a treatment region of a tooth prior to obturation. For example, in some embodiments, a pressure wave generator can be used to clean diseased materials, bacteria, and other undesirable materials from the root canal of the tooth. In other embodiments, the pressure wave generator can clean a carious region from an outer surface of the tooth. When the treatment region (e.g., root canal, carious region, etc.) is substantially clean, the clinician can obturate or fill the treatment region with a suitable obturation material. For example, in a root canal treatment, the clinician may fill the canals with the obturation material in order to prevent bacteria or other undesirable materials from growing (or otherwise forming) in the canal spaces after treatment. Accordingly, to protect the long-term health of the tooth, it can be advantageous to substantially fill the canal spaces of the tooth, including the major canal spaces as well as minor cracks and spaces in the tooth. The filling or obturation material can be cured or hardened to form the final material. Indeed, it should be appreciated that setting, curing, hardening, etc. may all refer to processes by which initial components are transformed into the final material. It should be appreciated that each of the obturation materials (and also the handpieces) disclosed herein may be used in conjunction with filling root canals after root canal treatments and/or with filling treated carious regions after treatment. Thus, the use of the term “obturation material” should be understood to mean a material that is configured to fill root canals and/or treated carious regions of the tooth. Similarly, as used herein, obturating or filling a treatment region should be understood to mean a procedure in which a treatment region is filled or restored, e.g., filling a root canal or a treated carious region of a tooth.

In conventional obturation techniques, a significant portion of the canal can be filled with solid phase (gutta percha cones) and only minor volume filled with liquid phase (sealer). In some of the treatment procedures described herein, the entire volume or substantially the entire volume of the root canal system can be filled with liquid phase.

Following treatment and drying of the root canal system using, for example, pressure wave generators as described herein, the delivery vessel 5 can be inserted into the canal until a certain depth. After user activation, material can be delivered at the desired location inside the tooth. Additional material can be deposited via cycling through manual steps of retraction and extrusion into the canal until the canal is filled to a desired amount and the process repeated for each canal. Alternatively, the delivery vessel 5 can be retracted by a user during extrusion of the filling materials such that a canal can be filled to the desired amount continuously without a cease in extrusion.

In some embodiments, automated methods of obturation can be utilized to fill a treatment region of a tooth. For example, the system 1 can perform hardware and software control of capillary axial movement, such as insertion or retraction, and dispensing metered aliquots of obturation material.

In some embodiments, the systems described herein can be utilized to accurately place the delivery vessel 5 at a desired depth inside the canal. Placement can be performed using a mechanical based system involving a depth-measurement tool, or based upon electrical or optical phenomena. For example, in some embodiments, system 1 can include an electronic apex locator for determining a length of the canal. An apex locator can include a first electrode and a second electrode. In use, the first electrode can be secured to a section of oral tissue, such as an oral mucous membrane of a patient, and the second electrode can be advanced towards the apex. Impedance measures can be used to determine the location of the second electrode. For example, in some embodiments, the electrical conductivity of the periodontal tissue at the apical foreman is greater than the electrical conductivity inside the root canal. In such embodiments, impedance measurements can be used to detect contact of the second electrode with the periodontal tissue. The detection of contact between the second electrode with the periodontal tissue can indicate reaching of the apex. In some embodiments, the second electrode is attached to a distal end of an instrument such as a reamer or file.

In some embodiments, the second electrode of an apex locator may be attached to a distal end of the delivery vessel 5. In some embodiments, an apex locator may be coupled to the delivery vessel 5 and/or the handpiece 3. In some embodiments, the apex locator is a separate instrument. The apex locator can be used as a depth measurement tool, to provide an indication of the depth of the canal. Thus, the apex locator can be utilized to accurately place the delivery vessel 5 at a desired depth inside the canal.

In some embodiments, the systems described herein can be operated to monitor a dental obturation procedure. For example, electrical or mechanical hardware combined with software processing capable of sensing, providing feedback and control of the material flow rate can be utilized to monitor the dental obturation procedure. Other properties of interest such as material temperature, material viscosity or total injection time could also be monitored, and displayed visually as information for the user.

In addition, the handpiece 3 can be used to deliver multiple materials, or a mixture of multiple materials, to the treatment region (e.g., root canal). For example, in some embodiments, multiple materials can be mixed at the handpiece 3 or downstream of the handpiece. The resulting mixture can be supplied to the treatment region by the handpiece 3 (e.g., by the delivery vessel 5). In some embodiments, the multiple materials can be mixed, partially or entirely, within the housing 9. In some embodiments, the multiple materials can be mixed, partially or entirely, within the delivery vessel 5. In other arrangements, multiple materials can be delivered to the treatment region and can be mixed at the treatment region, such as within the tooth.

It should be appreciated that the filling material and procedural parameters for the activation mechanism 8 may be selected such that the filling material is flowable as it fills the canal or treatment region, and then once it fills the canals or treatment region, it can be hardened. For multiple component mixtures, for example, the reaction rate between the components, the mixing rate of the components, and the fill rate of the filling material can at least in part determine whether the obturation is effective. For example, if the fill rate is less than the reaction rate, then the composition may harden before filling the treatment region. If the fill rate is faster than the mixing rate of the two components, then an inhomogeneous mixture may result in the canals or treatment region. Accordingly, it can be important so select combinations of compositions such that the material is able to flow fully into the treatment region before it hardens and such that the compositions mix well before it fills the treatment region and hardens. In addition, for single component materials, the material and curing method can be selected such that the filling material does not harden before it fills the treatment region.

### II. Examples of Filling Materials

### A. Non-Limiting Examples of Obturation Materials

Various types of obturation or filling materials may be suitable with the embodiments disclosed herein. In some embodiments, the obturation or filling material can comprise two or more components that react with one another to form a hardened obturation material. In other embodiments, the obturation or filling material can comprise a composition that is curable from a flowable state to a hardened state by way of an external trigger (e.g., light, heat, etc.). Still other types of obturation materials may be hardened by precipitation, by the addition of moisture, by drying or evaporation, or by combination with a catalyst or initiator.

1. Sealer-Based Materials

Various obturation materials used with the embodiments disclosed herein may include sealer-based materials. Sealers include materials that are traditionally used to seal and occupy the spacing between the core root filling gutta-percha cones and the inner root wall. In traditional techniques, the sealers occupy a minimal volume fraction inside the root canal system. In the embodiments described herein, an obturation material consisting of entirely sealer-based materials or mostly sealer-based materials can be used to fill the entire root canal system or nearly the entire root canal system. Sealer-based materials can act as lubricant, have an anti-bacterial effect and, via compaction, are forced into canal system geometries, such as dentin tubules and accessory canals, that the gutta-percha itself cannot penetrate. Some sealer-based materials, materials including mineral trioxide aggregate (MTA) for example, can have cement-like properties, facilitating adhesion between the sealer-based material and the dentin wall.

2. Multi-Component Obturation Materials

Various obturation materials used with the embodiments disclosed herein may include two components that are mixed prior to entering the tooth, or that are mixed inside the tooth or at the treatment region. The components may comprise one or more chemical compounds. For example, a first, flowable carrier component, X, may act as a flowable carrier material and may act to flow through the treatment region to fill the treatment region (e.g., the root canal system). A second filler component, Y, may comprise a material that is a solid, a semisolid, a powder, a paste, a granular material, a liquid-containing granular material, a solution containing particles (such as nanoparticles), a liquid containing gas, a gas, or any other physical form. In various arrangements, the first flowable component X may have physical properties (such as viscosity) closer to water than the second component Y. In some embodiments, the second flowable component X is configured to be delivered by way of the delivery vessel 5 in connection with the handpiece 3. The second filler component Y may also be delivery by way of the delivery vessel 5. In some embodiments, the second filler component Y may be delivered by a separate pump or delivery mechanism that may or may not be synchronized with and/or coupled to the handpiece 3. In some embodiments, the second filler component Y may comprise a material that is placed into the treatment region by hand, needle, or any other delivery mechanism before, during, or after the introduction of the first flowable component X.

The filler component Y may be mixed with the flowable component X in the console 2, somewhere along the high pressure flow path between the handpiece 3 and the console 2, in the handpiece 3 (e.g, in a reservoir or cartridge within the handpiece 3), or at the treatment region (e.g., in the tooth chamber or root canals). The flowable component X may dissolve or carry filler material Y with itself into the treatment region of the tooth. The filler component Y may be applied directly into the tooth, and flowable component X may be supplied and flowed through the treatment region with the delivery vessel 5. In some embodiments, hydroacoustic and hydrodynamic effects created by a pressure wave generator may dissolve or activate filler material Y. Other triggers may also be used, e.g., light, heat, etc. The flowable component X may be sufficiently degassed such that the resulting mixture of flowable component X and filler component Y is also adequately degassed.

The physical properties of the obturation material may be controlled such that the obturation material can be delivered into the treatment region of the tooth by way of the delivery vessel 5 to provide adequate filling and sealing before the properties of the obturation material changes and/or before the obturation material sets or is cured. The setting/curing time may be controlled such that adequate mixing is obtained and adequate filling and sealing is obtained before the obturation material sets. In one embodiment, the entire filling process is completed in about 5 seconds or less. In other embodiments it may take up to about 30s, 60s, or 5 minutes for proper and adequate filling and sealing to occur.

The second fillable component Y may be provided inside a housing or reservoir that is disposed in or near the handpiece 3. As explained above, the housing can be provided at the handpiece 3 or upstream from the handpiece 3. The housing or reservoir may contain the filler component Y, which may or may not be degassed. In embodiments in which the cartridge is upstream of the handpiece 3, the cartridge may provide features that allow for sufficient mixing with adequate uniformity of components X and Y before entering the handpiece. In embodiments in which the reservoir or cartridge is disposed in the handpiece 3, the components X and Y can be suitably mixed in the handpiece 3 just prior to being supplied to the treatment region of the tooth. In still other arrangements, the components X and Y are maintained separate from one another in the handpiece 3 and are mixed together at or near the treatment region of the tooth. In various embodiments, the cartridge or reservoir may be disposable. The handpiece can also be disposable.

3. Other Examples of Multi-Component Obturation Materials

In some embodiments, the filling or obturation material may be hardened by utilizing a multi-component (e.g., two component) chemically curable system. Hardening of such systems may comprise mixing of stoichiometric or approximately stoichiometric relative amounts of initially separate components, herein termed component A and component B, which can then undergo chemical reactions to form a hardened material. In some arrangements, the mixing of components may be done by volume or other suitable measure. Mixing may occur immediately prior to delivering the material into the root canal system (or other treatment region), or mixing may occur within the root canal system or treatment region after simultaneous, consecutive, or alternating delivery of both parts into the tooth through diffusion. For example, in some embodiments, component A and component B can be mixed in the handpiece 3, in the housing 9, and/or in the delivery vessel 5. The components A and B can therefore be delivered as a mixture to the tooth. In other embodiments, component A and component B can be delivered to the tooth along separate fluid pathways and can be mixed in the tooth. In some embodiments, component A and B can be introduced to the treatment region concurrently. In other embodiments, component A can be introduced to the treatment region, then component B can be introduced to the treatment region. In still other embodiments, component A can be delivered to the tooth, then component B can be delivered to the tooth, then component A can be delivered to the tooth, component B can be delivered to the tooth, and so on, until the treatment region is filled. Any suitable order or permutation of material delivery may be suitable. Mixing may also be assisted by agitation provided by the pressure wave generators disclosed herein.

In some embodiments, one of component A and component B can be a base and the other of component A and component B can be a catalyst. In some embodiments, the base-to-catalyst volume ratio of component A and component B can be 1:1, 2:1, 3:1, 4:1, 5:1, 6:1, 7:1, 8:1, or any other suitable ration. In some embodiments, one or both of the base and catalyst can have a density of 1950 kg/cm³. In some embodiments, one or both of component A and component B are shear thinning. With reference to Equation 5, discussed herein, the base can have a reference viscosity of 124 and a power law coefficient of 0.43. The catalyst can have a reference viscosity of 101 and a power law coefficient of 0.1. In some embodiments, component A and component B can each be a component of GuttaFlow® 2, a two-part material consisting of a base and a catalyst.

In some embodiments, the hardening reaction may comprise the addition of suitably reactive functional groups of the first component A to strained cyclic functional groups present in the second component B. Examples include, without limitation, reactions between oxirane or oxetane groups and nucleophilic functional groups, including the known epoxy-amine and epoxy-thiol systems. In one embodiment, component A may comprise diepoxy functionalized prepolymers. The prepolymers can advantageously be hydrophilic, which may facilitate penetration of the uncured liquid deep into small spaces within the root canal system, such as side canals and dentinal tubules. However, hydrophobic prepolymers may also be suitable. The prepolymers may include without limitation poly(alkylene glycol) diglycidyl ether, and may further comprise poly(glycidyl ether) crosslinking prepolymers including without limitation trimethylolpropane tri(glycidyl ether), ethoxylated trimethylolpropane tri(glycidyl ether), pentaerythritol tetra(glycidyl ether), ethoxylated pentaerythritol tetra(glycidyl ether), and the like. Component B may comprise hydrophobic and, advantageously, hydrophilic polyamine compounds including without limitation poly(alkylene oxide) diamines such as poly(ethylene glycol) di(3-aminopropyl ether). The obturation material may further contain radio contrast agents in the form of fine powders dispersed in part A or part B, or both. Suitable radio contrast agents include without limitation barium sulfate, bismuth oxychloride, bismuth carbonate, calcium tungstate, zirconium dioxide, ytterbium fluoride, and other suitable agents.

In another embodiment, the hardening reaction may comprise ionic crosslinking of anionically functionalized polysaccharides with multivalent cations. Component A may comprise a solution of an anionic polysaccharide and component B may comprise a solution of salts and polyvalent metal cations. The solvents in components A and B may be identical or they may be mutually miscible. One example solvent for components A and B may be water; however, other solvents may also be suitable. In one embodiment, the anionic polysaccharide may be selected from alginic acid and its salts with monovalent cations. One non-limiting example is sodium alginate, as explained in more detail below. The multivalent cation may be selected from earth alkaline metal salts or other cations that form stable chelates with the anionic polysaccharide. In one embodiment, the multivalent cation can be divalent calcium. Multivalent cations of metals with high atomic numbers may be added to impart radiopacity. Non-limiting examples of high atomic number cations include divalent strontium and barium salts.

In yet another embodiment, the hardening reaction may comprise a reaction between acid-dissolvable metal oxide solids and polyacids in the presence of water. Component A may comprise a metal oxide solid as a powder, dispersed in water, or other, water miscible, liquid. For the purposes of this disclosure, the term metal oxide is to be understood as broadly defined to include other basic acid-dissolvable inorganic salts, minerals, compounds, and glasses that may contain anions other than oxide anions such as phosphate, sulfate, fluoride, chloride, hydroxide, and others. Component B may comprise a solution of a polyacid in water or other, advantageously water miscible, liquid. An amount of water sufficient to at least partially support the setting reaction can be present in part A or part B, or both. The polyacid can undergo an acid-base reaction with the generally basic metal oxide, which may lead to the release of multivalent metal cations that form ionic crosslinks with the at least partially dissociated anionic polyacid to form a stable hardened matrix. Examples for suitable polyacids include without limitation polycarboxylic acids such as poly(acrylic acid), poly(itaconic acid), poly(maleic acid) and copolymers thereof, and may also be selected from polymers functionalized with other acidic functional groups such as sulfonic, sulfinic, phosphoric, phosphonic, phosphinic, boric, boronic acid groups, and combinations thereof. Examples of suitable basic metal oxides include without limitation zinc oxide, calcium oxide, hydroxyapatite, and reactive glasses such as aluminofluorosilicate glasses which may further contain calcium, strontium, barium, sodium, and other metal cations. In one embodiment, radio contrast agents as defined above may further be present in component A or component B, or both. In another embodiment, the material may further contain a hardenable resin composition that is curable by exposure to actinic radiation such as ultraviolet or visible light. The presence of a radiation curable resin may allow the practitioner to command cure at least part of the composition following the filling procedure to advantageously provide an immediate coronal seal. The radiation curable resin may be present in component A or component B, or both.

In yet another embodiment, the hardening reaction may comprise addition polymerization of silicone prepolymers that proceed with or without addition of catalysts. A non-limiting example of this reaction is a hydrosilylation addition to vinyl groups. Suitable silicone prepolymers may be selected from poly(diorgano siloxane) additionally substituted with reactive functional groups. Poly(diorgano siloxane) prepolymers of the general formula Z1-[R1R2SiO2]n-Z2 include without limitation poly(dialkyl siloxane) wherein R1 and R2 comprise identical or different alkyl radicals, poly(diaryl siloxane) wherein R1 and R2 comprise identical or different aryl radicals, and poly(alkyl aryl siloxane) wherein R1 and R2 comprise alkyl and aryl radicals. A suitable, non-limiting example for a poly(dialkyl siloxane) is poly(dimethyl siloxane); however other linear or branched alkyl substituents may be suitable. In one embodiment, component A may comprise vinyl functionalized silicone prepolymers including without limitation poly(diorgano siloxane) prepolymers carrying at least one vinyl group. Non-limiting examples are vinyl terminated poly(dimethyl siloxane) where Z1 and Z2 are vinyl groups, and copolymers of dialkyl siloxane and vinyl alkyl or vinyl aryl siloxane where R1 or R2 is a vinyl group in at least one repeat unit. Component B may comprise hydrosilane functionalized silicone prepolymers including without limitation vinyl hydride terminated poly(dimethyl siloxane) wherein Z1 and Z2 are hydrogen, and copolymers of dialkyl siloxane and hydro alkyl or hydro aryl siloxane wherein R1 or R2 is hydrogen in at least one repeat unit. Advantageously, the hydrosilane prepolymer can be functionalized with at least two, three or more hydrosilane groups. A polymerization catalyst may be added to either part A or part B. Examples of suitable catalysts include platinum catalysts such as hexachloroplatinic acid or Karstedt's catalyst (platinum(0)-1,3-divinyl-1,1,3,3-tetramethyldisiloxane complex).

Optionally, additives such as polymerization mediators and retarders may further be present in component A or component B, or both. Advantageously, the composition may further contain surfactants to facilitate penetration of the uncured liquid into small spaces within the root canal system. In some embodiments, radio contrast agents as defined above may further be present in component A or component B, or both. In one embodiment, component A and component B may be non-reactive in the absence of a suitable catalyst. In such an embodiment, components A and B may be combined prior to delivery. In some arrangements, components A and B may be stored in combined form for extended periods of time. The setting reaction may be induced by adding a suitable catalyst to the composition immediately prior to or following delivery of the composition into the root canal system, which advantageously obviates the mixing of the two components A and B in pre-defined ratios during delivery.

4. Gel-Based Obturation Materials

In various embodiments, the filling material used to fill the treatment region of a tooth (e.g., a tooth chamber, a root canal system, a treated carious region of a tooth) can include Fa gel-based material such as polymer molecules dissolved in water or hydrogel. In some arrangements, the polymer molecules can form a gel as soon as the molecules are in contact with water molecules. In various arrangements, other types of polymer molecules may form a gel following a trigger when the molecules are already in an aqueous solution. For example, the trigger can comprise heat, the addition of a composition having a predetermined pH, and/or chemical reactions between the polymer molecules and a different compound (such as a gelifying initiator). In some embodiments, the gel-based obturation materials may also comprise a multi-component obturation material, e.g., a polymer-ionic compound reaction, a polymer-polymer reaction, etc.

In some embodiments, the gelification (e.g., solidification) of a polymer solution (e.g., sodium alginate) in the presence of ionic compounds (e.g., calcium) may be used to obturate a root canal system. A liquid solution of polymers (e.g., sodium alginate) can be delivered into the treatment area, e.g. inside the tooth. Once the delivery of the solution (which may be three-dimensional and/or bubble-free) is complete, gelification can be achieved by, for example, providing ionic compounds to the solution. An ion-based (e.g., calcium-based) liquid may be delivered, or a calcium-based material (for example calcium hydroxide) may be applied, somewhere inside the tooth (or just prior to being delivered to the tooth) to contact the polymer. The calcium in this material can diffuse into solution and initiate the gelification of the material inside the tooth.

The gelification process can occur at different rates as a function of the availability of ions to the polymer compound. Gelification time scales can range from a fraction of a second to minutes, hours, etc. During an obturation or filling procedure, it can be important to precisely control the rate of gelification. For example, if gelification occurs too rapidly, then the obturation material may harden before it has fully filled the treatment region. Furthermore, rapid gelification may result in a non-homogenous mixture of materials, which may result in a poor obturation. On the other hand, if gelification occurs too slowly, then the obturation procedure may take too much time, creating discomfort for the patient and reducing efficiency of the treatment procedure. Accordingly, it can be desirable to control the rate of gelification such that the obturation procedure is relatively fast, while also ensuring that the obturation material is substantially homogenous and that the obturation material substantially fills the treatment region.

In some embodiments, a pressure wave generator can be used to help control the gelification process. For example, the pressure wave generator can cause pressure waves to propagate through the obturation material, which can assist in causing the obturation material to flow through substantially the entire treatment region. For example, for root canal obturation procedures, the pressure wave generator can cause obturation material to flow through the major canal spaces, as well as the tiny cracks and spaces of the tooth. In addition, if the gelifying initiator (e.g., calcium particles or a calcium compound) is coated with an encapsulant, the pressure wave generator can be activated to break up the encapsulant to cause the release of the gelifying initiator. The pressure wave generator can be controlled to cause the release of the gelifying initiator at the desired rate. For example, if the gelification rate is to be increased, the energy supplied by the pressure wave generator may be increased to increase the rate at which the gelifying initiator is released. If the gelification rate is to be decreased, then the energy supplied by the pressure wave generator may be decreased to decrease the rate at which the gelifying initiator is released.

In other embodiments, another control mechanism may be the rate of ions released into the solution. For example, the ions can be supplied directly by means of concentrated solutions of triggering ions. If the concentrated solutions are supplied at a higher flow rate, then the gelification may occur at a faster rate. If the concentrated solutions are supplied at a lower flow rate, then the gelification may occur at a slower rate.

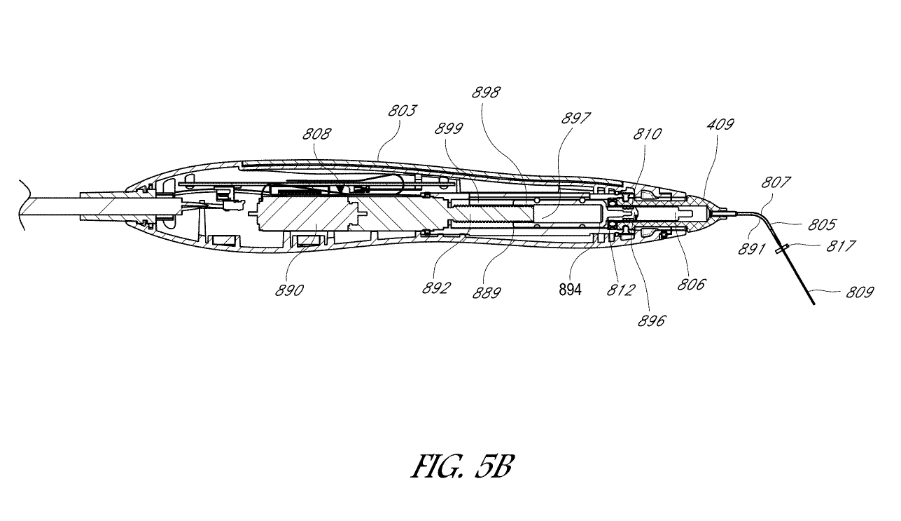

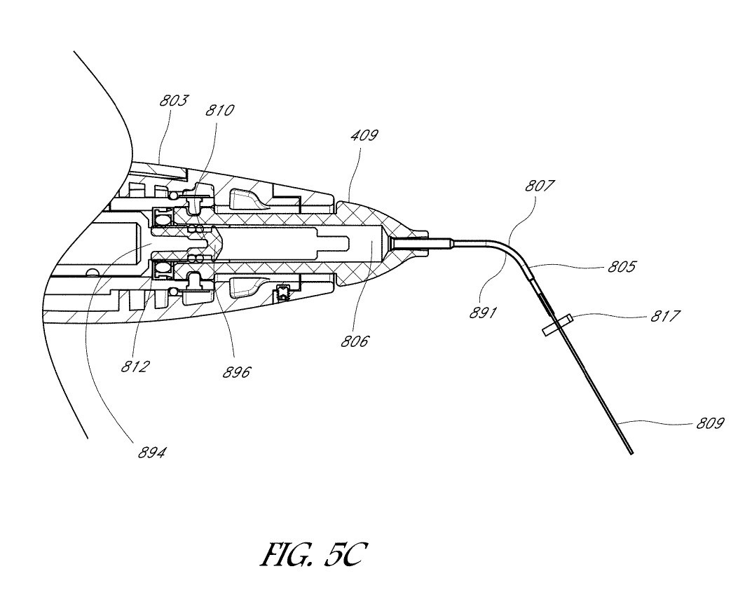

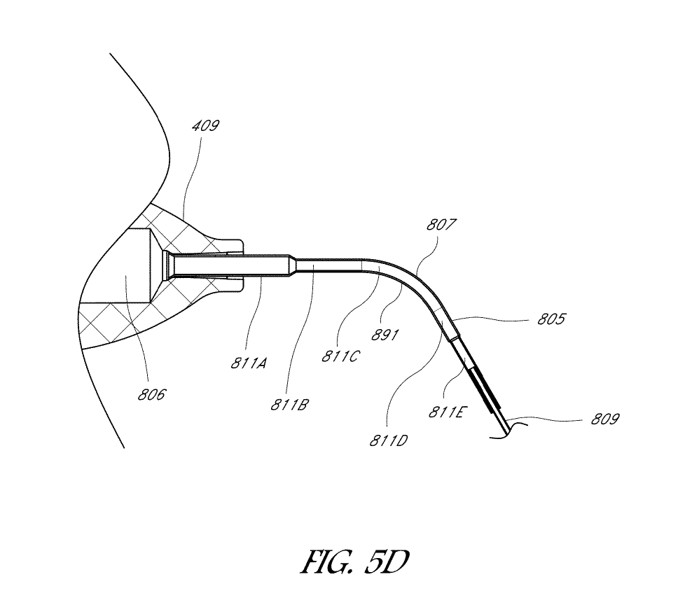

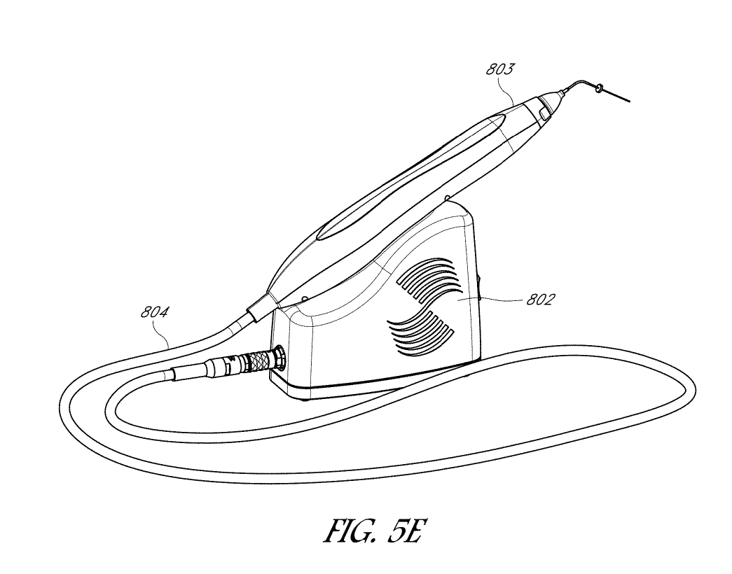

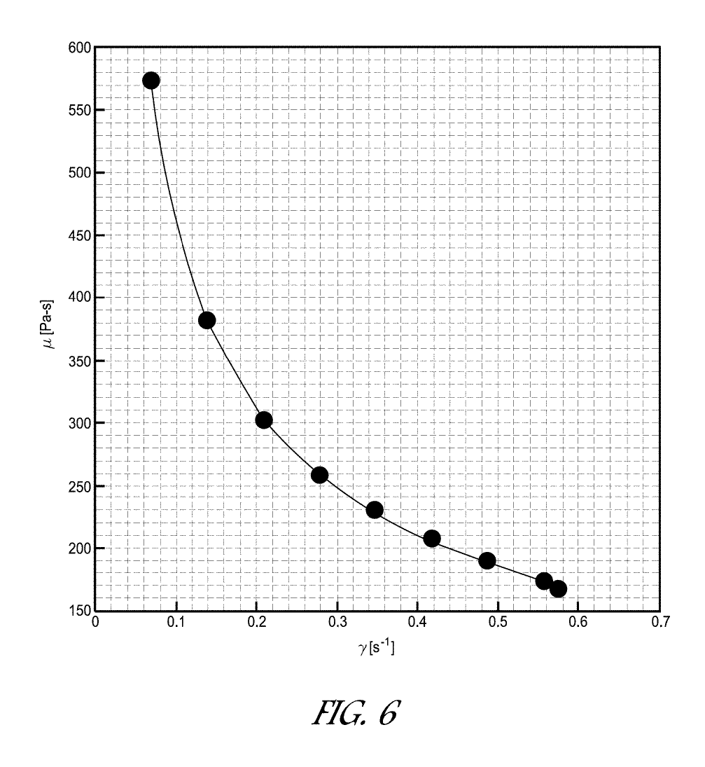

One example of a multi-composition obturation material may be formed by a trigger comprising an ionic reaction between two or more materials. In such arrangements, an obturation base material can be reacted or mixed with a gelifying initiator or agent. For example, sodium alginate (a flowable base material) may be in a liquid form when dissolved in water with a very low level of cations, but can gelify substantially instantaneously when in the presence of a gelifying initiator (e.g., calcium ions, potassium ions, etc.). When in a flowable state, the sodium alginate can be delivered into the treatment region of the tooth (e.g., the tooth chamber, root canal spaces, carious region, etc.) by way of the disclosed handpieces FIG. 5A-5C, or by any other suitable delivery devices. The sodium alginate solution can gelify upon exposure to calcium or calcium containing compounds.

In some embodiments, the sodium alginate and calcium-containing compound can be delivered separately and can be mixed in the treatment region of the tooth. For example, in such embodiments, one outlet of the handpiece can deliver the sodium alginate to the tooth, and another outlet can deliver the calcium-containing compound to the tooth. The sodium alginate and calcium ions can react in the treatment region of the tooth. In other embodiments, the sodium alginate and calcium-containing compound can be mixed and reacted in the handpiece just prior to being delivered to the tooth. For example, the calcium-containing ions may be combined with the sodium alginate in a reservoir just prior to exiting the handpiece, such that the composition remains flowable. In yet other embodiments, coated calcium particles can be provided within the flowable sodium alginate solution. An encapsulant that coats the calcium particles can be broken or dissolved to release calcium when agitated, for example, by acoustic or shear forces that can be imparted on the particles by a pressure wave generator or other source. Although sodium alginate is one example of a base obturation material, any other suitable base material can be used, such as agar, collagen, hyaluronic acid, chondroitin sulfate, ulvan, chitosan, collagen/chitosan, chitin/hydroxyapatite, dextran-hydroxyethyl methacrylate, and/or pluronic. Furthermore, a radiopaque material may also be mixed with the obturation material to assist with radiographic visualization of obturation or filling for reimbursement (insurance) and assessment purposes.

In some embodiments, the ionic solution or gelifying initiator may be dispensed by way of a syringe and needle. In other embodiments, the ionic solution may be dispensed by a handpiece including a pressure wave generator, such as that disclosed herein. In one embodiment, the ionic solution or gelifying initiator may be dispensed by saturated cotton positioned in the pulp chamber of the tooth. As disclosed herein, in some arrangements, calcium compounds may be introduced into the polymer solution and trigger gelification. The solubility of the particular calcium compound may be used to control the time for the gel to form. As an example, calcium chloride can initiate immediate gel formation due to its high water solubility, whereas the use of calcium sulfate or calcium carbonate can delay gel formation because of their lower solubility in water. In various embodiments, gelification may be achieved by ions that may be naturally provided by the surrounding dentin. Ions can diffuse from the dentin into the polymer solution (e.g., sodium alginate) and trigger gelification.

In some embodiments, ions (e.g., calcium) may be provided by common dental compounds such as dental sealers, calcium hydroxide or mineral trioxide aggregate (MTA). The dental compound may be applied anywhere in the proximity of the solution, for example, at the top of the canal and can initiate gelification by diffusion. Calcium rich compounds may also be introduced into the canals as points (e.g., calcium hydroxide points).

In some embodiments, the gelifying initiator (e.g., ions) may be encapsulated in nano/microspheres that are dispersed in the polymer solution. When subjected to high shear or oscillation, or any other chemical or physical phenomena, the encapsulating shell may be torn and ions can be released into the polymer solution within the root canal system or other treatment region. Such release can induce gelification of the polymer solution within the root canal. As explained above, in some arrangements, activation of a pressure wave generator can cause the encapsulating shell or encapsulant to break apart, which can control the gelification of the polymer solution. In some embodiments, ion-enriched microspheres or particles that are not subject to shear or that are shear resistant may be dispersed into solution within the root canal system. Once full obturation is achieved (e.g., assisted by the pressure wave generator in some embodiments), the particles or microspheres can slowly dissolve into solution, thereby initiating gelification. In some embodiments, light or heat can be applied to the encapsulated initiator to cause the release of the initiator.

In various embodiments, ions (e.g. calcium) may be introduced into solution by flowing the polymer solution (e.g. sodium alginate) through an ion (e.g. calcium) enriched capillary tube (e.g. guide tube or needle). By flowing through the tube, ions are introduced into solution and thereby can initiate gelification.

Further, when using sodium alginate as a base material for gel formation, various types of ions may be used. For example, cross-linking of the polymers can be achieved using divalent ions. Divalent ions that may be used as a gelifying initator may include Ca²⁺, Ba²⁺, Sr²⁺, Mg²⁺, and/or Fe²⁺. In some embodiments, barium (Ba²⁺), may be used under its barium sulfate form as a gelifying agent or initiator. Advantageously, barium sulfate is also a radiopaque compound, such that barium sulfate may serve as a dual purpose compound, allowing for full gelification as well as radiopaque control of the proper extent of obturation.

In some embodiments, instead of using sodium alginate as a base obturation material, Kappa-Carrageenan can be used in conjunction with an initiator that includes potassium ions. In other embodiments, Iota-Carrageenan can be used in conjunction with an initiator that includes calcium ions. In some embodiments, the polymer base material may be a poly(carboxylate) polymer. For example, the polymer base material may include poly(acrylic acid), poly(methacrylic acid), copolymers of acrylic and itaconic acid, copolymers of acrylic and maleic acid, or combinations thereof. These polymers can be cross-linked through reaction with di- or trivalent cations, such as Ca²⁺, Zn²⁺, and/or Al³⁺.

In various embodiments, crosslinking may be achieved through a glass-ionomer reaction, e.g., an acid-base reaction between a poly(carboxylic acid) and a reactive, ion-leachable glass in the presence of water. The reactive, ion-leachable glasses may comprise a fluoroaluminosilcate glass. The reactive fluoroaluminosilcate glass may further comprise calcium, barium, or strontium ions, and may further comprise phosphates and/or borates. In various embodiments, the polymer can be gelified via a reduction-oxidation reaction (redox) when in the presence of ions. It should be appreciated that, while the examples above discuss the use of hydrogels, the examples are non-limiting and the same concepts may apply to organogels.

In various embodiments disclosed herein, the gel can comprise a polymer matrix that traps fluid within its structure. For example, in the case of a hydrogel, this trapped fluid is water. The physical mechanical properties of the matrix may be controlled based on, for example, concentration of polymer or molecular properties (e.g. High M or High G grade in the case of sodium alginate). The matrix formed after gel formation (e.g. cross-linking) may exhibit various physical properties such as, for example, viscosity, strength, elasticity or even “mesh” size. The physical properties of the gel matrix may be tailored by way of the gel formation process. For example, in one embodiment, the physical properties of the obturation material may be controlled by generation of a gel using cross-linking. In various arrangements, the physical properties may be controlled by generation of a gel using thermally sensitive polymer molecules. In one embodiment, the physical properties may be controlled by generation of a gel using polymer molecules with free radicals, e.g., free radical polymerization.

In some embodiments, the physical properties of the obturation material may be controlled by combining more than one polymer (e.g. two polymers A & B). The molecules of polymer A may be linked to molecules of polymer B. For example, each polymer B molecule may be linked to polymer A molecules such that a matrix A-B-A-B . . . is formed. The link may be covalent or ionic in various embodiments. Click chemistry may be used to control this process in some arrangements. In some embodiments, polymer A may be selected from epoxy prepolymers, while polymer B may selected from amine prepolymers. The epoxy prepolymer can comprise at least two reactive epoxy (oxirane) functional groups and may be selected from bis(glycidyl ether) of bisphenol-type oligomers, bis(glycidyl ether) of poly(alkylene glycol) oligomers, triglycidyl ether of trimethylolpropane, triglycidyl ether of ethoxylated trimethylolpropoane, poly(glycidyl ether) of pentaerythritol, and the like. The amine prepolymer may comprise bis(aminoalkyl) poly(alkylene glycol), ethylenediamine, diethylenetriamine, triethylenetetramine, poly(ethylene imine), and the like. In other embodiments, polymer A may comprise a poly(isocyanate) and polymer B may comprise a polyol. In other embodiments, different types of polymers may be formed. For example, the compound may include copolymers that are randomly distributed. In some embodiments, block copolymers may be used. In various arrangements, polymerization and cross-linking can happen at the same time.

The polymer matrix may also be formed because of thermo-sensitivity of the molecule, in various arrangements. The physical mechanical properties of a gel (e.g. “mesh” size) may be adjusted to control the resistance of a gel to different chemical components, compounds or organisms. For example, the physical mechanical properties of a gel (e.g. “mesh” size) may be adjusted to trap organisms (e.g. bacteria) and prevent their proliferation after obturation. Trapping of bacteria may induce starvation or desiccation of the micro-organisms, which may induce death of the micro-organism. In some embodiments, the physical mechanical properties of a gel (e.g. “mesh” size) may be adjusted by controlling the concentration of the gel. In some embodiment, the physical mechanical properties of a gel (e.g. “mesh” size) may be adjusted by controlling the molecular weight of the gel. In various embodiments, the physical mechanical properties of a gel (e.g. “mesh” size) may be adjusted by using different grades of polymers (e.g. different shapes) that induce different gelification patterns (e.g. different cross-linking pattern).

The obturation material may also comprise a gel that possesses various degradation properties that may be tailored to the application and expected life-time desired of the obturation material. For example, in some cases, degradation of the obturation material may occur by surface erosion or bulk erosion. The rate of degradation may be controlled by adjusting the degree of oxidation of the polymer, by changing the purity of the polymer, and/or by adjusting the chain length or density of the polymer. In some embodiments, the degradation properties of the obturation material may be adjusted by changing the fluid used in the formation of the gel (e.g. fluid trapped in the structure).

In various embodiments, light may trigger, or assist in triggering, the gelification reactions described herein. For example, in some embodiments, photo-induced gelification may be used. Photo-induced gelification may be achieved using ultraviolet (UV) light or visible light in various arrangements, typically in the presence of a photoinitiator. In some embodiments, gels such as pluronic based hydrogels (e.g. DA Pluronic F-127) may be formed when exposed with UV and/or visible light. Such polymer solutions may be introduced in the root canal system or other suitable treatment regions. Once introduced into the root canals or treatment region, a UV and/or visible light source may be introduced on the coronal portion of the tooth or into the pulp chamber to initiate gelification. The UV and/or visible light source may be provided by a dental curing light. The source may also be located on the treatment handpiece 3 (e.g., near the proximal end of the delivery vessl 5) and may be activated after delivering the light-curable polymer solution. In other embodiments, the source may be located on the delivery vessel 5 or coupled to the delivery vessel 5.

In some embodiments, gels such as Dex-HEMA (Dextran-hydroxyethyl methacrylate) based gels may be initiated by visible light. Light triggers can be achieved by delivering visible light to the coronal portion of the tooth or in the pulp chamber. The visible light source may be a regular light source or a visible dental curing light (e.g. blue). The visible light source may be located on the treatment handpiece 3 (e.g., near the proximal end of the guide tube) and activated after delivery of the polymer solution.

Additional examples of photo-inducible gels may include systems based on poly(alkylene glycol) diacrylate, poly(alkylene glycol) dimethacrylate, trimethylolpropane tri(meth)acrylate, ethoxylated trimethylolpropane tri(meth)acrylate, pentaerythritol poly(meth)acrylate, and the like, as well as combinations thereof, preferably in the presence of a photoinitiator.

Another gelification trigger that may be used in accordance with various embodiments is heat. Some hydrogels (e.g., agar) may gelify at known temperatures. Some of these materials may, however, exhibit a hysteresis behavior that may be useful in the obturation process. Such a thermally-activated gel can be heated to a melting temperature T1 to reach a liquid state. After reaching the liquid state, the solution can cool down and transition back to a gel structure at a temperature T2. The gelification temperature T2 can be much lower than the melting temperature T1. As an example, agar gels may exhibit this hysteresis property. For example, a 1.5% w/w agar gel melts at about 85° C. but gelifies at a temperature T2 between about 32° C. and about 45° C. The hysteresis properties of agar may be tailored to the obturation process. For example, a hydrogel such as agar (in liquid form) may be heated and delivered to the root canal system at a temperature larger than T2 such that the hydrogel is in a flowable state sufficient to flow through the treatment region. Heat may be delivered to the obturation material directly by conduction or radiation, or indirectly by, for example, heat absorbing elements inside the material, such as nanoparticles that absorb a specific wavelength of light and produce heat inside the material. As the gel cools down (e.g., if the body temperature is below T2), the solution may gelify within the root canal system or treatment region. Heat may also catalyze a polymerization or curing process in various embodiments.

5. Resin-Based Obturation Materials

In some embodiments, the obturation material may be selected from curable (e.g., hardenable) resin-based materials. The resin-based material may be delivered into the tooth in its uncured, flowable state and may be cured following delivery using a trigger. The trigger may be an external stimulus and may include radiation, e.g. actinic radiation. The trigger may also be thermal energy or mechanical energy, e.g. sonic and/or ultrasonic energy (which may be provided by the pressure wave generator). The trigger may further comprise a chemical reaction, including, but not limited to, a redox reaction to initiate polymerization, e.g., free radical polymerization of ethylenically unsaturated monomers (e.g. acrylate, methacrylate). Chemical triggers may further comprise nucleophiles to initiate anionic polymerization (e.g. cyanoacrylate) and further may comprise acids to initiate cationic (ring-opening) polymerization. Curing may also be achieved through addition polymerization of complementary resin monomers having at least two reactive functional groups. Examples for complementary resin monomers include epoxy-amine systems, epoxy-thiol systems, isocyanate-alcohol (urethane) and isocyanate-amine (polyurea) systems.

In some embodiments, the resin-based obturation material may be delivered by way of a syringe, or any dental or non-dental material delivery device. For example, as explained above, the resin-based obturation material may be delivered using the delivery vessel 5 disclosed herein. In various embodiments, the resin-based material may be unfilled or may include a particulate filler. Fillers may be used to adjust viscosity and rheological properties of the obturation material. In some arrangements, the filler may also impart radiopacity for verification during or after the obturation procedure. Examples for radiopaque fillers include without limitation barium sulfate, bismuth oxychloride, bismuth subcarbonate, ytterbium fluoride, yttrium fluoride, and the like. Particulate fillers may also be used to advantageously reduce polymerization shrinkage during curing.

In various embodiments, the resin-based material includes monomers having at least one ethylenically unsaturated group. Examples of ethylenically unsaturated groups include vinyl groups, acrylate and/or methacrylate groups. Some resin monomers may comprise at least two ethylenically unsaturated groups. Examples of monomers containing two ethylenically unsaturated groups may include without limitation di(meth)acrylate monomers selected from bisphenol-A diglycidyl dimethacrylate (BisGMA), ethoxylated bisphenol-A dimethacrylate (EBPADMA), triethyleneglycol dimethacrylate (TEGDMA), urethane dimethacrylate (UDMA), and other suitable monomers.

The resin-based material may further include adhesion promoters to increase adhesion of the material to the tooth structure to provide a more efficient seal with the tooth. Adhesion promoters may contain acidic groups including without limitation carboxylic, phosphoric, phosphonic, sulfonic, and sulfinic groups. The adhesion promoter may further be capable of copolymerizing with the other resin components. In some embodiments, the resin-based obturation material may include a photoinitiator system that may be cured after being delivered into the tooth using actinic radiation, e.g. UV and/or visible light. The light source may be a standard dental curing light unit.

In some embodiments, the resin-based material may comprise two components, termed a base material and catalyst, respectively. The resin-based obturation material may be cured chemically through a redox reaction. The catalyst part may include oxidizing species including without limitation peroxides, e.g. organic peroxides. The organic peroxide may be selected from benzoyl peroxide, tert.-butyl hydroperoxide, cumene hydroperoxide, and the like. The base material may also comprise reducing co-initiators. Reducing co-initiators may include amines, e.g. teriary alkyl and/or aryl amines, thiourea, and the like. The two-part resin-based material may further contain a photoinitiator, as explained above.

6. Moisture Cure Systems

In some embodiment, the obturation material may be hardened by reacting with water or other residual moisture inside the root canal system or treatment region. The water may act as catalyst to initiate the hardening reaction, or the water may be a reactant in stoichiometric or near stoichiometric relative amounts. In some embodiments, the moisture curable material may comprise cyanoacrylate esters of the general formula CH2=C(CN)COOR, where R is a linear or branched alkyl radical, aryl radical, or combinations thereof. The ester group R may further comprise heteroatoms such as oxygen, nitrogen, phosphorus, and sulfur atoms, and combinations thereof. Non-limiting examples of suitable alkyl cyanoacrylates include methyl cyanoacrylate, ethyl cyanoacrylate, butyl cyanoacrylate, branched or linear octyl cyanoacrylate, and the like. In certain embodiments, additives such as plasticizers, inert fillers, and stabilizers may be added. In some embodiments, a radio contrast agent may further be present. Without being bound by theory, the chemical structure of the ester group R may be utilized to adjust the rate of the hardening reaction. It is believed that bulkier R groups provide lower reaction rates, which may increase the setting time. It is further believed that more hydrophilic R groups may facilitate penetration of the uncured liquid into small spaces within the root canal system.

In various embodiments, the moisture curable material may comprise condensation cure silicone. Suitable examples include one-part condensation cure systems, commonly referred to as one-part room temperature vulcanizeable (RTV) silicones. Suitable silicone materials may be selected from silicone prepolymers functionalized with readily hydrolysable groups including without limitation acetoxy (O(CO)CH3), enoxy (O(C═CH2)CH3), alkoxy (OR; R is an alkyl radical), and oxime (ON═CR1R2; R1, R2 are identical or different alkyl radicals). Optionally, silanol functionalized silicone prepolymers may further be present. Without being bound by theory, exposure to moisture may lead to hydrolysis of these hydrolysable groups followed by rapid crosslinking. In certain embodiments, the material may further contain radio contrast agents.

In some embodiments, the moisture curable material may be selected from mineral cements. For the purposes of the present disclosure, the term mineral cement includes siliceous, aluminous, aluminosiliceous materials in the presence of calcium species such as calcium oxide, calcium hydroxide, calcium phosphate, and others. These cements may harden through hydration and crystallization of the hydrated species. Non-limiting examples include Portland cement, mineral trioxide aggregate (MTA), calcium aluminate, calcium silicate, and calcium aluminosilicate. In some embodiments, the mineral cement may be provided as a dispersion of the solid cement particles in a non-reactive, water miscible liquid. In some embodiments, additives including radio contrast agents may be present. Optionally, organic modifiers including polymeric modifiers may further be present.

7. Precipitation or Evaporation Hardening Systems

In some embodiments, the obturation material may harden through precipitation. The obturation material can comprise a polymer dissolved in a first solvent. The first solvent can be any suitable material, such as a solvent in which the polymer is substantially soluble or miscible. Hardening of the material can be caused by combining the polymer solution with a second solvent or liquid that is miscible with the first solvent but that does not display appreciable solubility for the polymer, which causes the polymer to precipitate out of solution. Advantageously, the second solvent can comprise water and the first solvent can comprise a water miscible solvent for the polymer. Examples for water miscible solvents include, without limitation, alcohols such as ethanol, iso-propanol, and the like, acetone, dimethyl sulfoxide, and dimethyl formamide. Examples of suitable water-insoluble polymers include without limitation partially hydrolyzed poly(vinyl acetate) and copolymers of vinyl alcohol, vinyl pyrrolidone, or acrylic acid copolymerized with hydrophobic vinyl monomers such as ethylene, propylene, styrene, and the like.

In another embodiment, the obturation material may harden through evaporation. The obturation material may comprise a solution of a polymer in a volatile solvent. After delivery of the material into the tooth, the volatile solvent can be evaporated, leaving behind a solid polymer. Evaporation of the solvent may proceed spontaneously or it may be assisted by any suitable mechanism, such as heating or reduced pressure (e.g., vacuum).

8. Catalytic Cure Systems

In some embodiments, the setting or curing reaction may be induced by adding a suitable catalyst to a catalytically curable composition immediately prior to, during, or immediately following delivery of said composition into the root canal system or treatment region. Appropriate distribution of the catalyst throughout the curable composition may be provided through diffusion or it may be provided through agitation. For example, agitation may advantageously be provided by a pressure wave generator.

In various embodiments, the catalytically curable material can comprise a curable resin mixture. The curable resin mixture may be selected from ethylenically unsaturated monomers. In various embodiments, the ethylenically uinsaturated monomers may be selected from (meth)acrylate monomers including acrylate, methacrylate, diacrylate, dimethacrylate, monomers with three or more acrylate or methacrylate functional groups, and combinations thereof. The (meth)acrylate monomers may advantageously be hydrophilic to facilitate penetration of the filling material into small spaces within the root canal system; however, the (meth)acrylate monomers may also be hydrophobic in other arrangements. Examples for particularly suitable (meth)acrylate monomers include without limitation, methyl methacrylate, hydroxyethyl methacrylate, hydroxypropyl methacrylate, hydroxyethoxyethyl methacrylate, poly(ethylene glycol) methacrylate, ethylene glycol dimethacrylate, diethylene glycol dimethacrylate, triethylene glycol dimethacrylate, poly(ethylene glycol) dimethacrylate, hexanediiol dimethacrylate, urethane dimethacrylate, bisphenol-A diglycidyl dimethacrylate (BisGMA), ethoxylated bisphenol-A dimethacrylate, trimethylolpropane trimethacrylate, pentaerythritol tetramethacrylate, ethoxylated trimetgylolpropane trimethacrylate, and their acrylate analogues. The (meth)acrylate monomers may be radically polymerizable. Free radical polymerization may be caused by any suitable catalyst system or combination, including without limitation thermal and redox free radical initiator systems. Examples for thermal free radical initiators include peroxide salts, hydrogen peroxide, and organically substituted peroxides and hydroperoxides, as well as azo compounds. Non-limiting examples for redox free radical initiator systems include peroxide-amine combinations, peroxide-thiourea combinations, peroxide-sulfinic acid combinations, peroxide-ferrous salt combinations, peroxide-cuprous salt combinations, and combinations thereof. One component of the redox initiator system may be part of the liquid catalytically curable composition, and the second component may be added immediately prior to, during, or immediately following delivery.

In some embodiments, radio contrast agents may further be added to the material. The radio contrast agent can advantageously comprises nanoparticles having a mean particle size of less than about 200 nm. Advantageously, the nanoparticles can be substantially non-agglomerated. Suitable nanoparticles may be selected from heavy metal, heavy metal salt, and heavy metal oxide nanoparticles. Examples include without limitation colloidal, silver, gold, platinum, palladium, and tantalum particles, zirconia, yttria, ytterbia, yttrium fluoride, ytterbium fluoride, tungstate, and bismuth oxide particles. In another embodiment, the composition may further contain polymerization mediators including chain-transfer agents, stabilizers, accelerators, and the like. The composition may further comprise rheology modifiers and colorants. In yet another embodiment, the composition may further comprise a photoinitiator system to provide additional light-cure capabilities, thus allowing the practitioner to rapidly seal the coronal aspect of the root canal system.

9. Light Cure Systems

In various embodiments, the setting or curing reaction for the obturation material may be induced by exposing a photo-curable composition to actinic radiation, such as ultraviolet and/or visible light. The obturation material may be delivered into the root canal system through the delivery vessels and systems disclosed herein, and at least part of the material can be exposed to a source of actinic radiation. Exposure may be direct or indirect by irradiating the material through at least part of the tooth structure. In some embodiments, the source of actinic radiation is located on the treatment handpiece 3 (e.g., near the proximal end of the delivery vessel 5). In other embodiments, the source may be located on the delivery vessel 5 or coupled to the delivery vessel 5.

In some embodiments, the obturation material may be substantially translucent and may further display a refractive index higher than the refractive index of the tooth structure. Without being bound by theory, in such embodiments, the high refractive index material may act as a waveguide material transmitting actinic radiation through internal reflection throughout at least part of the tooth's internal volume. The photo-curable composition may be selected from ethylenically unsaturated monomers with or without the presence of a separate photoinitiator. Examples of suitable ethylenically unsaturated monomers include without limitation (meth)acrylate monomers as described herein. Advantageously, at least part of the monomer composition may comprise high refractive index monomers or additives. The refractive index can be greater than about 1.5, preferably greater than about 1.6. Non-limiting examples of a suitable (meth)acrylic high index monomer include halogen-substituted (meth)acrylates, zirconium (meth)acrylates, hafnium (meth)acrylates, thio-substituted (meth)acrylates such as phenylthiolethyl acrylate and bis(methacryloylthiophenyl)sulfide, and combinations thereof. Optionally, high refractive index nanoparticles having a mean particle size of less than about 200 nm may further be added. Advantageously, the high refractive index nanoparticles can be substantially non-agglomerated. Non-limiting examples of suitable nanoparticles include zirconia and titania colloidal particles; other high refractive index materials may also be suitable. In some embodiments, the photoinitiator system may be selected from type I or type II photoinitiator systems or a combination thereof. Non-limiting examples of type I initiators may include benzoin ethers, benzyl ketals, α-dialkoxy acetophenones, α-hydroxy alkylphenones, α-amino alkylphenones, and acyl phosphine oxides; examples of type II initiators include benzophenone-amine combinations, thioxanthone-amine combinations, α-diketone-amine combinations such as phenyl propanedione-amine and camphorquinone-amine systems, and combinations thereof.

10. Further Examples of Obturation Materials and Combinations

Additional examples of obturation materials are disclosed in Table 1 below. It should be appreciated that the disclosed materials are examples; other suitable combinations of materials and cures may be suitable.

TABLE 1

| Cure Type | Chemistry | Description | Example Benefits |
|---|---|---|---|
| Two component | Epoxy-amine | Component A: | good long term stability |
| chemical cure | | hydrophilic diepoxy | hydrophilic nature may |
| | | prepolymer (e.g. | facilitate tubule penetration |
| | | PEG-diglycidyl | slight expansion by water |
| | | ether) + poly(glycidyl) | absorption possible to improve seal |
| | | crosslinker) | |
| | | Component B: | |
| | | hydrophilic polyamine | |
| | | (e.g. PEG diamine) | |
| | | dispersed radio | |
| | | contrast agent | |
| Two component | Alginate + Ca²⁺ | Component A: | good biocompatibility |
| chemical cure | | sodium alginate | excess Ca may provide |
| | | solution in water | remineralization properties |
| | | Component B: | |
| | | calcium salt | |
| | | solution | |
| | | Component B | |
| | | can also include | |
| | | Ba or Sr salt for | |
| | | radiopacity | |
| Two component | metal oxide - polyacid | Component A: | good biocompatibility |
| chemical cure | (polyalkenoate or glass | acid-dissolvable | remineralizing may be possible |
| | ionomer cement) | metal oxide (e.g. | hydrophilic for tubule penetration |
| | | HAp, CaO, ZnO, | |
| | | reactive glass) | |
| | | Component B: | |
| | | polyacid, e.g. | |
| | | poly(acrylic acid) | |
| | | Light curable | |
| | | resin can be | |
| | | added for rapid | |
| | | coronal seal. | |
| | | dispersed radio | |
| | | contrast agent | |
| Two component | VPS addition | Component A: | excellent long term stability |
| chemical cure | silicone | vinyl poly(siloxane) + | good biocompatibility |
| | | Pt catalyst | |
| | | Component B: | |
| | | Hydrosilane | |
| | | crosslinker | |
| | | dispersed radio | |
| | | contrast agent | |
| | | (similar to | |
| | | “GuttaFlow ®” | |
| | | matrix without | |
| | | dispersed gutta | |
| | | percha particles) | |
| One component | Cyanoacrylate | Water inside root | No additional catalyst needed |
| moisture cure | (CA) | canal catalyzes | good tubule penetration may be |
| | | setting reaction; | possible |
| | | hydrophobic/hydrophilic | |
| | | balance can be | |
| | | adjusted (within limits) | |
| One component | Condensation | silanol-terminated | No additional catalyst needed |
| moisture cure | cure silicone | siloxane prepolymer + | good biocompatibility |
| | (one-part | hydrolysis-sensitive | good long term stability |
| | RTV silicone) | crosslinker dispersed | |
| | | radio contrast agent | |
| One component | Refractory | calcium silicates, | excellent long term stability |
| moisture cure | cement | aluminosilicates + | excellent biocompatibility |
| | | radiopaque metal oxide, | good dimensional stability |
| | | water miscible | bonds to dentin |
| | | carrier liquid; | |
| | | MTA and “bio-ceramics” | |
| | | are similar. | |
| Precipitation | Dissolved | Contact with water | Non-reactive systems |
| or evaporation | polymers in | inside the root | Solvent may facilitate tubule |
| hardening | water miscible | canal or evaporation | penetration |
| | or highly | of volatile solvent | |
| | volatile solvents | causes polymer | |
| | | to precipitate | |
| Catalytic cure | VPS addition | Single part vinyl | excellent long term stability |
| | silicone | siloxane + hydrosilane, | good biocompatibility |
| | | dispersed radio contrast | |
| | | agent; Pt catalyst | |
| | | delivered into tooth; | |
| | | solvent may be used | |
| | | to control viscosity | |
| Catalytic cure | Acrylic/ | PEG (meth)acrylates, | excellent long term stability |
| | methacrylic | PEG di(meth)acrylates, | good biocompatibility |
| | resin | dispersed radio contrast | tunable hydrophilicity to |
| | | agent peroxide catalyst | facilitate tubule penetration |
| | | delivered by syringe; | slight expansion possible |
| | | additional light cure | through water sorption to |
| | | possible to provide | compensate for shrinkage |
| | | rapid coronal seal | |
| Light cure | Acrylic/ | (meth)acrylate - PEG | excellent long term stability |
| | methacrylic | system with high | good biocompatibility |
| | resin | refractive index (RI) | tunable hydrophilicity to |
| | | additives (e.g. | facilitate tubule penetration |
| | | zirconia nanoparticles) | slight expansion possible |
| | | high RI additive | through water sorption to |
| | | may be sufficient | compensate for shrinkage |
| | | to provide radiopacity; | |
| | | RI higher than that | |
| | | of dentin (~1.6) may | |
| | | allow the material to | |
| | | act as wave guide to | |
| | | ensure complete cure | |

Additional examples of sealer-based obturation materials and material properties thereof are disclosed in Table 2 below. It should be appreciated that the disclosed materials are examples; other suitable combinations of materials and cures may be suitable.

TABLE 2

| | | WORKING | SETTING | DIMENSIONAL | | | |
|---|---|---|---|---|---|---|---|
| | | TIME | TIME | CHANGE | SOLUBILITY | | |
| NAME | PHASE | (mins) | (hours) | (%) | (%) | CURING | COMPOSITION |
| iRoot SP | paste | | | | | | Zirconium oxide, |
| | | | | | | | calcium silicates, |
| | | | | | | | calcium phosphate, |
| | | | | | | | calcium hydroxide, |
| | | | | | | | filler, and thickening |
| | | | | | | | agents |
| BC Sealer | paste | 1440 | 2.7 | 0.09 | 2.9 | moisture | Zirconium oxide, |
| | | | | | | | calcium silicates, |
| | | | | | | | calcium phosphate, |
| | | | | | | | calcium hydroxide, |
| | | | | | | | filler, and thickening |
| | | | | | | | agents |
| MTA- | paste/paste | 45 | 2.5 | −0.67 | 1.1 | mix | Salicylate resin, |
| Fillapex | | | | | | | diluting resin, natural |
| | | | | | | | resin, bismuth |
| | | | | | | | trioxide, |
| | | | | | | | nanoparticulate silica, |
| | | | | | | | MTA, and pigments |
| MTA- | powder/liquid | | 0.25 | | | | Tricalcium silicate, |
| Angelus | | | | | | | dicalcium silicate, |
| | | | | | | | tricalcium aluminate, |
| | | | | | | | tetracalcium |
| | | | | | | | aluminoferrite, |
| | | | | | | | bismuth oxide, iron |
| | | | | | | | oxide, |
| | | | | | | | calcium carbonate, |
| | | | | | | | magnesium oxide, |
| | | | | | | | crystalline silica, and |
| | | | | | | | residues (calcium |
| | | | | | | | oxide, free |
| | | | | | | | magnesium oxide, |
| | | | | | | | and potassium and |
| | | | | | | | sodium sulphate |
| | | | | | | | compounds) |
| ProRoot | powder/liquid | 5 | 2.3 | 0.30 | 1.28 | moisture | Powder: tricalcium |
| | | | | | | | silicate, dicalcium |
| | | | | | | | silicate, calcium |
| | | | | | | | sulphate, bismuth |
| | | | | | | | oxide, and a small |
| | | | | | | | amount of tricalcium |
| | | | | | | | aluminate |
| | | | | | | | Liquid: viscous |
| | | | | | | | aqueous solution of a |
| | | | | | | | water-soluble |
| | | | | | | | polymer |
| BioRoot | powder/liquid | 10^{a} | 5.4^{a} | | 1.785^{a} | unknown | |
| GuttaFlow ® | paste/paste | 10 | 0.7 | 0.04 | 0.02 | mix | Zirconium dioxide |
| 2 | | | | | | | Siloxanes |
| | | | | | | | Guttapercha Zinc |
| | | | | | | | oxide mixture Micro- |
| | | | | | | | silver (preservative) |
| | | | | | | | Platinum catalyst |
| | | | | | | | Colouring |
| AH Plus | paste/paste | 240 | 10.2 | 2 | 0.352 | | |
| Endoseal | paste | 4 | | 2.5 | 0.70 | air | Calcium silicates, |
| | | | | | | | Calcium aluminates, |
| | | | | | | | Calcium |
| | | | | | | | aluminoferrite, |
| | | | | | | | Calcium sulfates, |
| | | | | | | | Radiopacifier, |
| | | | | | | | Thickening agent |
| EndoREZ | | 12-15 | 0.5 | 0 | 3.5-4 | | unknown |

### B. Obturation Material Removal

In some embodiments, it can be desirable to remove an obturation material that fills a treatment region of the tooth. For example, the clinician may desire to remove the obturation material in order to re-treat the treatment region if the treatment region becomes infected or if the obturation or restoration material is damaged. In some embodiments, the hardened obturation material may be removed using a pressure wave generator. As one example, a fully gelified hydrogel (e.g., a calcium-alginate gel) may be broken down using a pressure wave generator. A suitable treatment fluid can be supplied to the obturated region of the tooth (e.g., an obturated root canal). The pressure wave generator (which may comprise a liquid jet device) can be activated to propagate pressure waves through the treatment fluid to dissolve the obturation material. In some embodiments, the handpiece 3 and delivery vessel 5 may be used to supply the treatment fluid to the obturated region. In other embodiments, the pressure wave generator may also be used to supply the treatment fluid to the obturated region. The pressure waves propagating through the obturation material can assist in agitating, breaking apart, and/or dissolving the obturation material. In other embodiments, the obturation material can be removed via heat, mechanical contact, light, electromagnetic energy, rinsing, suction, etc.

Any suitable treatment fluid may be employed to remove the gelified obturation material. For example the treatment fluid used to remove the obturation material may comprise a solvent specific to the obturation material of interest. In one embodiment, ionically cross-linked hydrogels, such as calcium-alginate gels, may be broken down using a solution of sodium hypochlorite or chelating agents (e.g., EDTA, citric acid, stearic acid). For example, chelating agents may help to break down gels (e.g. ionically cross-linked hydrogels) by breaking the ionic links between molecules, which may be formed using divalent ions. For calcium-based gels, EDTA may be used based on its calcium binding properties. Thus, in some embodiments, EDTA or other treatment fluid may be supplied to the obturated region, for example, by the handpiece 3 and delivery vessel 5, and a pressure wave generator can be activated to assist with removing the calcium-based gel.

In various embodiments, two different treatment fluids may be used when removing the obturation material. One treatment fluid may be configured to quickly diffuse within the obturation medium, and the other treatment fluid can be configured to break down the structure of the obturation material matrix. For example, sodium hypochlorite can be used in combination with EDTA. In some embodiments, one or both of the treatment fluids can be delivered by the handpiece 3 and delivery vessel 5.

### C. Other Characteristics of Obturation Materials

The obturation materials disclosed herein can include a flowable state and a cured or hardened state. When in the flowable state, the obturation material can be delivered to the treatment region (e.g., root canal). For example the material can be flowable such that it can be delivered into root canals, including into all of the isthmuses and ramifications. The flowability or viscosity of the material may depend at least in part on the method of delivery and agitation that would assist in filling complex and small spaces inside the tooth and root canal system. For example, it may be desirable that obturation material delivered through the handpiece 3 and delivery vessel 5 be less viscous (e.g., more flowable) so that it can penetrate into small spaces (e.g., micron size spaces) without using excessive force that could potentially cause extrusion of materials into the periapical space and potentially harm the patient. Accordingly, a flowable obturation material can advantageously fill small spaces while protecting the patient from injury. In other arrangements, the viscosity of the obturation material can be selected such that the obturation material can form a liquid jet when it passes through a nozzle or orifice. For example, an obturation material used to form a liquid jet may have a viscosity similar to that of water or other treatment fluids (such as EDTA, bleach, etc.). The flowable obturation material can be hardened or cured after it fills the treatment region in order to provide a long-term solution for the patient.

For gel-based materials, an obturation gel in its flowable state (e.g., before gelification) can be efficiently delivered into the root canal system based at least in part on its relatively low viscosity. The gel may be degassed in some arrangements, e.g., substantially free of dissolved gases. In some embodiments, the viscosity of the obturation material may be controlled by adjusting the polymer concentration or the molecular weight of the molecule. In other embodiments, the viscosity of the gel-based obturation material may be controlled by exposing the polymer molecules to specific shear/strain rates. The molecules may be designed and formed in such a way that when the molecules are subjected to high deformation rates, the molecules or chemical links may break and therefore induce a lower apparent viscosity. In some embodiments, the molecules may go back to their original state (repair) when the source of deformation is removed, therefore regaining the higher viscosity.

In various embodiments, the obturation material may be delivered by way the delivery vessel 5. In some embodiments, the obturation material can be delivered by the handpiece 3 disclosed herein. For example, the handpiece 3 can be used to induce the flow of obturation material (or various components of the obturation material) through the delivery vessel 5. When delivered by the delivery vessel 5, the solution can be passed through a small orifice by way of the handpiece 3. A stream of obturation material can be created, and the obturation material can be delivered within the root canal system (or other treatment region). The resulting flow of obturation material into the root canal system helps to ensure a complete obturation of the root canal system (or treatment region). In some embodiments, a pressure wave generator (such as a liquid jet device) can be activated before or during obturation to enhance the obturation of the root canal system. The liquid stream of obturation material may be a high velocity stream, and may pass through fluid that is retained at the treatment region. The stream of obturation fluid may be diverted to ensure efficient and safe delivery of material. The obturation material may or may not be degassed, e.g., substantially free of dissolved gases.

The viscosity (flowability) of the material may remain substantially constant or it may vary during the procedure. For example, during the delivery of the material into the tooth, the viscosity may be low, but the viscosity may increase after the filling is completed. The viscosity can be increased during the procedure to stabilize the obturation material in place after completion of the filling procedure. At or near the beginning of the procedure, a flowable liquid obturation material can be used, which can be cured into a semi-solid or solid obturation material after filling is completed.

The viscosity of the material may change automatically or by way of an external trigger or force. The viscosity of the obturation material may change by way of changes in chemical reaction in the material or molecular structure of the material. The external trigger or force may comprise an external stimulus including energy having one or more frequencies, or ranges of frequencies, e.g., in the electromagnetic wave spectrum. For example, in some embodiments, the external trigger may include energy having frequencies or ranges of frequencies at frequencies corresponding to microwaves, UV light, visible light, IR light, sound, audible or non-audible acoustics, RF waves, gamma rays, etc. The trigger may comprise an electrical current safe for a human or mammalian body, a magnetic field, or a mechanical shock. In some embodiments, a clinician or user can engage the external trigger to change the obturation material from a substantially flowable state (e.g., a liquid-like state in some arrangements) to a substantially solid or semi-solid state. For example, when the filling is complete or almost complete, the clinician or user can activate the trigger to convert or change the obturation material to a solid or semi-solid state. In still other embodiments, the obturation material may be configured to cure (set) automatically. The setting and curing may be irreversible and permanent, or the setting and curing may be reversible such that the obturation material can be more easily removed.

In some embodiments, the obturation material may be seeded with another material which can preferentially absorb a specific type of electromagnetic wave or a plurality of electromagnetic waves (or frequencies thereof). For example, near-IR absorbing gold nanoparticles (including gold nanoshells and nanorods) may be used to produce heat when excited by light at wavelengths from about 700 to about 800 nm. In such embodiments, heat may help in reducing the viscosity of the material, rendering it more flowable until the material is delivered and has filled substantially all the spaces inside the tooth and root canals. The material viscosity can then return to its original state as the heat is dissipate.

In another embodiment, the filling material may be seeded by particles of a magnetic material, such as stainless steel. In such an embodiment, the magnetic material may be driven into the root canals and small spaces remotely by way of an external magnet. In another embodiment, the obturation material may be seeded with electrically conductive particles which can help in controlling the delivery of the material. For example, when the obturation material reaches the apex of the root canal, the circuit electrical circuit is completed and the console may signal the operator that the filling process is completed. In yet other embodiments, the obturation material can be made electrically conductive and, through safe electrical currents that are absorbed by the energy absorbing material, heat can be generated. The heat can act to reduce the viscosity of the filling material, rendering it more flowable until the source of energy is stopped and the heat is dissipated. The material can then become more viscous as it cools down until it hardens, for example, as a semi-solid or solid material.

In various arrangements, the obturation material may have a surface tension that is sufficiently low such that the material can flow into small complex (or irregular) spaces inside the tooth. Having a low surface tension can reduce or eliminate air bubbles trapped in the spaces of the canals or tooth. In some embodiments, the obturation material can be radiopaque. Radiopaque obturation materials can allow the clinician to monitor the location and quality of obturation material inside the tooth. Radiopaque obturation materials may also be used to alert the doctor or clinician in the future about which teeth have received root canal treatment(s) in the past.

The obturation material may comprise a biocompatible material configured to minimize or reduce any negative effects that the filling or obturation material may have on the body. For example, the obturation material can be designed to prevent the growth of bacteria, biofilms, parasites, viruses, microbes, spores, pyrogens, fungi or any microorganisms that may trigger patient/body reactions or infections/diseases. For example, the growth of bacteria or biofilms may be prevented or reduced by way of an antibacterial agent that is designed such that it kills bacteria while not inducing bacterial resistance to such agent. The antibacterial agent may be suitable for in vivo use and can be configured such that it does not induce unwanted body/patient reactions. The antibacterial agent may also be designed such that it does not react with the various components of the obturation material. In some embodiments, the antibacterial agent may be designed such that it is soluble or miscible in the obturation material. The antibacterial agent may be combined with other agents (e.g. surfactants, polymers, etc.) to increase its potency and efficiency. In some embodiments, the antibacterial agent can be encapsulated in a coating. In some arrangements, the antibacterial agent may be replaced or supplemented by antiparasitic agents, antiviral agents, antimicrobial agents, antifungal agents or any agents that may prevent development of infections/diseases or patient/body reactions.

Moreover, the obturation material may be configured to be naturally absorbed by the body over time. The absorption of the obturation material may occur in combination with pulp tissue regeneration that helps the pulp tissue to grow and fill the root canal space as the filling material is absorbed. In some cases, the obturation material may be absorbed without any pulp tissue regeneration. In some cases, the obturation material may not be absorbed by the patient's body. The obturation materials disclosed herein can also be configured to bond securely to dentin. Bonding to dentin can help provide a better seal, which can then reduce the rate and extent of penetration of contaminants and bacteria.

Some obturation materials disclosed herein (e.g. long chain polymers or cross-linked polymer networks) may have a certain molecular structure, or may be seeded by such a material, that causes a reduction of viscosity of the material (making them more flowable) when under the application of shear forces. This shear rate can be imparted via rotational force or via applied pressure. This reduction in viscosity may be reversible or irreversible. The reversing mechanism can be automatic or by way of an external trigger or chemical reaction. If the reduction of viscosity is reversible, the reversing time may be adjustable to allow for the time for filling the teeth.

In some arrangements, shear-thinning behavior can usually be observed when in the presence of various configurations, such as a solution of long chain polymers or a cross-linked polymer (e.g. short chain) network. When in the presence of long chain polymers, the molecular network of the obturation material can be subjected to a shear flow that can evolve from an entangled state to a more structured orientation that follows the main direction of the flow. The alignment can reduce the apparent resistance of the fluid to the driving force (e.g., can exhibit lower viscosity) due to the untangling of the polymer molecules. The fluid may therefore exhibit shear thinning behavior. When the amount of strain applied to the fluid is sufficient, the change in the fluid properties can be reversible. The relaxation time of the molecules may drive the time it takes for the fluid to go back to its original state.

When in the presence of a cross-linked polymer network, each polymer molecule of the obturation material can be linked to its neighboring molecules (e.g., by cross-linking, typically covalent or ionic bonds). When subjected to a shear flow, the links between the molecules may be broken and the polymer molecules can move “freely” into solution, hence leading to a lower apparent viscosity. If the links can be reformed (e.g., via heat, pH, etc. . . . ), the process may be reversible. If the network cannot be reformed, the process may be irreversible.

When subjected to a large enough deformation, polymer molecules of the obturation material may break. The breakage may lead to a drop in apparent viscosity (shear thinning). Such large-deformation processes may be irreversible.

### III. Examples of Delivery Vessels

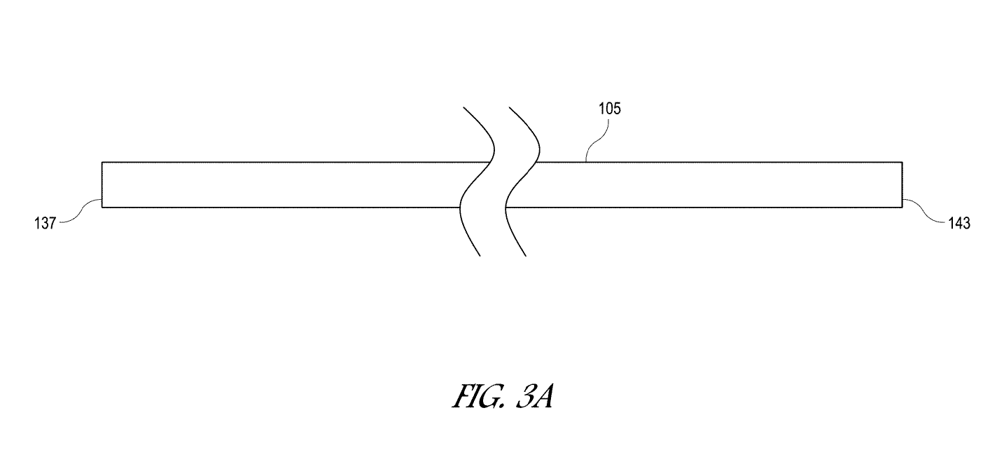

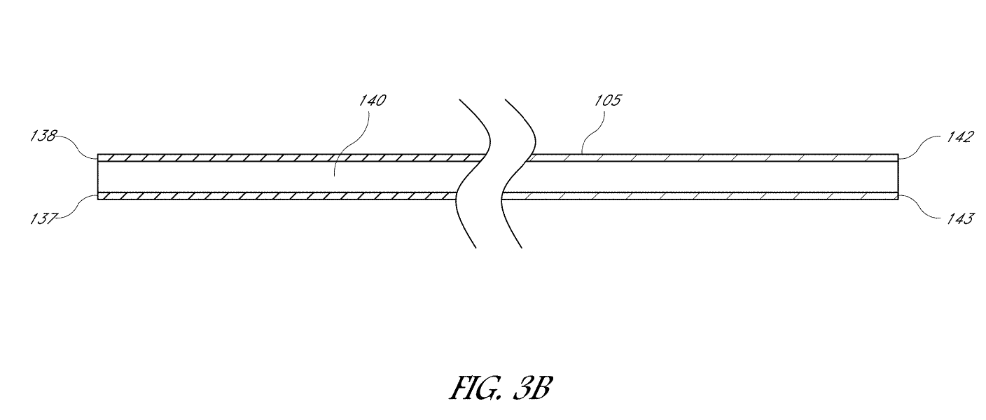

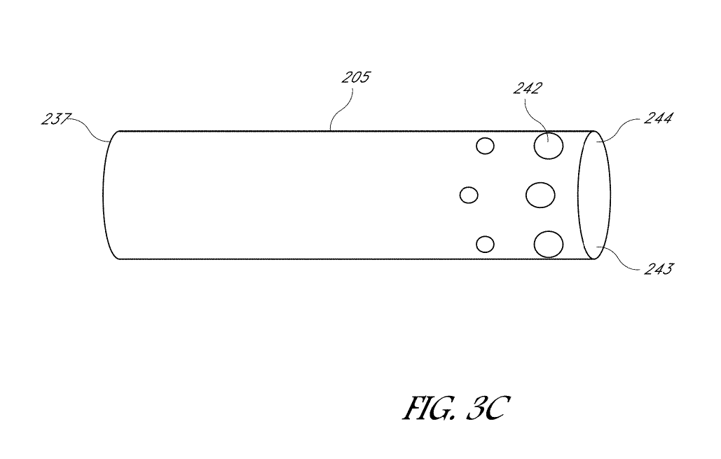

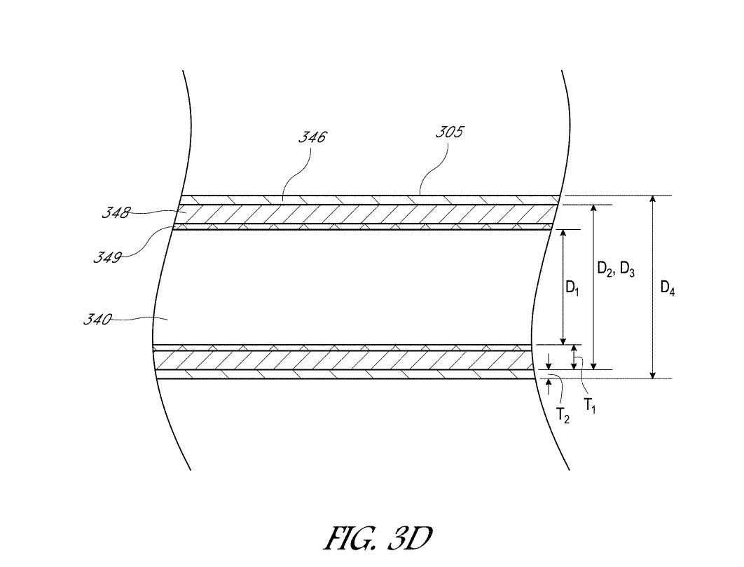

FIG. 3A is a schematic side view of a delivery vessel 5 comprising a capillary 105 for treating a tooth, e.g., obturating a root canal, filling a treated carious region, etc. FIG. 3B is a schematic side cross-sectional view of the capillary 105 shown in FIG. 3A. The capillary 105 can be sized and shaped to facilitate introduction of the capillary 105 into any canal (e.g. main canal) and to allow for navigation therein. In various embodiments, an outer diameter of the capillary 105 can be in a range of 50 μm to 400 μm, in a range of 50 μm to 350 μm, in a range of 50 μm to 300 μm, in a range of 100 μm to 400 μm, in a range of 100 μm to 350 μm, in a range of 150 μm to 350 μm, in a range of 200 μm to 400 μm, or in a range of 200 μm to 350 μm In some embodiments, an outer diameter is less than or equal to approximately 250 μm. In some embodiments, the outer diameter is between 200 μm to 250 μm. In some embodiments, the outer diameter is between 250 μm to 300 μm. In some embodiments, the outer diameter can be 150 μm, 180 μm, 200 μm, 250 μm, or 350 μm. In some embodiments, the outer diameter is between 300 μm to 350 μm. In some embodiments, a length of the capillary can be in a range of 0.2″ to 3″, in a range of 0.25″ to 3″, in a range of 0.5″ to 3″, in a range of 0.5″ to 2.5″, or in a range of 1″ to 3″. In various embodiments, the length of the capillary 105 is approximately 0.5″, 1″, 1.5″, 2″, 2.5″, 3″, or any other suitable length. The capillary 105 can have a large aspect ratio, i.e., a ratio of the length of the capillary 105 to its outer diameter. In various embodiments, the aspect ratio can be in a range of 12.5 to 1550, in a range of 15 to 1000, in a range of 15 to 500, in a range of 15 to 250, in a range of 15 to 100, in a range of 15 to 50, in a range of 100 to 1,000, in a range of 100 to 500, in a range of 100 to 250, in a range of 250 to 1,000, in a range of 250 to 500, in a range of 250 to 750, in a range of 500 to 1,000, in a range of 500 to 750, in a range of 750 to 1,500, in a range of 1,000 to 1,500, or in a range of 1,250 to 1,500.

The capillary 105 can also be of a sufficient flexibility to allow for navigation through any canal, for example, a canal that is curved. For example, in some embodiments, the capillary 105 can be sufficiently flexible to allow for insertion into deep regions of the root canal, which may be curved. For example, in some embodiments, a distal end of the capillary 105 is pivotable or bendable relative to a proximal end of the capillary 105 by at least 15°, at least 30°, at least 45°, at least 60°, at least 75°, at least 90°, at least 115°, at least 130°, at least 145°, at least 160°, at least 175° or at least 180°. In some embodiments, the capillary 105 can have a bend radius of greater than 3 mm, greater than 5 mm, greater than 10 mm, greater than 15 mm, greater than 20 mm, greater than 25 mm, or greater than 30 mm. Capillary size combinations of inner and outer diameters can be selected based upon internal tooth structure, ranging from nanometer to micrometer length scales.

The capillary 105 can include an inlet port 138 at a proximal end 137 of the capillary 105, an internal lumen 140, and an outlet port 142 at a distal end 143 of capillary 105. In some embodiments, the capillary 105 can be configured to receive a fluid or flowable material, such as obturation material, through the inlet port 138 and supply the fluid to the tooth via the outlet port 142. The internal lumen 140 can be shaped and sized to allow for the flow of fluid, such as obturation material, therein. In some embodiments, a diameter of the internal lumen (e.g. an internal diameter of the capillary 105) can be in a range of 10 microns to 450 microns, in a range of 10 microns to 400 microns, in a range of 25 microns to 400 microns, in a range of 50 microns to 450 microns, in a range of 50 microns to 400 microns, in a range of 50 microns to 350 microns, in a range of 50 microns to 300 microns, in a range of 100 microns to 400 microns, or in a range of 100 microns to 350 microns, in a range of 125 microns to 350 microns, in a range of 125 microns to 300 microns, in a range of 125 microns to 250 microns. In some embodiments, the diameter of the internal lumen can be in a range of 10 microns to 200 microns, in a range of 30 microns to 150 microns, e.g., approximately 100 μm, in a range of 50 microns to 100 microns, in a range of 100 microns to 200 microns, in a range of 200 microns to 300 microns, or in a range of 300 microns to 400 microns. In some embodiments, the diameter of the internal lumen can be 150 μm, 180 μm, 200 μm, 220 μm, 250 μm, or 350 μm, or approximately 150 μm, 180 μm, 200 μm, 220 μm, 250 μm, or 350 μm.

Although the dimensions and ranges of dimensions are provided for various diameters of the capillary 105 and other capillaries described herein, it should be appreciated, however, that capillaries may or may not be circular in cross-section. In various embodiments, the capillaries can be polygonal, elliptical, or any other suitable cross-section. In such embodiments, the dimensions provided for the diameters described herein can correspond to major dimensions of the cross-sectional shape of capillaries.

In operation, the capillary 105 can be positioned within the treatment region of the tooth so that the fluid can be delivered at the desired location of the tooth. Additional fluid can be deposited via cycling through manual steps of retraction and extrusion into the canal until the canal is filled to a desired amount and the process repeated for each canal. Alternatively, the capillary 105 can be retracted by a user during extrusion of the fluid such that a canal can be filled to the desired amount continuously without a cease in extrusion. As shown in FIG. 3B, the outlet port 142 can be positioned at the distal-most end of the capillary 105.

The capillary 105 can be coupled to a fluid source. The fluid source can supply fluid, such as obturation material or other filling material, to the capillary 105. In some embodiments, the capillary 105 can couple to a fluid source within a handpiece. For example, housing 9 within handpiece 3 can act as a fluid source for the capillary 105. The capillary 105 can be in fluid communication with the housing 9 when coupled to the handpiece 3. In some embodiments. For example, the capillary 105 can be positioned such that fluid within housing 9 can flow from the housing 9 into the inlet port 138 of the capillary 105.

An activation mechanism, such as activation mechanism 8, can be coupled to the capillary 105 to apply a pressure to fluid within the lumen 140 in order to cause the fluid to flow through the lumen 140 and out of the one or more outlet ports 142 via a pressure differential. The activation mechanism can include any type of pressure generator or pressure generator system that can move a fluid or gas including, but not restricted to: positive displacement, rotary, peristaltic, plunger, screw or cavity pumps. Such a pressure generator system can be electric, hydraulic, or pneumatic. Such a pressure generator or pressure generator system can be coupled to the chamber 6, the housing 9, and/or the capillary 105 to apply a pressure to fluid within the chamber 6, the housing 9, and/or the capillary 105 in order to cause the fluid to flow through the capillary 105. The activation mechanism can be configured to supply a sufficient pressure so as to cause shear thinning of the filling material and to cause the shear thinned filling material to flow into the delivery vessel 5. In various embodiments, for example, the activation mechanism can be configured to apply a pressure of at least 50 psi, at least 100 psi, at least 150 psi, at least 200 psi, or at least 500 psi to the filling material. In various embodiments, the activation mechanism can apply pressure between 1-10,000 psi to a chamber filled with a filling material. In some embodiments, the activation mechanism can be configured to supply a pressure of approximately 1,500 psi. In some embodiments, the activation mechanism can be configured to supply a pressure of approximately 2,000 psi. In some embodiments, the activation mechanism 105 can be configured to supply a pressure greater than 500 psi, greater than 536 psi, greater than 700 psi, greater than 800 psi, greater than 900 psi, greater than 1,000 psi, greater than 1,100 psi, greater than 1,200 psi, greater than 1,300 psi, greater than 1,400 psi, or greater than 2,000 psi. In some embodiments, the activation mechanism 8 can be configured to supply a pressure less than 1,000 psi, less than 1,500 psi, less than 2,000 psi, less than 2,500 psi, less than 3,000 psi, less than 4,000 psi, less than 5,000 psi, less than 6,000 psi, less than 7,000 psi, less than 8,000 psi, less than 9,000 psi, or less than 10,000 psi. In various embodiments, the activation mechanism 8 can be configured to apply a pressure in a range of 50 psi to 20,000 psi, in a range of 50 psi to 10,000 psi, in a range of 50 psi to 5,000 psi, in a range of 100 psi to 10,000 psi, in a range of 200 psi to 10,000 psi, in a range of 500 psi to 10,000 psi, in a range of 500 psi to 9,000 psi, in a range of 500 psi to 8,000 psi, in a range of 750 psi to 7,000 psi, in a range of 750 psi to 5,000 psi, in a range of 750 psi to 4,000 psi, in a range of 750 psi to 3,000 psi, in a range of 1,000 psi to 3,000 psi, or in a range of 1,200 psi to 2,500 psi.

Any type of fluid can be delivered via the capillary 105 including, but not restricted to: Newtonian fluids; and non-Newtonian fluids such as shear thinning (rheopectic), shear thickening (dilatant), thixotropic or Bingham plastic liquids. Knowledge of the fluids' viscoelastic and physiochemical properties can allow the control of volume flow rate via the pressure differential supplied by the pump and vessel diameter and length. The pressure supplied can range from 1-10,000 psi, depending, e.g., on the various properties of the flowable material, the dimensions of the delivery vessel, etc.

FIG. 3C is a schematic side view of a delivery vessel comprising a capillary 205 for treating a tooth, e.g., cleaning or obturating a root canal, cleaning or filling a carious region, etc. The capillary 205 can include any of the features and functions described with respect to the capillary 105 with reference to FIGS. 3A-3B.

The capillary 205 can include an inlet port at a proximal end 237 of the capillary 205, an internal lumen, and a plurality of outlet ports 242 positioned near a distal end 243 of capillary 205. In some embodiments, the capillary 205 can be configured to receive a fluid, such as obturation material, through the inlet port and supply the fluid to the tooth via the outlet ports 242. As shown in FIG. 3C, the outlet ports 242 can be positioned in a side wall of the capillary 205 near the distal end 243 of the capillary 205. The distal-most end of the capillary 205 includes a cap or seal 244. The cap or seal can prevent the flow of fluid out of the distal-most end of the capillary 205. The cap or seal 244 can be formed of a material having a sufficient thickness or durability to prevent puncture during insertion of the delivery vessel into the tooth. In some embodiments the cap or seal 244 can have a thickness in a range of 75 microns to 1000 microns. In such embodiments, the outlet ports 242 are located circumferentially about the capillary 205, in order to direct the extrusion flow path. In some embodiments, the outlet ports 242 can be located at different axial distances with different diameters in order to preferentially control and direct extruded material delivery to different depths inside the tooth. In some embodiments, the outlet ports 242 may comprise only a single outlet port 242 positioned in a side wall of the capillary 205. In some embodiments, the capillary 205 can include one or more outlet ports at the distal-most end of the capillary 205 and one or more outlet ports 242 positioned in the sidewall of the capillary 205.

FIG. 3D is a schematic cross-sectional side view of a section of a delivery vessel comprising a capillary 305 for treating a tooth, e.g., cleaning or obturating a root canal, cleaning or filling a carious region, etc. The capillary 305 can include any of the features and functions described with respect to the capillary 105 and the capillary 205 with reference to FIGS. 3A-3C. The capillary 305 includes an outer coating 346 covering an inner layer 348. In some embodiments, a thin protective coating 349 can be provided on an inner surface of the inner layer 348 to protect the inner layer 348 from being damaged by the flowable obturation material. The capillary 305 further includes an inner lumen 340. The inner layer 348 can have an inner diameter D1 (which may be defined by the inner surface of the thin protective coating 349 in the illustrated embodiment), an outer diameter D2, and a thickness T1. The outer coating 346 has an inner diameter D3 that is substantially equivalent to outer diameter D2, an outer diameter D4, and a thickness T2.

The dimensions of the inner and outer diameters can be modified to achieve desired design specifications such a flow rate. For example, as explained in more detail herein, the dimensions of the capillary 305 can be selected to be sufficiently small so as to be inserted into the root canal 30 of the tooth. However, making the inner diameter D1 of the lumen 340 to be small enough to be inserted in to the canal 30 may significantly reduce the flow rate of flowable obturation material into the treatment region. Beneficially, the embodiments disclosed herein can drive the flowable obturation material at pressures that are sufficiently high as to create shear-thinning flow, in which the viscosity of the obturation material decreases with increasing pressure and/or shear strain. Utilizing the shear-thinning properties of suitable obturation materials can advantageously increase the flow rate of obturation material through the small inner lumen 340, thereby reducing obturation times significantly. In various embodiments, for example, the treatment region of the tooth (e.g., the root canal(s) or treated carious region of a tooth) can be filled in a time period of less than 10 minutes, less than 5 minutes, less than 4 minutes, less than 3 minutes, less than 2 minutes, or less than 1 minute. In various embodiments, the filling time can be in a range of 10 seconds to 5 minutes, in a range of 10 seconds to 3 minutes, in a range of 15 seconds to 3 minutes, in a range of 30 seconds to 3 minutes, in a range of 30 seconds to 2 minutes, or in a range of 30 seconds to 1 minute.

The inner diameter D1 can be in a range of 10 microns to 450 microns, in a range of 10 microns to 400 microns, in a range of 25 microns to 400 microns, in a range of 50 microns to 450 microns, in a range of 50 microns to 400 microns, in a range of 50 microns to 350 microns, in a range of 50 microns to 300 microns, in a range of 100 microns to 400 microns, in a range of 100 microns to 350 microns, in a range of 100 microns to 300 microns, in a range of 125 microns to 350 microns, in a range of 125 microns to 300 microns, in a range of 125 microns to 250 microns, in a range of 10 microns to 200 microns, in a range of 30 microns to 150 microns, e.g., approximately 100 μm, in a range of 50 microns to 100 microns, in a range of 100 microns to 200 microns, in a range of 200 microns to 300 microns, or in a range of 300 microns to 400 microns. In some embodiments, the diameter D1 can be 150 μm, 180 μm, 200 μm, 220 μm, 250 μm, or 350 μm. In some embodiments, the outer diameter D4 can be in a range of 50 μm to 400 μm, in a range of 50 μm to 350 μm, in a range of 50 μm to 300 μm, in a range of 100 μm to 400 μm, in a range of 100 μm to 350 μm, in a range of 150 μm to 350 μm, in a range of 200 μm to 400 μm, or in a range of 200 μm to 350 μm In some embodiments, the diameter D4 is less than or equal to approximately 250 μm. In some embodiments, the diameter D4 is between 200 μm to 250 μm. In some embodiments, the diameter D4 is between 250 μm to 300 μm. In some embodiments, the outer diameter is between 300 μm to 350 μm. In some embodiments, the outer diameter D4 can be 150 μm, 180 μm, 200 μm, 250 μm, or 350 μm. In some embodiments, the thickness T1 can be less than 350 μm, less than 250 μm, less than 150 μm, less than 50 μm, less than 25 μm, less than 10 μm, between 50 μm to 300 μm, between 100 μm to 250 μm, or between 150 μm to 200 μm, between 5 μm to 10 μm, between 5 μm to 25 μm, between 25 μm to 50 μm, or between 50 μm to 100 μm. In some embodiments, the thickness T1 can be 5 μm, 10 μm, 25 μm, 50 μm, 100 μm, 150 μm, 200 μm, 220 μm, 250 μm, 300 μm, or 350 μm. In some embodiments, the thickness T1 can be between 1 μm to 5 μm. In some embodiments, the thickness T2 can be between 1 μm to 5 μm, between 5 μm to 50 μm, between 5 μm to 25 μm, between 25 μm to 50 μm, or between 10 μm to 20 μm. In some embodiments, the thickness T2 can be 5 μm, 10 μm, 15 μm, 20 μm, 25, μm, 30 μm, 40 μm, 50 μm, 60 μm, 70 μm, or any other suitable size. A thickness of the protective coating 349 can be between 1 μm to 5 μm, between 5 μm to 10 μm, between 5 μm to 50 μm, between 5 μm to 25 μm, between 25 μm to 50 μm, or between 10 μm to 20 μm.

In some embodiments, the inner layer 348 of the capillary 305 is constructed with a thin wall of fused silica and the external coating 346 comprises polyimide. Such a fused silica capillary can be advantageous in an obturation procedure as described herein. A fused silica capillary can have high mechanical strength, allowing the fused silica capillary to handle high pressures used for achieving desirable flow rates for the obturation procedures described herein. In some embodiments, the fused silica inner layer 348 can have a smooth interior surface, which can ensure efficient flow of obturation material. For example, in some embodiments, the smooth interior surface of the fused silica inner layer 348 can improve structural integrity and preserve strength during bending of the capillary 305. In embodiments that utilize the protective inner coating 349, the inner coating 349 can comprise a polymer, e.g., polydimethylsiloxane (PDMS). Fused silica, PDMS, and polyimide are inert, facilitating biocompatibility.

Further, the polyimide outer coating 346 can provide flexibility to allow the capillary to navigate the curvature of the root canal geometry. For example, in some embodiments, a distal end of the capillary 305 is pivotable or bendable relative to a proximal end of the capillary 305 by at least 15°, at least 30°, at least 45°, at least 60°, at least 75°, at least 90°, at least 115°, at least 130°, at least 145°, at least 160°, at least 175° or at least 180°. In some embodiments, the capillary 305 can have a bend radius of greater than 3 mm, greater than 5 mm, greater than 10 mm, greater than 15 mm, greater than 20 mm, greater than 25 mm, or greater than 30 mm.

In some embodiments, the protective coating 346 can also provide abrasion resistance to prevent capillary breakage during contact with sharp dental edges or surfaces during capillary placement. As explained above, in some embodiments, the capillary 305 can further include the protective internal coating 349, which can comprise a polymer such as polydimethylsiloxane (PDMS). The PDMS coat can provide additional abrasion resistance. In some embodiments, the PDMS coat can have a thickness of 1 μm.

### IV. Examples of Housings

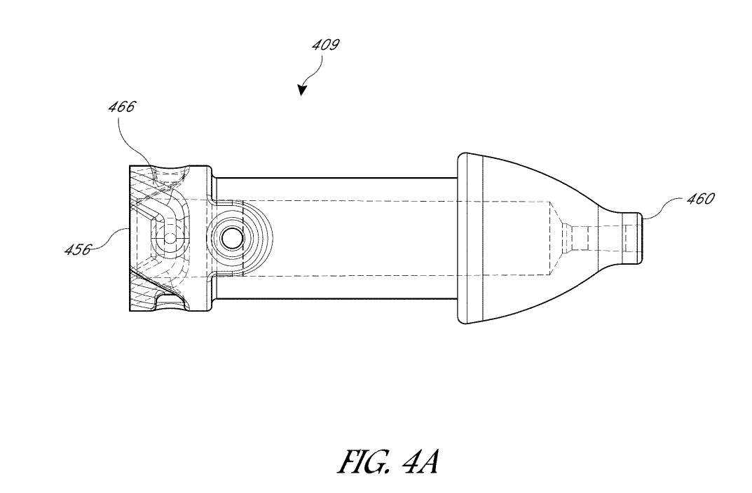

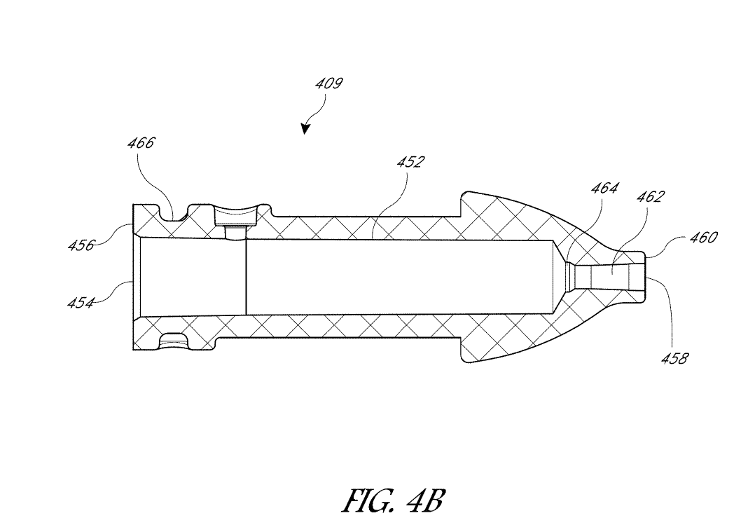

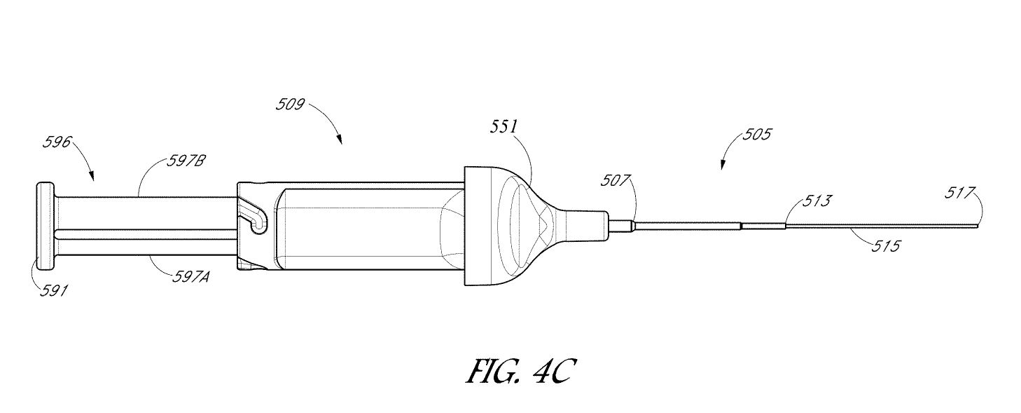

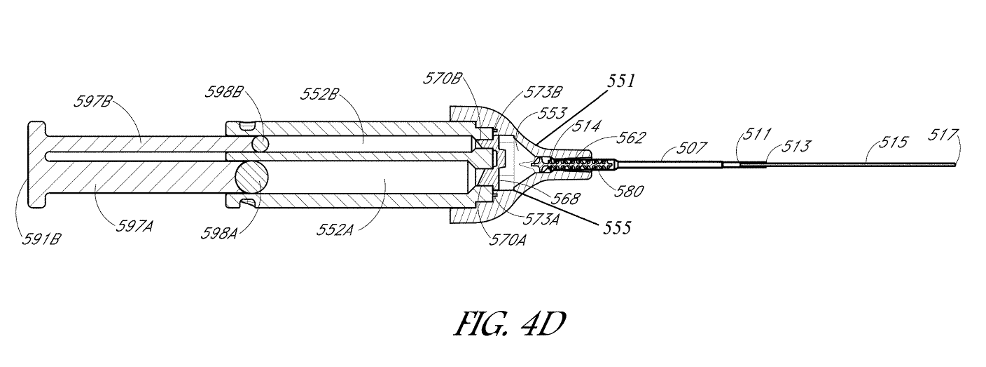

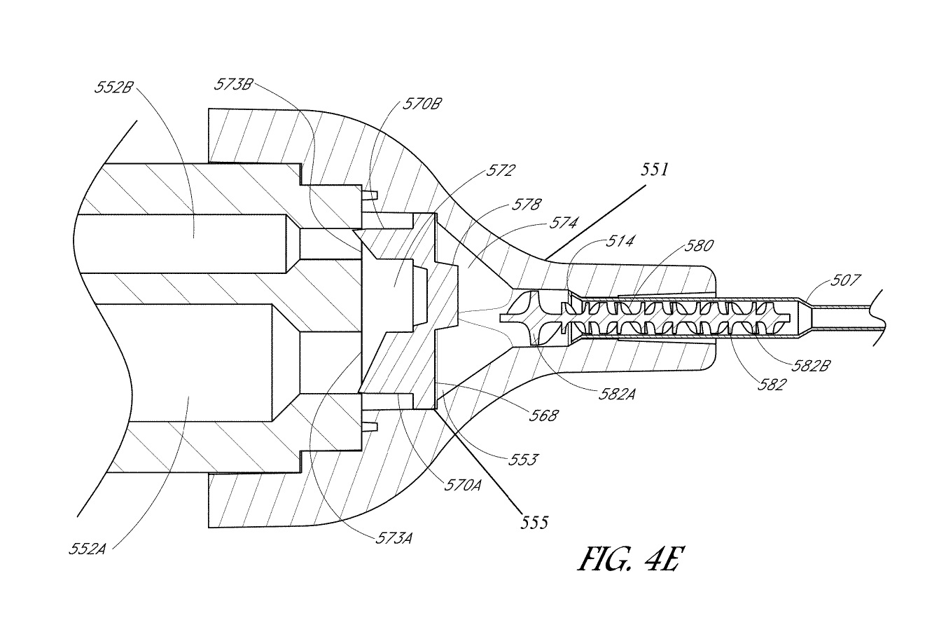

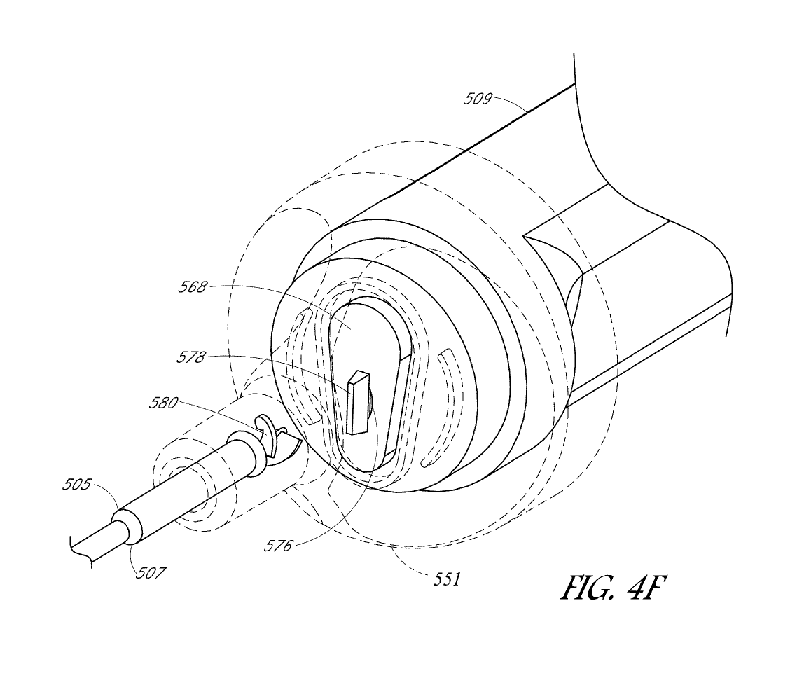

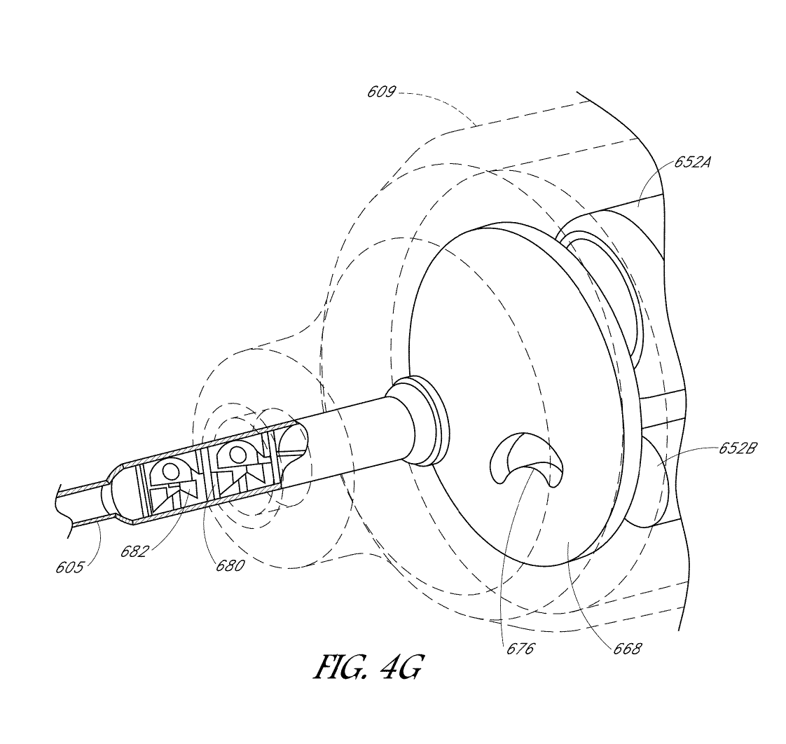

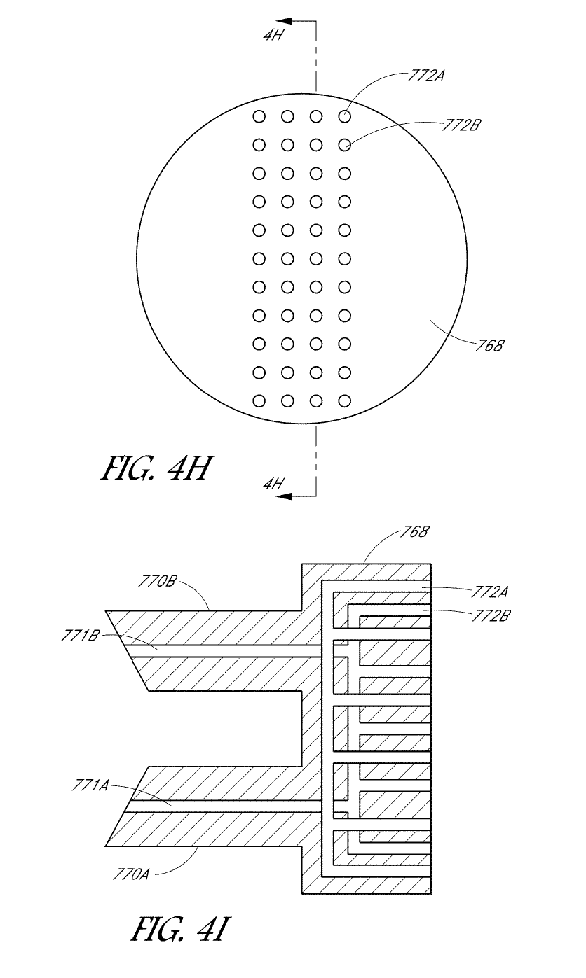

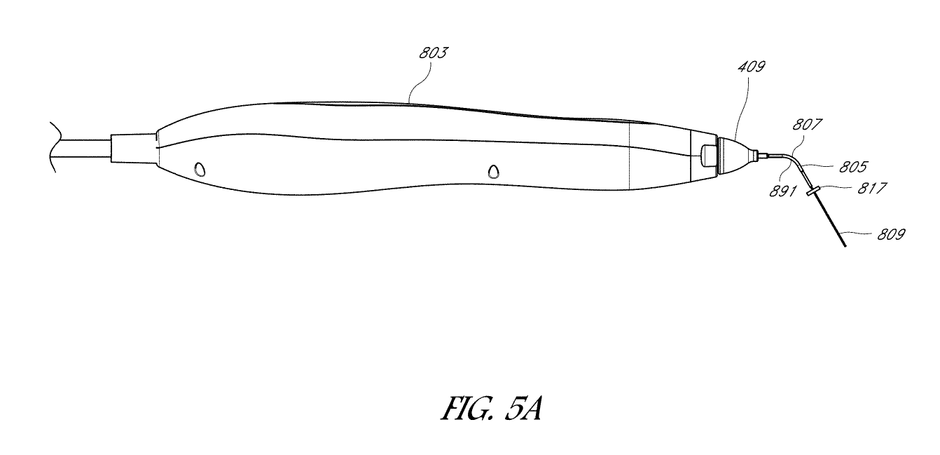

FIG. 4A depicts a schematic side view of a housing 409 for holding obturation material in accordance with embodiments disclosed herein. FIG. 4B is a schematic side cross-sectional view of the housing 409 shown in FIG. 4A. The housing 409 includes an interior chamber 452, an opening 454 at a proximal end 456 of the housing 409, an opening 458 at a distal end 460 of the housing 409, and a lumen 462 extending between the interior chamber 452 and the opening 458 at the distal end 460 of the housing 409.

The interior chamber 452 can receive and store one or more obturation materials therein. In some embodiments, the interior chamber 452 can have a volume in a range of 0.1 mL to 3 mL, in a range of 0.1 mL to 1.5 mL, in a range of 0.1 mL to 1 mL, in a range of 0.25 mL to 1.5 mL, in a range of 0.3 mL to 1.5 mL, or in a range of 0.4 mL to 1.5 mL. In various embodiments, the interior chamber 452 can have a volume of 0.3 mL, 0.5 mL, 0.75 mL, 1.0 mL, greater than 0.3 mL, or any other suitable size.

In the illustrated embodiment, the interior chamber 452 can contain a single obturation material, e.g., a single obturation composition. In some embodiments, the interior chamber 452 can contain a pre-mixed obturation material, e.g., an obturation material comprising a mixture of two or more component compositions. In still other embodiments, as explained herein, multiple interior chambers can be provided in the housing 409. In some embodiments, the interior chamber 452 can be pre-filled with the obturation material(s). In other embodiments, the interior chamber 452 can be user-filled, e.g., the user or clinician can fill the interior chamber 452 with a desirable obturation material(s), for example, using a syringe or other device.

In some embodiments, the delivery vessel 5 can be part of, disposed in, disposed on, or otherwise coupled to the housing 409 to receive the obturation material housed within the interior chamber 452. At least a portion of the delivery vessel 5 can be positioned within the lumen 462, e.g., to couple (for example, removeably couple) a proximal portion of the delivery vessel 5 to the lumen 462. The delivery vessel 5 can extend from the lumen 462 and out of the opening 458 at the distal end 460 of the housing 409. In some embodiments, the housing 409 may include one or more features for securably coupling with the delivery vessel 5. For example, as shown in FIGS. 4A-4B, the housing 409 can include a tapered inner wall section 464 between the interior chamber 452 and the lumen 462 configured to receive a tapered exterior section of the delivery vessel 5. The lumen 462 can be sized to prevent the passage of the tapered exterior section of the delivery vessel while allowing distal portions of the delivery vessel to extend therethrough. In some embodiments, the tapered inner wall section 464 can act as a manifold (e.g., a single-port manifold in some embodiments), or transition or manifold chamber, that receives the filling material from the interior chamber 452 and delivers it to the delivery vessel 5 by way of the lumen 462.

When the delivery vessel 5 is coupled to the housing 409, an actuating force can be applied to obturation material housed within the housing 409 to cause the obturation material to flow from the interior chamber 452, through the tapered inner wall section 464, and through the delivery vessel 5. In some embodiments, the actuating force can be applied by the activation mechanism 8 of the handpiece 3. In some embodiments, one or more components of the activation mechanism 8 extend through the opening 456 at the proximal end of the housing 409 to cause the obturation material to flow distally through the housing 409 and delivery vessel 5. In some embodiments, the housing 409 includes a piston or plunger capable of moving within the housing 409 to cause the flow of fluid therein. The plunger can create a seal along the sidewalls of the internal chamber 452 of the housing 409 so that fluid is confined to the section of the internal chamber 452 between the plunger and the interface between the housing 409 and the opening 458 at the distal end 460 of the housing 409. The plunger can be positioned to receive a portion of the activation mechanism 8 to cause movement of the piston or plunger within the housing 409.

The housing 409 can be received within or coupled to the handpiece 3. The handpiece 3 and housing 409 can include one or more complementary coupling features to facilitate coupling. As shown in FIGS. 4A-4B, the housing 409 can include a plurality of tracks or slots 466 extending from the proximal end 454 and configured to receive a protrusion extending from the handpiece 3 or a fastener extending through a portion of the handpiece 3. The tracks 466 can include one or more bends or curves so that the protrusions extending from the handpiece 3 can be advanced to a position in the tracks 466 in separation of the housing 409 from the handpiece 3 is restricted. For example, the tracks 466 can include at least one portion extending circumferentially about the housing 409. When positioned therein, distal movement of the housing 409 with respect to the handpiece 3 is restricted.

As described herein, various obturation materials can comprise a mixture of two or more component compositions that may be mixed prior to entering the tooth. For example, in some embodiments, a filling or obturation material may be hardened by utilizing a multi-component (e.g., two component) chemically curable system. Hardening of such multi-component materials may comprise mixing of stoichiometric or approximately stoichiometric relative amounts of initially separate components, herein termed component A and component B, which can then undergo chemical reactions to form a hardened material. As described above, mixing may occur immediately prior to delivering the material into the root canal system (or other treatment region). For example, in some embodiments, component A and component B can be mixed in the handpiece 3, within the housing 9, and/or within the delivery vessel 5. The components A and B can therefore be delivered as a mixture to the tooth. In some embodiments, the component A can be a base and the component B can be a catalyst.

FIG. 4C depicts a schematic side view of a housing 509 coupled to a delivery vessel 505, accordance with embodiments disclosed herein. FIG. 4D is a schematic side cross-sectional view of the housing 509 and delivery vessel 505. The housing 509 can include any of the features and functions described with respect to the housing 409 with reference to FIGS. 4A-4B. In some embodiments, the housing 509 can be attached to an end portion of or positioned within a handpiece, such as handpiece 3. The housing 509 comprises a first housing chamber 552A, a second housing chamber 552B, a manifold 551, a manifold chamber 553, and a lumen 562 at a distal end of the housing 509. Each of the housing chamber 552A and the housing chamber 552B can receive and store a component composition that can be mixed to form an obturation material. For example, in some embodiments, the housing chamber 552A can receive and store one of the component A and the component B and the housing chamber 552B can receive and store the other of component and component B.

In some embodiments, the housing chamber 552A and/or the housing chamber 552B can have a volume in a range of 0.1 mL to 3 mL, in a range of 0.1 mL to 1.5 mL, in a range of 0.1 mL to 1 mL, in a range of 0.25 mL to 1.5 mL, in a range of 0.3 mL to 1.5 mL, or in a range of 0.4 mL to 1.5 mL. In various embodiments, the housing chamber 552A and/or the housing chamber 552B can have a volume of 0.3 mL, 0.5 mL, 0.75 mL, 1.0 mL, greater than 0.3 mL, or any other suitable size. In some embodiments, one or both of the chambers 552A and 552B can have a length of between 15 mm to 45 mm, between 20 mm to 35 mm, or between 25 mm to 30 mm, e.g., 28.1 mm. In some embodiments a diameter at a proximal end of one or both of the chambers 552A and 552B, respectively, can be between 1 mm to 5 mm or between 2 mm to 4 mm. In some embodiments, the diameter at the proximal end of one or both of the chambers 552A and 552B can be 1.9 mm or 3.9 mm. In some embodiments, the first housing chamber 552A and the second housing chamber 552B can be about the same size and hold about the same volume of component materials A and/or B. In other embodiments, the first and second chambers 552A, 552B can be different sizes. Furthermore, although two chambers 552A, 552B are illustrated in FIG. 4D, in other embodiments, more than two chambers may be provided, e.g., to mix more than two component materials. Although dimensions and ranges of dimensions are provided for various diameters of chambers 552A, 552B and other chambers disclosed herein, it should be appreciated, however, that the chambers may or may not be circular in cross-section. In various embodiments, the chambers can be polygonal, elliptical, or any other suitable cross-section. In such embodiments, the dimensions provided for the diameters described herein can correspond to major dimensions of the cross-sectional shape of the chambers.

In some embodiments, the housing 509 includes a piston or plunger assembly 596 capable of moving within the housing 509 to cause the flow of fluid therein. The plunger 596 assembly can include a plunger head 591, a plunger rod 597A, a plunger rod 597B, a plunger stopper 598A, and a plunger stopper 598B. The plunger rod 597A and the plunger rod 597B can each extend distally from the plunger head 591. Alternatively, each of plunger rod 597A and plunger rod 597B may be connected to a separate plunger head. The plunger stopper 598A and the plunger stopper 598B can be coupled to the distal ends of the plunger rod 597A and the plunger rod 597B, respectively.

The plunger stopper 598A and the plunger stopper 598B can be positioned within the housing chamber 552A and the housing chamber 552B, respectively, such that distal movement of the plunger head 591 causes distal movement of the plunger stopper 598A and the plunger stopper 598B within the housing chamber 552A and the housing chamber 552B, respectively. The plunger stopper 598A can create a seal along the sidewalls of the housing chamber 552A of the housing 509 so that fluid is confined to the section of the internal housing chamber 552A between the plunger stopper 598A and a distal opening 573A at a distal end of the housing chamber 552A. The plunger stopper 598B can create a seal along the sidewalls of the housing chamber 552B of the housing 509 so that fluid is confined to the section of the internal housing chamber 552B between the plunger stopper 598B and a distal opening 573B at a distal end of the housing chamber 552B. In some embodiments, the plunger head 591 can be positioned to receive a portion of the activation mechanism 8 to cause movement of the plunger assembly 596 within the housing 509. In some embodiments, the diameter of one or both of the distal opening 573A and the distal opening 573B can be between 0.5 mm to 4 mm, between 0.75 mm to 1.25 mm, between 1 mm to 2 mm, between 1.5 mm to 2.5 mm, between 2 mm to 3 mm, or between 3 mm to 4 mm. In some embodiments, the diameter of one or both of the distal opening 573A and the distal opening 573B can be 1 mm or 2 mm.

The manifold chamber 553 can be defined by an interior section or surface of the manifold 551 (e.g., the interior sidewall of the manifold 551). In some embodiments, the manifold chamber 553 may be placed in fluid communication with the housing chamber 552A and the housing chamber 552B. The manifold chamber 553 can be positioned distal the chambers 552A, 552B to receive the component compositions from housing chamber 552A and housing chamber 552B during a treatment procedure. For example, component A and component B can be driven from the respective chambers 552A, 552B and can merge and/or mix at least partially within the manifold chamber 553. In some embodiments, the manifold 551 can comprise an access mechanism 555 configured to facilitate access between the manifold chamber 553 and the housing chambers 552A and 552B, e.g., to access or fluidly communicate with the filling material components in the housing chambers 552A, 552B. In some embodiments, the access mechanism 555 is configured to facilitate communication between the manifold chamber 553 and the components of the filling material within the housing chambers 552A and 552B. As shown in FIGS. 4C-4D, the access mechanism can comprise a recessed portion within the chamber 553 configured to receive a cap 568. The cap 568 can move between a first configuration, in which migration of fluid into the manifold chamber 553 is prevented or restricted and a second position in which migration of fluid into the manifold chamber 553 is permitted. The recessed portion of the access mechanism 555 shown in FIG. 4D can be shaped to receive portions of the cap 568 (including the posts 570A, 570B) when the cap 568 (and posts 570A, 570B) are displaced from the distal openings of the housing chambers 552A 552B.

As shown in FIG. 4D, a post 570A can extend through the distal opening 573A of the housing chamber 552A and reside within a distal section of the housing chamber 552A. A post 570B can extend through the distal opening 573B of the housing chamber 552B and reside within a distal section of the housing chamber 552B. The post 570A and the post 570B can be shaped and sized to prevent the migration of fluid or other flowable material out of the distal ends of the housing chamber 552A and the housing chamber 552B, respectively, when positioned within the housing chamber 552A and the housing chamber 552B. For example, if the material components are provided in the respective chambers 552A, 552B without such posts 570A, 570B, in some cases the material may leak or otherwise migrate out the distal end of the housing 509 without being driven actively by an activation mechanism. In some embodiments, the diameter of one or both of the posts 570A and 570B can be between 0.5 mm to 4 mm, between 0.75 mm to 1.25 mm, between 1 mm to 2 mm, between 1.5 mm to 2.5 mm, between 2 mm to 3 mm, or between 3 mm to 4 mm. In some embodiments, the diameter of one or both of the posts 570A and 570B can be 1 mm or 2 mm. In some embodiments, the length of one or both of the posts 570A and 570B can be between 1 mm to 4 mm, between 1 mm to 2 mm, between 2 mm to 3 mm, between 3 mm to 4 mm, or between 1.5 mm to 2 mm. In some embodiments, the length of one or both of the posts 570A and 570B is 1.8 mm.

In some embodiments, initiation of fluid flow within the housing chamber 552A and the housing chamber 552B, for example, by activation mechanism 8 in connection with plunger assembly 596, can cause the fluid or flowable material within the housing chamber 552A and the housing chamber 552B to displace the post 570A and the post 570B out of the distal openings 573A and 573B of the chambers 552A and 552B and at least partially into the manifold chamber 553. FIG. 4E is a schematic side cross-sectional view illustrating a section of the housing 509 and delivery vessel 505 in which the post 570A and the post 570B are shown displaced from the housing chamber 552A and the housing chamber 552B, respectively. FIG. 4F is a perspective view illustrating action of the housing 509 and delivery vessel 505 in which the post 570A and the post 570B are shown displaced from the housing chamber 552A and the housing chamber 552B, respectively

In some embodiments, the post 570A and the post 570B extend proximally from the cap 568 positioned within the manifold chamber 553. In some embodiments, the cap 568 can have a thickness of between 0.5 mm to 1 mm, e.g., 0.7 mm. In some embodiments, as shown in FIG. 4E, after the post 570A and 570B are displaced out of the housing chamber 552A and the housing chamber 552B, the cap 568 can separate the manifold chamber 553 into a flow field region 572 extending between the distal openings 573A and 573B of the respective chambers 552A, 552B and the cap 568, and a funnel region 574 extending between the cap 568 and the lumen 562. The sidewalls of the housing 509 defining the funnel region 574 may taper distally towards the lumen 562. In some embodiments, the tapered sidewalls of the funnel region can enable or improve mixing of the component compositions extruded from the housing chamber 552A and the housing chamber 552B. In some embodiments, the funnel region 574 may include one or more surface features that enable or improve mixing of the component compositions extruded from the housing chamber 552A and the housing chamber 552B.

The cap 568 can include a port 576 to allow fluid flow between the flow field region 572 and the funnel region 574. The port 576 can enable or improve the mixing of the component compositions extruded from housing chamber 552A and housing chamber 552B. In some embodiments, the port 576 can be opened or ruptured due to the pressure of the flowable component materials. In other embodiments, the port 576 can be opened or accessed in other ways. In various embodiments, the port 576 may be open yet unexposed to the filling material. For example, as explained herein, when pressure is applied to the filling material, the cap 568 can be pushed distally to expose the port 576 and to enable the filling material to flow outwardly through the port 576. In some embodiments, the port 576 can be elliptical or generally elliptical in shape. In some embodiments, the port 576 can be kidney or arc shaped. A kidney or arc shape can induce higher strain rates and therefore promote shear thinning. In some embodiments, the port 576 can be located centrally between the housing chamber 552A and the housing chamber 552B. In some embodiments, the port 576 can be positioned closer to one of the chambers 552A and 552B. For example, in embodiments in which one of the chambers 552A and 552B houses a catalyst and the other of chambers 552A and 552B houses a base, the port 576 can be positioned closer to the chamber housing the base. Such a configuration may improve mixing component compositions prior to entering funnel region 574, for example, by driving the separate component compositions towards one another. In some embodiments, the cap 568 can include a plurality of ports 576. In some embodiments, the plurality of ports 576 may be heterogenous, e.g., an arc shaped port and an elliptical port. In some embodiments, the plurality of ports 576 can be homogenous, e.g., a plurality of arc shaped ports or a plurality of elliptical ports. Although not shown in FIGS. 4A-4B, it should be appreciated that a cap and/or a post may also be provided in the housing 409 to prevent inadvertent migration of component materials from the housing.

In some embodiments, the post 570A and the post 570B can enable or improve mixing of the component compositions extruded from the housing chamber 552A and the housing chamber 552B. For example, the posts 570A and 570B can be shaped or otherwise configured to direct the flow of fluid from the housing chamber 552A and the flow of fluid from the housing chamber 552B, respectively, towards a common mixing area, e.g., towards a central region of the manifold chamber 553. As shown in FIGS. 4D-4E, the post 570A and the post 570B are beveled at their proximal ends. The posts 570A and 570B may be beveled to cause the component compositions housed within the housing chamber 552A and the housing chamber 552B to flow medially within the housing 509, for example, towards a centerline extending through the housing 509. In some embodiments, the length of a beveled portion of one or both of the posts 570A and 570B can be between 0.2 mm to 2 mm, between 0.2 mm to 1 mm, between 0.4 mm to 0.8 mm, or 0.7 mm to 1.1 mm. In some embodiments, the length of the beveled portion of one or both the posts 570A and 570B can be 0.6 mm or 0.9 mm. Medial flow of the component compositions can enable or improve mixing of the component compositions prior to entry into the funnel region 574. While beveled posts 570A and 570B are shown in FIGS. 4D-4E, it should be recognized that any shape configured to encourage medial flow of the component compositions may be employed. In alternative embodiments, proximal ends of the post 570A and the post 570B can be flat or generally flat.

As shown in FIGS. 4D-4E, in some embodiments, a strut 578 may extend across the port 576. The strut 578 can be positioned within the port 576 or distal to the port 576. In some embodiments, the strut 578 is part of the cap 568. In some embodiments, the strut 578 can enable or improve mixing of the component compositions extruded from the housing chamber 552A and the housing chamber 552B.

As shown in FIGS. 4C-4D, the delivery vessel 505 includes a reduction conduit 507 and the capillary 515. The capillary 515 can include any of the features and functions described with respect to the capillary 105, the capillary 205, and/or the capillary 305 described with reference to FIGS. 3A-3D.

As explained above in connection with FIGS. 3A-3D, the inner diameter of a lumen 340 of the capillary 515 and the outer diameter of the capillary 515 may be very small so as to enable insertion of the capillary 515 into the root canal(s) of the tooth to be obturated. By contrast, the width or diameter of the manifold chamber 553 of the housing 509 may be significantly larger than the inner diameter of the lumen 540, because the manifold chamber 553 may be used to receive and mix a volume of the flowable obturation materials from chambers 552A and 552B. In various embodiments, for example, volume of the manifold chamber 553 of the housing can be in a range of 0.03 mL to 0.17 mL, e.g., 0.05 mL. Because the diameter or width of the manifold chamber 553 is substantially larger than the diameter or width of the capillary 515, it can be important to provide a transition region between the manifold chamber 553 and the capillary 515. As shown in FIGS. 4D-4E, the funnel region 574 can provide a first reduction in width or diameter so as to transition the flow of obturation material to the delivery vessel 505. The lumen 562 of the housing 509 can provide a second reduction in width or diameter so as to transition the flow of obturation material to the delivery vessel 505.

To further improve the transition of flow to the capillary 515, the delivery vessel 505 can include conduit 507 as a transition between the housing 509 and the capillary 515. In some embodiments, the reduction conduit 507 can enable or improve mixing of the component compositions of the obturation material.

As shown in FIG. 4D proximal end 511 of the capillary 515 is configured to be received within a distal end 513 of the reduction conduit 507. A proximal end 514 of the reduction conduit 507 is configured to be received within the lumen 562 of the housing 509. The obturation material can flow from the chamber 553 through the proximal end 514 of the reduction conduit and out of the distal end 517 of the capillary 515 into the treatment region.

In various embodiments, for example, a proximal end of the reduction conduit 507 (which can couple or connect to the opening at the distal end of the housing 509) can have a diameter or width in a range of can be between 750 microns to 2,000 microns, between 750 microns to 1,500 microns, between 1,000 microns to 2,000 microns, between 1,000 microns and 1,500 microns, or between 1,000 microns to 1,200 microns, e.g., 1100 microns. A distal end of the reduction conduit 507 (which can couple or connect to the inlet port at the proximal end of the capillary 515) can have a diameter or width in a range of 100 microns to 1,000 microns, between 200 microns to 300 microns, e.g., 250 microns, or between 400 microns to 600 microns, e.g., 500 microns. Thus, in some embodiments, a reduction ratio R can be defined as the ratio of the diameter or width at the proximal end of the conduit 807 to the diameter or width at the distal end of the conduit 807. In some embodiments, a reduction ratio R can be defined as the ratio of the diameter or width at the proximal end of the conduit 507 to the diameter or width at the distal end of the conduit 507. In various embodiments, the reduction ratio R can be in a range of 1.5 to 20, in a range of 2 to 20, in a range of 2 to 10, in a range of 2 to 8, or in a range of 2 to 5. Beneficially, therefore, the reduction conduit 507 can provide a transition region to enable smooth flow between the interior manifold chamber 553 of the housing 509 and the inner lumen of the capillary 515. In some embodiments, the reduction conduit can include a first segment having a first diameter, a second segment having a second diameter, and a third segment having third diameter. The first diameter can be between 750 microns to 2,000 microns, between 750 microns to 1,500 microns, between 1,000 microns to 2,000 microns, between 1,000 microns and 1,500 microns, or between 1,000 microns to 1,200 microns, e.g., 1100 microns. The second diameter can be between 100 microns to 1,000 microns, between 200 microns to 300 microns, e.g., 250 microns, or between 400 microns to 600 microns, e.g., 500 microns. The third diameter can be between 100 microns to 1,000 microns, between 200 microns to 300 microns, e.g., 250 microns, or between 400 microns to 600 microns, e.g., 500 microns. The third diameter can be less than the second diameter. In some embodiments, a length of the reduction conduit 507 can be between 5 mm to 50 mm, between 10 mm to 40 mm, between 20 mm to 30 mm, or between 24 mm to 26 mm. In some embodiments, the length of the first segment of the reduction conduit 507 can be between 2 mm to 10 mm, between 5 mm to 10 mm, between 5 mm to 15 mm, or between 6 mm to 8 mm. In some embodiments, the length of the second segment of the reduction conduit can be between 5 mm to 15 mm, between 10 mm to 15 mm, between 10 mm to 20 mm, or between 11 mm to 13 mm. In some embodiments, the length of the third segment of the reduction conduit can be between 1 mm to 10 mm, between 3 mm to 7 mm, or between 4 mm to 6 mm.

Although dimensions and ranges of dimensions are provided for various diameters of reduction conduit 507 and other reduction conduits disclosed herein, it should be appreciated, however, that the reduction conduits may or may not be circular in cross-section. In various embodiments, system components can be polygonal, elliptical, or any other suitable cross-section. In such embodiments, the dimensions provided for the diameters described herein can correspond to major dimensions of the cross-sectional shape of the reduction conduits.

In some embodiments, a mixer 580 can be positioned within the fluid path between the chambers 552A and 552B and the capillary 515 to enable or improve mixing of component compositions of the obturation material. As shown in FIGS. 4D and 4E, the mixer 580 can be positioned at least partly within the reduction conduit 507, e.g. at or near a proximal portion of the reduction conduit 507. The mixer 580 may also be positioned at least partially within the housing 509, for example, in the funnel region 574. The mixer can include a plurality of plate elements 582 positioned to encourage mixing of component compositions of the obturation material as the obturation material flows through the mixer 580.

In some embodiments, the mixer 580 can comprise a static mixer. In some embodiments, the mixer can comprise a helical static mixer. The plate elements 582 of the mixer 580 can alternatively twist left and right. A trailing edge of each plate element 582 may be perpendicular to the leading edge of the adjacent downstream plate element 582. The geometry of the mixer 580 can mix the component compositions of the obturation material by continually cutting, dividing, folding, stretching, and recombining fluid streams. In some embodiments, the plate elements 582 have a length of approximately between 1 to 3 diameters of the bore of the static mixer 580. In some embodiments, the plate elements 582 have a length of approximately between 1 to 1.5 diameters of the bore of the static mixer 580. As shown in FIGS. 4D and 4E, the mixer 580 can comprise a multi-sized static mixer having multiple sizes of plate elements 582 therein. FIGS. 4D and 4E show a first element 582A and a plurality of elements 582B that are smaller than the first element 582A. The first element 582A is positioned within the funnel region 574 while the smaller elements 582B are positioned within the reducer conduit 507. In other embodiments, each plate element 582 within the static mixer is of the same size or substantially the same size. The mixer 580 may include any suitable number of plate elements 582, including, but not limited to 1, 2, 3, 4, 5, 6, 7, 8, 9, 10, 11, 12, 13, 14, and 15 elements. In some embodiments, the plate elements 582 can induce higher strain rates and therefore promote shear thinning. In some embodiments, the strain rates are highest at the lateral edges of each plate element 582. In some embodiments, the static mixer can be a KMS mixer, an SMX mixer, or an SMXL mixer.

Although the chambers 552A and 552B are shown as a portion of the housing 509 in FIGS. 4C-4F, in some embodiments, one or both of the chambers 552A and 552B may be part of a separate cartridge or other fluid container than can be coupled with the manifold 551. For example, in some embodiments, the chambers 552A and 552B can be configured to be received within the manifold chamber 553, e.g., the distal portion of the chambers 552A, 552B of a cartridge may comprise one or more mechanical connection portions configured to connect to the manifold 551. In some embodiments, the chambers 552A and 552B can couple to the manifold 551 through a threaded connection. In other embodiments, the chambers 552A, 552B can couple to the manifold 551 through a snapfit connection or other arrangement. As described above, the access mechanism 555 can be configured to facilitate access between the manifold chamber 553 and the housing chambers 552A and 552B (which can contain components of a filling material). In some embodiments, the access mechanism 555 is configured to facilitate communication between the manifold chamber 553 and the components of the filling material within the housing chambers 552A and 552B. In some embodiments, the distal openings 573A and 573B of the chambers 552A and 552B, respectively, may be filled with the material configured to prevent the migration of fluid, or a foil or other cover may be provided over ports of the openings. In some embodiments, an access mechanism of the manifold 551 can be configured to rupture the material (or foil or cover) or otherwise facilitate fluid communication between the chambers 552A and 552B and the chamber 553. For example, the access mechanism (which can be coupled to or formed with the manifold 551) can include one or more features that push through and break an occlusal surface of the material configured to prevent the migration of fluid when then manifold 551 is coupled to the chambers 552A and 552B. For example, these features can comprise various puncture devices, such as a series of spikes, beveled posts (e.g., one per chamber), or tapered points (e.g., one per chamber). In some embodiments, these features can be static such that the mechanical interface is designed so that during connection these features protrude into the chambers and through the occlusal surface. In another embodiment, these features can be dynamic and activated automatically or via user action. For example, the aforementioned puncture shapes can be spring loaded and deployed by a user-initiated mechanical action (e.g., a button press) or can be automatically activated when, during connection, chambers 552A and 552B reach a certain location relative to a fixed location within chambers 552A and 552B (a face, edge, surface, etc). In some embodiments, the material configured to prevent the migration of fluid can be biocompatible and/or dissolvable to prevent or reduce flow blockage after rupture. The material and its surrounding fixture can be constructed such that, during rupture, a membrane of the material remains intact as a single piece and splits apart in well-defined, repeatable parts (for example, a central opening surrounded by “petals”). In some embodiments, the material configured to prevent the flow of migration is a rupture film, foil, or a controlled rupture device.

FIG. 4G is perspective view of a section housing 609, a delivery vessel 605, and a mixer 680. The housing 609, the delivery vessel 605, and the mixer 680 can include any of the same features and functions described with respect to the housing 509, the delivery vessel 505, and the mixer 580 with reference to FIGS. 4C-F. A cap 668 within the housing can include a port 676 having a kidney or arc shape. As described herein, a kidney or arc shape can induce higher strain rates and therefore promote shear thinning. As shown in FIG. 4G, the port 676 can be positioned closer to one of chambers 652A and 652B of the housing 609, which each hold a component composition for an obturation material. For example, in embodiments in which one of the chambers 652A and 652B houses a catalyst and the other of chambers 652A and 652B houses a base, the port 676 can be positioned closer to the chamber housing the base. Such a configuration may improve mixing component compositions prior to entering a funnel region 674, for example, by driving the separate component compositions towards one another.

The mixer 680 can be a stamped ribbon mixer having plate elements 682. The plate elements 682 may include flatter surfaces and less curvature in comparison to the plate elements 582 shown in FIGS. 4D-4E. In some embodiments, the mixer 680 may include multiple sizes of plate elements 682. In other embodiments, the mixer 680 may include only a single size of plate elements 682.

In some embodiments, a cap, such as cap 568 or cap 668, can include geometrical features that promote mixing. For example, FIGS. 4H and 4I depict a schematic bottom view and a schematic cross-sectional side view, respectively, of a cap 768 having a post 770A and a post 770B. The cap 769 can include a network of component-carrying estuaries or channels 771A that are configured to deliver fluid from a proximal portion of the post 770A out of a distal surface of the cap 768 and a network of component-carrying estuaries or channels 771B that are configured to deliver fluid from a proximal portion of the post 770B out of a distal surface of the cap 768. The network of component-carrying estuaries 771A can include a plurality of outlet ports 772A on the distal surface of the cap 768, and the network of component-carrying estuaries 771B can include a plurality of outlet ports 772B on the distal surface of the cap 768. In some embodiments, paths of fluid flow within the network of component-carrying estuaries 771A and network of component-carrying estuaries 771B are designed such that the surface area of the two components is greatly increased at the distal surface or exit plane of the cap. For example, each of the network of component-carrying estuaries 771A and the network of component-carrying estuaries 771B can include a single inlet port and a plurality of outlet ports.

In some embodiments, the cap 768 can include a plurality of microfluid channels configured to direct fluid flowing into the posts 770A and 770B into one or more chambers within the cap 768 in which the fluid flowing into the post 770A and the post 770B can mix. In some embodiments, the material exiting the cap 768 can be at least partially or fully mixed.

In some embodiments, prior to initiation of fluid flow, the outlet ports 772A and 772B may be occluded with a material configured to prevent the migration of fluid out of the outlet ports 772A and 772B prior to initiation of fluid flow. In some embodiments, the distal end of the chambers within the cap 768 may be occluded with the material configured to prevent migration. In some embodiments, the distal openings 573A and 573B of the chambers 552A and 552B, respectively, may be occluded with the material configured to prevent the migration of fluid. In some embodiments, the material can be configured to rupture during pressurization. The material can be biocompatible and/or dissolvable to prevent or reduce flow blockage after rupture. The material and its surrounding fixture can be constructed such that, during rupture, a membrane of the material remains intact as a single piece and splits apart in well-defined, repeatable parts (for example, a central opening surrounded by “petals”). In some embodiments, the material configured to prevent the flow of migration is a rupture film or a controlled rupture device. In another embodiment, the distal openings 573A and 573B of the chambers can each be fitted with a check valve style device which opens, and remains open, after a defined amount of pressure is applied, but is closed prior to application of the defined amount of pressure. In some embodiments, above the defined amount of pressure, the size of the check valve opening may be proportional to the applied pressure so that the flow rate is variable. In another embodiment, it is possible to initiate a controlled occlusal surface rupture using a two-part assembly whereby a downstream component, such as the manifold 551 is physically connected to an upstream material chamber, such as chambers 552A and 552B. The rupture can be mechanically induced when the two components are connected via features of an access mechanism that push through and break an occlusal surface of the material configured to prevent the flow of migration. For example, these features can take the form of a series of spikes, beveled posts (e.g., one per chamber), or tapered points (e.g., one per chamber). In some embodiments, these features can be static such that the mechanical interface is designed so that during connection these features protrude into the chambers and through the occlusal surface. In another embodiment, these features can be dynamic and activated automatically or via user action. For example, the aforementioned puncture shapes can be spring loaded and deployed by a user-initiated mechanical action (e.g., a button press) or can be automatically activated when, during connection, the upstream component reaches a certain location relative to a fixed location within the upstream component (a face, edge, surface, etc).

Beneficially, the embodiments disclosed in FIGS. 4C-4I can enable thorough mixing of multi-component flowable obturation materials, while enabling shear-thinning flow of the obturation material within geometries small enough to fit within a root canal of the tooth. In various embodiments disclosed herein, the component materials A and B can mix partially within the manifold chamber 553, partially within the funnel region 574, partially within the mixer 580 (including at elements 582A and/or 582B), partially within the reduction conduit 507, and partially within the capillary 515. In some embodiments, a majority of the mixing can occur upstream of the capillary 515, and a minority of the mixing can occur within the capillary 515. In some embodiments, the flowable obturation material is fully mixed within the manifold chamber 553. In some embodiments, the flowable obturation material is fully mixed within the mixer 580.

In some embodiments, the housing 409, the housing 509, or the housing 609 can comprise a wireless chip (such as a radio frequency identification, or RFID, chip) configured to wirelessly communicate with the console 2 or with a reader that is in communication with the console 2. The RFID chip can be used to confirm what type of housing is being used with the system 1. For example, the RFID chip can store information regarding the housing, such the number of chambers within the housing configured to hold a component of an obturation material. This information can be used to track information regarding the treatment procedure and/or to ensure that the proper procedure is being performed with the particular housing.

### V. Examples of Handpieces

FIG. 5A is a schematic side view of a handpiece 803 for treating a tooth, e.g., obturating a root canal, filling a carious region, etc. FIG. 5B is a schematic side cross-sectional view of the handpiece 803 shown in FIG. 5A. FIG. 5C is a schematic side cross-sectional view showing an enlarged section of the handpiece 803. The dental handpiece 803 can include a body or housing shaped to be gripped by the clinician. In some embodiments, a delivery vessel 805 can be coupled to or formed with a distal portion of the handpiece 803. Before a treatment procedure (e.g., a cleaning procedure, an obturation procedure, a restorative procedure, etc.), the clinician can connect the handpiece 803 to an interface member 4 of the system 1. The interface member 4 can be in fluid and/or electrical communication with the console 2 (see FIG. 2), which can be configured to control the treatment procedures. The interface member 4 may be similar to or the same as the interface members disclosed in U.S. patent application Ser. No. 14/172,809, filed on Feb. 4, 2014, entitled “DENTAL TREATMENT SYSTEM,” and in U.S. Patent Publication No. US 2012/0237893, each of which is incorporated by reference herein in its entirety and for all purposes. In some embodiments, the handpiece 803 can comprise a wireless chip (such as a radio frequency identification, or RFID, chip) configured to wirelessly communicate with the console 2 or with a reader that is in communication with the console 2. The RFID chip can be used to confirm what type of handpiece 803 is being used with the system 1. For example, the RFID chip can store information regarding the handpiece 803, such as whether the handpiece 803 is a cleaning handpiece, an obturation handpiece, or both. This information can be used to track information regarding the treatment procedure and/or to ensure that the proper procedure is being performed with the particular handpiece 803. Additional details of such a wireless chip system for the handpiece are disclosed in U.S. patent application Ser. No. 14/172,809, filed on Feb. 4, 2014, entitled “DENTAL TREATMENT SYSTEM,” which is incorporated by reference herein in its entirety and for all purposes.

The clinician can manipulate the handpiece 803 such that the delivery vessel 805 is positioned near the treatment region on or in the tooth (e.g. within one or more root canal(s) of the tooth). The clinician can activate an activation mechanism 808 using controls on the console 2 and/or the handpiece 803, and can perform the desired treatment procedure, for example, filling the treatment region (obturating the root canal(s), filling a treated carious region, etc.). After performing the treatment procedure, the clinician can disconnect the handpiece 803 from the interface member 4 and can remove the handpiece 803 from the system 1. The handpiece 803 shown in FIGS. 5A-5B can advantageously be configured to obturate or fill the tooth. In other embodiments, the handpiece 803 may also be configured to clean the tooth. In some embodiments, the clinician can position the handpiece 803 at or against the treatment region during a treatment procedure.

In some embodiments, the handpiece 803 can include an engagement portion configured to connect to the housing 409 or a chamber within the housing 409. In various embodiments, the engagement portion can comprise mechanical fasteners or connectors to connect to corresponding features of the housing 409 or chamber of the housing 409. In some embodiments, the engagement portion can be configured to connect to the manifold. As shown in FIGS. 5A-5B, in some embodiments, the handpiece 803 can define a chamber 806 configured to removably receive the housing 409. The housing 409 can house a fluid, such as obturation material therein. The housing 409 can be a disposable cartridge in some embodiments. In some embodiments, a proximal end 456 (see FIGS. 4A-4B) of the housing 409 is sized and shaped to removably couple to or otherwise be received within the chamber 806. A distal end 460 of the housing 409 can include an opening 458 (see FIG. 4B) sized and shaped to removably receive a delivery vessel 405 therein. Alternatively, the delivery vessel 805 may be integrally formed with or irremovably secured within the housing 409. While the housing 409 is positioned within or coupled with the chamber 806, a clinician can activate the activation mechanism 808 to drive the flow of fluid out of the opening 458 at the distal end 460 of the housing 409 and through the delivery vessel 805 (see FIGS. 4A-4B). In some embodiments, the chamber 806 of the handpiece 803 can be configured to retain fluid, such as obturation material, therein.

As shown in FIG. 5B, the handpiece 803 includes a plunger 896 configured to move within the housing 409 to cause the flow of fluid therein. In various embodiments, the plunger 896 can be coupled to and/or formed with the handpiece 803, and, upon engagement of the housing 409 with the handpiece 803, the plunger 896 can be driven within the internal chamber 452 of the housing 409 (see FIG. 4B). The plunger can create a seal along the sidewalls of the internal chamber 452 of the housing 409 so that fluid is confined to the section of the internal chamber 452 (see FIG. 4B) between the plunger 896 and the interface between the housing 409 and the opening 458 at the distal end 460 of the housing 409. The plunger 896 can be positioned to receive a portion of the activation mechanism 808 to cause movement of the plunger 896 within the housing 409.

As shown in FIG. 5B, the activation mechanism 808 can comprise a motor 890, a drive element (such as a leadscrew 892), and a leadscrew nut 894. The leadscrew 892 can be coupled to or integrally formed with the motor 890. In operation, the motor 890 can be actuated to drive the leadscrew 892. A proximal end 889 of the leadscrew nut 894 can include one or more features for operatively coupling with the leadscrew 892. For example, in some embodiments, the proximal end 889 can include a recess 897 having threads 898 positioned to engage complementary threads 899 of a distal end of the leadscrew 892. When driven by the motor 890, the leadscrew 892 can move the leadscrew nut 894 distally within the handpiece 803 towards a distal end of the handpiece 803, or proximally within the handpiece 803 in a direction of a proximal end of the handpiece 803. The distal end 810 of the leadscrew nut 894 can be shaped and sized to couple with a proximal end 812 of the plunger 896. Alternatively, the piston 896 can be integrally formed with the lead screw nut 894. Movement of the leadscrew nut 894 distally within the handpiece 803 can cause movement of the plunger 896 distally within the handpiece 803, for example, within the housing 409, to drive fluid within the housing 409 through the delivery vessel 805. In some embodiments, the housing 409 includes an opening 454 at its proximal end for receiving the leadscrew nut 894 and/or piston 896 (see FIG. 4B). In some embodiments, actuation of the motor 890 causes the lead screw nut and plunger 896 to advance distally within the housing 409. In such embodiments, the lead screw nut 894 can advance distally within the handpiece 803 and through the opening of the housing 409 to engage the plunger 896 and cause movement of the plunger 896 distally within the housing 409 and towards the delivery vessel 805. Although the drive element illustrated herein comprises a leadscrew, other types of drive elements may be suitable to operably couple the motor with the plunger.

The motor 890 can be any motor suitable for providing a driving force to the leadscrew 892 capable of driving obturation material through the delivery deice 805. The motor 890 can be a Polulu 986:1 motor, a 1000:1 HPCB 6V motor, an 8 mm brushless motor (e.g., an ECX SPEED 8M 3W motor coupled to a 256:1 GPX 8 gearhead), and 8 mm brushed motor (e.g., a 6V RE8 motor coupled to a 256:1 GP8A gearhead), a 10 mm brushed motor (e.g., a 12V RE10 motor coupled with a GP 10A gearhead), or a 6 mm brushed motor (e.g. a 6V RE6 motor coupled with a GP 6A gearhead). Any suitable motor may be used.

As shown in FIGS. 5A-5C, the delivery vessel 805 includes a reduction conduit 807 and the capillary 815 (which may be the same as or generally similar to the capillary 305 described above). As explained above in connection with FIGS. 3A-3D, the inner diameter of the lumen 340 and the outer diameter of the capillary 815 may be very small so as to enable insertion of the capillary 815 into the root canal(s) of the tooth to be obturated. By contrast, the width or diameter of the interior chamber 452 of the housing 409 may be significantly larger than the inner diameter of the lumen 340, because the chamber 452 may be used to store a volume of the flowable obturation material(s). Because the diameter or width of the interior chamber 452 is substantially larger than the diameter or width of the capillary 815, it can be important to provide a transition region between the chamber 452 and the capillary 815. As shown in FIG. 4B above, the lumen 462 of the housing 409 can provide a first reduction in width or diameter so as to transition the flow of obturation material to the delivery vessel.

To further improve the transition of flow to the capillary 815, a reduction conduit 807 can be provided as a transition between the housing 409 and the capillary 815. In some embodiments, explained in more detail below, the reduction conduit 807 can enable or improve mixing of multi-component obturation materials. As shown in FIGS. 5A-5B, the reduction conduit 807 includes a bent or angled portion 891 along its length. The bent or angled portion 891 can facilitate access to all portions of the canal. In other embodiments, the reduction conduit 807 is straight or generally straight along its length. As shown in FIGS. 5A-5B, the reduction conduit further includes a plurality of a tapered segments, each segment tapered to a different degree along the axial dimension. In various embodiments, for example, a proximal end of the reduction conduit 807 (which can couple or connect to the opening 458 at the distal end 460 of the housing 409) can have a diameter or width in a range of 750 microns to 2,000 microns or between 1,000 microns to 1,200 microns, e.g., 1100 microns. A distal end of the reduction conduit 807 (which can couple or connect to the inlet port 138 at the proximal end 137 of the capillary 815 as shown in FIG. 3B) can have a diameter or width in a range of 100 microns to 1,000 microns, between 200 microns to 300 microns, e.g., 250 microns, between 400 microns to 600 microns, e.g., 500 microns, or between 100 microns to 500 microns, or between 500 microns to 1,000 microns. Thus, in some embodiments, a reduction ratio R can be defined as the ratio of the diameter or width at the proximal end of the conduit 807 to the diameter or width at the distal end of the conduit 807. In various embodiments, the reduction ratio R can be in a range of 1.5 to 20, in a range of 2 to 20, in a range of 2 to 10, in a range of 2 to 8, or in a range of 2 to 5. Beneficially, therefore, the reduction conduit 807 can provide a transition region to enable smooth flow between the interior chamber 452 of the housing 409 and the inner lumen 340 of the capillary 815/305. In some embodiments, the reduction conduit can include a first segment having a first diameter, a second segment having a second diameter, and a third segment having third diameter. The first diameter can be between 750 microns to 2,000 microns, between 750 microns to 1,500 microns, between 1,000 microns to 2,000 microns, between 1,000 microns and 1,500 microns, or between 1,000 microns to 1,200 microns, e.g., 1100 microns. The second diameter can be between 100 microns to 1,000 microns, between 200 microns to 300 microns, e.g., 250 microns, between 400 microns to 600 microns, e.g., 500 microns, or between 100 microns to 500 microns, or between 500 microns to 1,000 microns. The third diameter can be between 100 microns to 1,000 microns, between 200 microns to 300 microns, e.g., 250 microns, between 400 microns to 600 microns, e.g., 500 microns, or between 100 microns to 500 microns, or between 500 microns to 1,000 microns. The third diameter can be less than the second diameter.

As explained herein, the motor 890 can be activated at sufficient torques and/or speeds so as to impart a force against the plunger 896. The imparted force on the plunger 896 can in turn increase the pressure within the interior reservoir 452 of the housing 409 to a pressure sufficiently high so as to induce shear thinning of the obturation material in the reservoir 452, e.g., so as to cause the obturation material to be more flowable within the reduction conduit 891 and the capillary 815. Beneficially, therefore, the embodiments disclosed herein can enable the flow of obturation material from a relatively large interior chamber 452 (e.g. having a volume in a range of 0.1 mL to 3 mL) to a relatively small lumen 340 (e.g., having an inner diameter in a range of 10 microns to 450 microns). As explained above, the reduction conduit 891 can beneficially assist in transitioning the flow diameters between the chamber 452 and the capillary 815. In various embodiments disclosed herein, a motor controller can be configured to control the operation of the motor 890. It should be appreciated that the motor control techniques can be used in any or all of the embodiments disclosed in FIGS. 2-5E. The motor controller can comprise processing electronics (such as a processor configured to execute instructions stored on non-transitory computer-readable memory) in or on the console 2, or in or on the handpiece 3. The motor controller can send signals to the motor 890 to increase and/or decrease the rotational speed of the motor, which in turn can increase and/or decrease the pressure applied to the filling material in the chambers 552A, 552B by way of applying varying forces to the plunger 896.

In some embodiments, the activation mechanism (which can include the motor 890, motor controller, plunger 896 and other components disclosed herein) can be configured to modulate the forces applied to the plunger 896 and, accordingly, the pressures applied to the filling material in the chamber(s). In various embodiments, a filling treatment procedure can comprise a plurality of treatment portions. For example, in a priming portion of the treatment procedure, the delivery vessel 805 can be primed so as to initially fill the delivery vessel 805 along its length and to expel air from the distal end of the delivery vessel 805 (e.g., from the distal end of the capillary 815). During a first portion of the priming portion of the treatment procedure, the motor controller can send a signal to the motor 890 to rotate at a first speed S1, which can drive the plunger 896 (e.g., by way of the leadscrew 892) to apply a first pressure P1 to the filling material in the one or more chamber(s). During the first portion of priming, it can be desirable to drive the motor 890 at a high speed and to apply a high pressure P1 to the filling material, so as to rapidly drive the filling material through larger volume areas of the device, such as through the chamber of the housing 409 and through the reducer conduit 807. Driving the filling material at a high flow rate through the housing 409 and the reducer conduit 807 can reduce overall treatment times.

When the leading portion of the filling material reaches the interface between the reducer conduit 807 and the proximal end of the capillary 815, the proximal end of the capillary 815 (e.g., the inlet to the capillary) can act as a constricted flow portion that increases the impedance and reduces the flow rate of the filling material. The constricted flow portion can represent a relatively large reduction in area, and therefore a large increase in pressure applied at the interface between the reduction conduit 807 and the capillary 815. If the applied pressures are sufficiently high, then the joint between the capillary 815 and the reduction conduit 807 (which can comprise a glue joint or other connection) may be ruptured or broken. Thus, it can be advantageous to reduce the pressure of the filling material during priming so as to avoid damaging the joint between the capillary 815 and the reduction conduit 807, and/or to improve the flow transition into the capillary 815.

In various embodiments, the motor controller (or other controller or control system) can be configured to determine when the filling material reaches the constricted flow portion (e.g., the proximal end of the capillary 815). For example, when the filling material reaches the proximal end of the capillary 815, the constricted region can decrease the flow rate. The decreased flow rate can cause the motor speed and the corresponding motor current to decrease (or otherwise change). The motor controller (or other control system) can detect a change in current that corresponds to the constricted flow portion, and can send a signal to the motor to change (e.g., reduce) the motor speed and therefore the pressure applied to the chamber and filling material. The reduced pressure applied to the filling material can smooth the flow transition to the capillary 815 and maintain the mechanical integrity of the delivery vessel 805.

During a second portion of the priming procedure, the motor speed and applied pressure can therefore be reduced to drive the filling material along the length of the capillary 815, which can expel air from the distal end of the capillary 815. The reduction in motor speed and/or pressure can comprise a stepped reduction in motor speed and/or pressure, or a ramped reduction in motor speed and/or pressure. For example, in some embodiments, the motor speed and/or applied pressure can be reduced linearly as a function of time. In other embodiments, the motor speed and/or applied pressure can be reduced according to any other suitable function of time.

In a third portion of the treatment procedure, the clinician can fill the treatment region (e.g., a root canal or a treated carious region of a tooth) with the filling material. In the third portion of the treatment procedure, the filling material has filled the housing 409 and delivery vessel 805 such that the flow of filling material can be generally continuous and/or steady state. During treatment of the tooth, the clinician can adjust the motor speed and/or applied pressures by engaging a user interface of the console 2, or an interface on the handpiece 3. The motor speed (and therefore the pressure) can be adjusted to a plurality of speeds (and pressures), based on the status of the treatment procedure. In some embodiments, the controller can be configured to automatically adjust the speed and/or pressure during treatment. In various embodiments, the pressures applied during filling of the tooth can be the same as or different from the pressures applied during priming.

Although the embodiments described above indicate that the motor speed and/or applied pressure can be reduced or stepped down prior to reaching the proximal end (e.g., proximal end 137) of the capillary 815, it should be appreciated that the motor controller can control the speed and/or applied pressure at multiple portions along the length of the housing 409 and/or delivery vessel 805. In various embodiments, for example, the motor controller can reduce or otherwise change the motor speed (and accordingly the applied pressure) at a plurality of constricted flow portions, e.g., at various portions of the system where the diameter or major dimension of the housing or delivery vessel is reduced. In such embodiments, for example, the motor controller can monitor the motor current as the filling material passes through the system and, when the current changes, the motor controller can correlate the change in current to a particular longitudinal location along the housing 409 and/or delivery vessel 805. When the current change is correlated to a flow constriction, the motor controller can send a signal to the motor to change (e.g., reduce) the speed and accordingly the pressure applied to the filling material. For example, in some embodiments, the motor controller (or other controller or control system) can be configured to determine when the filling material reaches a constricted flow portion of the delivery vessel 805 proximal to the proximal end of the capillary 815 (e.g., a distal-most constricted flow portion of the reduction conduit 807). The motor controller (or other control system) can detect a change in current that corresponds to the constricted flow portion proximal to the proximal end of the capillary 815 (e.g., the distal-most constricted flow portion of the reduction conduit 807), and can send a signal to the motor to change (e.g., reduce) the motor speed and therefore the pressure applied to the chamber and filling material. The reduced pressure applied to the filling material can smooth the flow transition prior to the filling material reaching the capillary 815 and maintain the mechanical integrity of the delivery vessel 805. Changing (e.g., reducing) the motor speed when the filing material reaches a portion of the delivery vessel 805 proximal to the proximal end of the capillary 815 can allow for a transition to a reduced motor speed and/or applied pressure advantageous for the flow of filling material into the capillary 815 prior to entry of the filling material into the capillary 815.

In some embodiments, a rubber stopper 808 is coupled to or integrally formed with the capillary 815. The rubber stopper 808 can be positioned at a particular distance proximal from the distal end of the capillary 815 to function as a depth measurement tool. The capillary 815 can be inserted until the rubber stopper contacts an occlusal surface, providing an indication of the depth of the capillary 815 within the canal. Thus, the rubber stopper 808 can be utilized to accurately place the delivery vessel 805 at the desired depth inside the canal.

FIG. 5D is a schematic cross-sectional side view of a reducer conduit coupled to the handpiece of FIG. 5A. As shown in FIG. 5D, the reducer conduit 807 can include a plurality of segments 811A-E. One or more of the segments 811A-E can include a reduction in width or diameter so as to transition the flow of obturation material from the housing 809 to the capillary 815. In some embodiments, one or more portions of a segment 811A-E can be tapered so as to transition the flow of obturation material between segments 811.

FIG. 5E depicts the handpiece 803 in connection with a handpiece holder 802 and a system interface member 804. As shown in FIG. 5C, the system interface member 804 can be a cable. The handpiece holder 802 can be formed with the console, or may be separate from the console described above. The handpiece holder 802 and interface member 804 can include any of the features and functions to those described with respect to the console 2 and interface member 4.

### VI. Analytical Models and Examples of Test Results

### A. Analytical Model for Non-Newtonian Flowable Obturation Materials

Filling (e.g., obturation) materials used in the embodiments described herein may be Newtonian or non-Newtonian. Newtonian fluids have shear stress linearly proportional to shear rate with the constant gradient equal to their viscosity. In contrast, non-Newtonian fluids have a non-linear relationship between shear stress and shear rate and therefore viscosity is a function of shear rate. Analogous to solid deformation, Newtonian fluids have elastic behavior (where the viscosity is analogous to the Young's modulus) while non-Newtonian fluids have plastic or inelastic behavior.

Flowable obturation materials used in the embodiments described herein can exhibit a flow property known as “shear thinning”. Shear-thinning is the phenomena of a fluid's viscosity decreasing with increasing shear rate; flowable obturation materials exhibiting shear thinning are non-Newtonian fluids. This shear rate can be imparted via rotational force or via applied pressure. A material with time dependent shear-thinning behavior is known as thixotropic. In the embodiments disclosed herein, for example, shear thinning of the obturation material can be provided by increasing the pressure of the obturation material, e.g. by way of the plunger 896.

The volume flow rate, Q, of a Newtonian fluid in a pipe (known as Pouiselle Flow) is given as:

$$Q = \frac{π {R}^{4} Δ P}{8 μ} \qquad ( Equation 1 )$$

where R is the pipe radius, ΔP is the applied pressure drop, and μ is the (constant) viscosity.

An expression of the volume flow rate for a non-Newtonian fluid for use with the embodiments described herein can be described by a generalized expression for volume flow rate:

Q=∫VdA

where V is the velocity and A is the area through which the fluid is flowing. For a circular cross-section, A=πr² so dA=2πdr, which gives:

Q=2π∫₀^{R}Vdr (Equation 2)

As the viscosity is not constant, a generalized form of the Navier-Stokes equation may be used:

$$∇ \cdot σ + ρ \tilde{f} - ∇ p = ρ \frac{D \tilde{V}}{Dt}$$

where σ is the stress tensor capturing the normal and shear stresses acting on a rectangular fluid element, ρ is the density, V is the velocity vector and p is the pressure. The left hand side of this equation indicates that there are 3 forces responsible for fluid motion: the first term on the left is the stress term which causes fluid motion in the capillary due to shear stresses; the second term is the external force or “body force” term, capturing forces such as gravity or buoyancy; and the last term is the pressure term which prevents motion due to normal stresses. For the embodiments described herein, cylindrical coordinates can be used to represent the capillary, which can have a circular or generally circular cross-section in various embodiments. These expressions ignore body forces and consider only the axial component of the Navier-Stokes equation. The right hand-side, the material derivative, in cylindrical coordinates for just the axial direction, where w is the axial velocity, is written as:

$$\frac{Dw}{Dt} = \frac{\partial w}{\partial t} + \frac{dr}{dt} \frac{\partial w}{\partial r} + \frac{d θ}{dt} \frac{\partial w}{\partial θ} + \frac{dz}{dt} \frac{\partial w}{\partial z}$$

where dr/dt (uᵣ), dθ/dt (u_{θ}) and dz/dt are the velocities in the radial, angular and axial directions respectively. Assuming that the flow is steady and one-dimensional (no angular or radial velocity), the axial material derivative becomes:

$$\frac{Dw}{Dt} = w \frac{\partial w}{\partial z}$$

The continuity equation (conservation of mass) is written as:

$$\frac{\partial ρ}{\partial t} + ∇ \cdot ( ρ \tilde{V} ) = 0$$

Assuming incompressible flow, applying the steady state assumption from previously and expanding out the divergence term (in cylindrical coordinates) provides:

$$\frac{1}{r} \frac{\partial {u}_{r}}{\partial r} + \frac{1}{r} \frac{\partial {u}_{θ}}{\partial θ} + \frac{\partial w}{\partial z} = 0$$

Assuming flow is one-dimensional, uᵣ and u_{θ} are both equal to zero, which provides:

$$\frac{\partial w}{\partial z} = 0$$

This results in the right-hand side of our Navier-Stokes equation being equal to zero and simplifies to:

∇·σ−∇p=0

Expanded out in cylindrical coordinates, and assuming a pressure drop only in the axial direction, provides:

$$\frac{1}{r} \frac{\partial }{\partial r} ( r {σ}_{zr} ) = \frac{\partial p}{\partial z}$$

The pressure term is the pressure gradient (pressure per length, ΔP/L, where L is the length of the capillary). Additionally, σ_{zr} is the shear stress in the axial direction normal to the wall of the capillary. The shear stress σ_{zr} can cause a shear rate and hence the shear thinning phenomena. Integrating with respect to the radius, provides:

$$\int \frac{Δ P}{L} dr = \int \frac{1}{r} \frac{\partial }{\partial R} ( r τ ) dr \\ ∴ r τ = \frac{Δ {Pr}^{2}}{2 L} \\ ∴ τ = \frac{Δ Pr}{2 L} \qquad ( Equation 3 )$$

In some embodiments obturation materials are assumed to be power law fluids, such that:

τ=ky^{′n} (Equation 4)

where k is known as the reference viscosity or flow coefficient, n is the power law exponent and T is the shear stress. The generalized definition of viscosity is:

T=μ\dot{γ}

Combining the two above equations gives the viscosity of a non-Newtonian fluid as:

μ=k\dot{γ}ⁿ⁻¹ (Equation 5)

Thus, for a non-Newtonian fluid, the viscosity is dependent on a coefficient, k, known as the reference viscosity and n is the power law exponent. For a shear-thinning fluid, n<1 (a shear-thickening material has n>1). The shear rate is also the rate of change of axial velocity in the radial direction:

$$\dot{γ} = - \frac{dw}{dr} \qquad ( Equation 6 )$$

Substitution of Equations 4 and 6 into Equation 3 gives:

$$- {k ( \frac{dw}{dr} )}^{n} = \frac{Δ Pr}{2 L}$$

Integrating with respect to r between the limits of r=0 and r=capillary internal radius 340, applying the boundary condition that w=0 when r=R to solve for the integration constant and performing some algebra provides:

$$w ( r ) = {( \frac{Δ P}{2 Lk} )}^{1 / n} ( \frac{1}{1 + 1 / n} ) [ {r}^{1 / n + 1} - {R}^{1 / n - 1} ] \qquad ( Equation 7 )$$

Equation 7 provides an expression for the axial velocity with respect to the radial direction. This expression can be used to calculate the volume flow rate, as per Equation 1:

$$Q = 2 π {\int }_{0}^{R} w ( r ) rdr \\ Q = 2 {π ( \frac{Δ P}{2 Lk} )}^{\frac{1}{n}} ( \frac{1}{1 + 1 / n} ) {\int }_{0}^{R} r [ {r}^{1 / n + 1} - {R}^{1 / n - 1} ] dr \\ Q = \frac{π {R}^{3}}{( 1 / n + 3 )} {( \frac{Δ PR}{2 Lk} )}^{1 / n} \qquad ( Equation 8 )$$

In the modeling of shear-thinning fluid in a capillary described herein, it is assumed that the fluid is incompressible, that fluid flow is one-dimensional (no velocity in the radial or azimuthal directions), that fluid flow is steady (all fluid properties do not change with time), and that obturation fluids are power law fluids. Further, gravity is neglected in the modeling described herein. It is also noted that the flow rate of obturation materials may be dependent on the length of the capillary.

Comparing the volume flow rate between a Newtonian fluid (Equation 1) and a non-Newtonian fluid (Equation 8), it can be seen that Q increases at a greater rate with applied pressure for a non-Newtonian fluid than a Newtonian fluid.

The power law relationship between applied pressure and volume flow rate for shear-thinning obturation materials can allow for a practical solution of obturation material through such a small capillary diameter. As an example, two materials flowing through a 2″ long capillary tube with a 200 μm inner diameter due to a 200 psi pressure gradient provides: one Newtonian fluid with (constant) viscosity of 100 Pa-s and one non-Newtonian fluid with k=100 Pa-s and n=0.3 (n=0.3 is a common value for non-Newtonian shear thinning fluids) can be considered. The time taken to extrude 0.3 mL, which is a representative volume for some of the embodiments described herein, for the non-Newtonian fluid is 3.75 minutes compared to 369 minutes for the Newtonian fluid: an increase in filling time by a factor of almost 100. Thus, the embodiments disclosed herein can beneficially create shear-thinning flow that enables rapid obturation times as compared with other procedures.

### B. Flow Rate/Fill Time

Experiments were completed to evaluate capillary flow rate characteristics of the different obturation materials. A 0.25 mm internal diameter capillary for use was pre-fixtured inside PEEK tubing pieces (IDEX, F-series PEEK tubing). Obturation material was transferred inside a chamber of a pressure generator apparatus having a capable of supplying pressures up to 4300 psi. The pressure generator apparatus includes an actuation mechanism, a plunger, and a pressure regulator in connection with the chamber. The actuation mechanism comprises a piston coupled to the plunger and an air supply line configured to introduce pressurized air into the pressure generator apparatus to move the piston and plunger. The pressure regulator can be adjusted to change the input pressure, which in turn, because of a constant pressure intensification ratio (achieved via an area contraction from piston diameter to chamber diameter), alters the applied pressure on the material. pressure generator apparatus. The upstream end of the pressure generator apparatus was sealed by screwing a female assembly nut of the capillary onto a connection port of the pressure generator apparatus such that the capillary was positioned to receive the plunger of the pressure generator apparatus. For materials with mixing syringes (GuttaFlow 2 ®, EndoREZ®, Fillapex®), the material was injected directly into the chamber; for materials which are prepared externally (BioRoot®), mixing was performed outside the pressure generator apparatus by following the material IFUs, and the material was then transferred into the intensifier. The distal end of the capillary was inserted into a syringe such that all material was extruded into the syringe so the total extruded volume could be quantified. The pressure generator apparatus was then set to the desired pressure, and the piston was activated to cause the plunger to advance within the capillary to extrude the material therefrom. The timer was started when material was seen extruding from the distal end of the capillary and stopped when material was no longer extruding, either due to a clog or because the material inside the chamber was exhausted. For each material, three repeat runs were performed. The average results summarized in Table 3 below. For BC Sealer®, it should be noted that the flow rate at 2000 psi was significantly lower than that at 1000 psi, suggesting that the pressure was accelerating the curing process. This phenomenon of accelerated curing was also observed for Fillapex®, where the material visibly changed in color from an original color to a post-cured color after applying pressure. From the results shown in Table 3, it is suggested that the fastest flowing material is EndoRez®, as EndoRez® achieved the highest flow rate, which was almost 0.2 mL/min higher than the next material and at half the pressure. In contrast, the slowest flowing material was Fillapex® which was 65% slower than the next slowest material.

TABLE 3

| | | | AVERAGE | FILLING |
|---|---|---|---|---|
| | CAPILLARY | PRES- | FLOW | TIME |
| | SIZE | SURE | RATE | FOR 0.3 mL |
| MATERIAL | (μm) | (psi) | (mL/min) | (minutes) |
| GuttaFlow 2 ® | 250 | 2000 | 0.206 | 1.5 |
| BioRoot ® | 250 | 2000 | 0.34 | 0.88 |
| Fillapex ® | 250 | 2000 | 0.125 | 2.4 |
| BC Sealer ® | 250 | 1000 | 0.145 | 2.07 |
| EndoRez ® | 250 | 1000 | 0.58 | 0.52 |

### C. Continuous Flow

The particle distribution of an obturation material can affect the minimum capillary size used to achieve continuous flow. The time at which particle accumulation causes flow obstruction, known as capillary clogging, is a statistical phenomena due to a heterogeneous particle size distribution and a function of material density, material flow rate, particle aggregation qualities and the capillary size.

Experiments were conducted using the pressure generator apparatus described herein. The experiment methodology followed that described above in the “Flow Rate” section. However, for this experiment, for each obturation material, extrusion through 150, 180, 200 and 250 μm internal diameter capillaries was explored. A constant pressure of 2000 psi was used across all capillary sizes and obturation materials. Measurements were repeated three times at each capillary size, for a total of 12 measurements per obturation material. The timer was started when the material was observed exiting the capillary and stopped when obturation material stopped flowing. If a clog occurred then the piston was retracted and then re-activated to determine if the clog could be “broken” and the flow could be started again. If material did begin flowing again, the timer was started again and the timer stopped once another clog occurred. In almost all cases, the clog could not be broken. The results are summarized in Table 4. The clogging time (in seconds) is tabulated and the number in brackets corresponds to the number of measurements for that particular capillary-material combination when clogging occurred. For certain cases (GuttaFlow® 180, BioRoot 250), both clogs and no clogs occurred. In these instances, the average was calculated from only those measurements when clogs occurred. Depending on the parameters of the activation mechanism and the forces applied, continuous flow may be possible in various diameters, including diameters above and below those shown in FIG. 4.

TABLE 4

| Internal | | | | | |
|---|---|---|---|---|---|
| Diameter | GuttaFlow ® | BioRoot | Fillapex | BC Sealer | EndoREZ |
| 150 | 34 (3) | 0 (3) | 0 (3) | No data | No data |
| | | | | collected | collected |
| 180 | 101 (2) | 98 (3) | 29 (3) | No data | 38 (3) |
| | | | | collected | |
| 200 | No clog | 93 (3) | 14 (3) | No clog | No clog |
| 250 | No clog | 130 (2) | No clog | No clog | No clog |

### D. Capillary Inner and Outer Diameter Selection

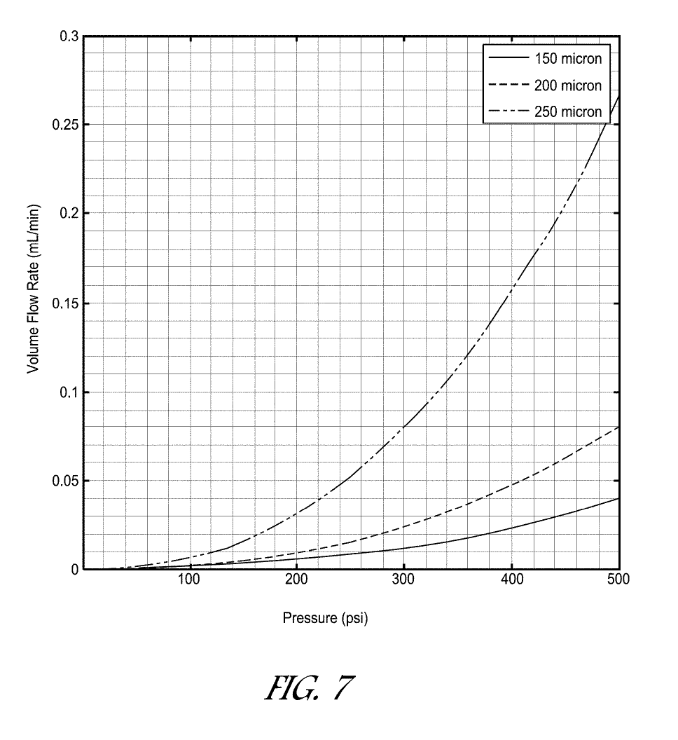

Volume flow rates through fused silica capillaries can be estimated using Equation 8. This calculation uses values for k, the reference fluid viscosity, and n, the power exponent. As an experimental example, the values of k and n for GuttaFlow® were calculated by experimentally measuring the viscosity of GuttaFlow® for different shear rates by using a viscometer (Brookfield E000140) and fitting the data to Equation 5, yielding k=124 and n=0.43. The experimental data for the base GuttaFlow® material is shown in FIG. 6. GuttaFlow® is a two-part material consisting of base and catalyst pastes at a volume fraction of 4:1 respectively, where the base material has a higher viscosity than the catalyst paste. Similar to two-part epoxies, mixing of these two materials initiates a chemical reaction which begins the curing process that causes a phase change and creates a hardened solid. Due to this hardening, only the shear-thinning properties of the higher-viscosity base material were measured and all calculations henceforth are based on this base material only. Modeling only the base material is a reasonable approximation as it represents a factor of safety in the design because the mixed solution will have a lower viscosity.

In Equation 8, described above, the applied pressure is the pressure across the capillary 305/815, and not the pressure exerted by the plunger on the material inside the housing/cartridge. Head loss may occur inside the constant cross-section cartridge length, and head loss may occur inside the reduction conduit 891 in which an area contraction occurs from the cartridge diameter to the capillary inner diameter. Head loss may also occur inside the capillary itself. Denoting the upstream edge of the cartridge/housing or reservoir as region 1, the entrance to the capillary as region 2 and the capillary exit as region 3, Bernoulli's equation for an energy balance across the entire flow domain can be used:

$${z}_{1} + \frac{{V}_{1}^{2}}{2 g} + \frac{{p}_{1}}{ρ g} = {z}_{3} + \frac{{V}_{3}^{2}}{2 g} + \frac{{p}_{3}}{ρ g} + {h}_{cart} + {h}_{cap} + {h}_{funnel} \qquad ( Equation 9 )$$

The cartridge/housing and capillary head losses can be calculated using standard pipe flow head loss since the cross-sectional area is constant:

$$h = 4 f ( \frac{L}{D} ) \frac{{V}^{2}}{2 g} \qquad ( Equation 10 )$$

where L is the length of pipe, D is the pipe diameter, V is the pipe velocity and f is the Fanning friction factor which is the 16/Re (Re=flow Reynolds Number). Head loss is related to pressure drop via ΔP=ρgh. The velocity inside the cartridge/housing is the linear speed and the velocity in the capillary can be calculated using mass continuity for an incompressible fluid:

$${V}_{cart} = \dot{x} \\ {V}_{cap} = {{V}_{cart} ( \frac{{R}_{cart}}{R} )}^{2} \qquad ( Equation 11 )$$

In order to estimate the friction factor in Equation 10, a Reynolds Number inside the cartridge and capillary can be calculated. For a power law fluid, the Reynolds Number is given by:

$${Re}_{PL} = {2}^{3 - n} {( \frac{n}{3 n + 1} )}^{n} \frac{{V}^{2 - n} {D}^{n} ρ}{K}$$

where D is the pipe diameter. Since the capillary and cartridge head losses can now be calculated, the input and output pressures are known to be the pressure applied by the plunger and atmosphere (˜14.7 psi), respectively, and if the entire flow domain is horizontal (no height change), Equation 9 can be re-arranged to solve for the funnel head loss:

$${h}_{funnel} = \frac{1}{2 g} ( {V}_{1}^{2} - {V}_{∞}^{2} ) + \frac{1}{ρ g} ( {p}_{1} - {p}_{∞} ) - {h}_{cart} - {h}_{cap}$$

In embodiments of obturation systems as described herein, the velocities can be very low (10⁻⁴−10¹ m/s) so the velocity term can be very small. For example, a linear speed of 1 in/min is about 4.24E-4 m/s, which via Equation 10, gives a velocity inside the capillary of 0.153 m/s. Therefore, the velocity terms can be neglected. Additionally, since the cartridge velocity can be slow, the cartridge head loss term can be very small (˜0.1 m) relative to the other terms (˜1000 m). Therefore, the velocity terms and the cartridge head loss term can be neglected, and after substituting in Equation 10 provide:

$${h}_{funnel} ≅ \frac{1}{ρ g} ( {p}_{1} - {p}_{∞} ) - \frac{16}{{Re}_{cap}} ( \frac{{L}_{cap}}{R} ) \frac{{V}_{cap}^{2}}{g} \qquad ( Equation 12 )$$

The pressure at the capillary entrance is then:

P=p₁−ρgh_{funnel}

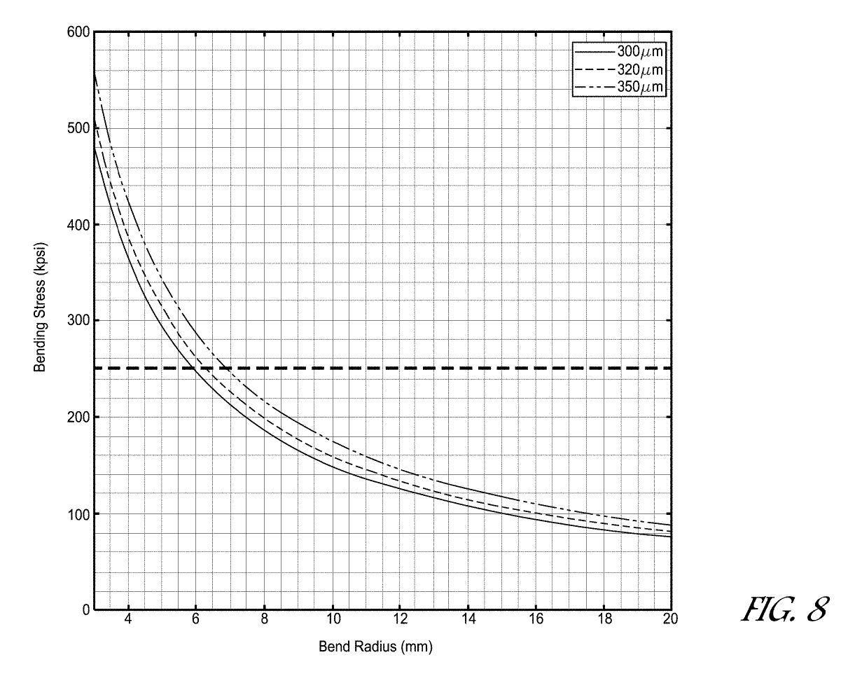

As a function of applied pressure at the capillary entrance, theoretical volume flow rates for three different capillary sizes (150, 200, and 250 μm) are shown in FIG. 7. Embodiments of capillaries described herein can include an inner diameter of between 200-250 μm. These embodiments may also have a minimum wall thickness of 50 μm. In some embodiments, a capillary may have an outer diameter of 300-350 μm.

### E. Bend Radius

It may be desirable for the capillaries 305/805 to retain a certain level of flexibility so that they can match the curvature of a canal without breaking while being inserted. This flexibility can be quantified in terms of bend radius. Capillary failure in this mode may be due to bending stresses which are imparted on the fused silica wall when the capillary is curved. The bending stress, σ, can be calculated using the following equation, where R_{curv} is the bend radius, E is the fused silica Young's Modulus, Cat is the coating thickness and Rₒᵤₜₑᵣ is the outer capillary radius (bore radius+fused silica wall thickness+coating thickness):

$${σ}_{bend} = \frac{{ER}_{outer}}{{R}_{curv} + {C}_{th} + R}$$

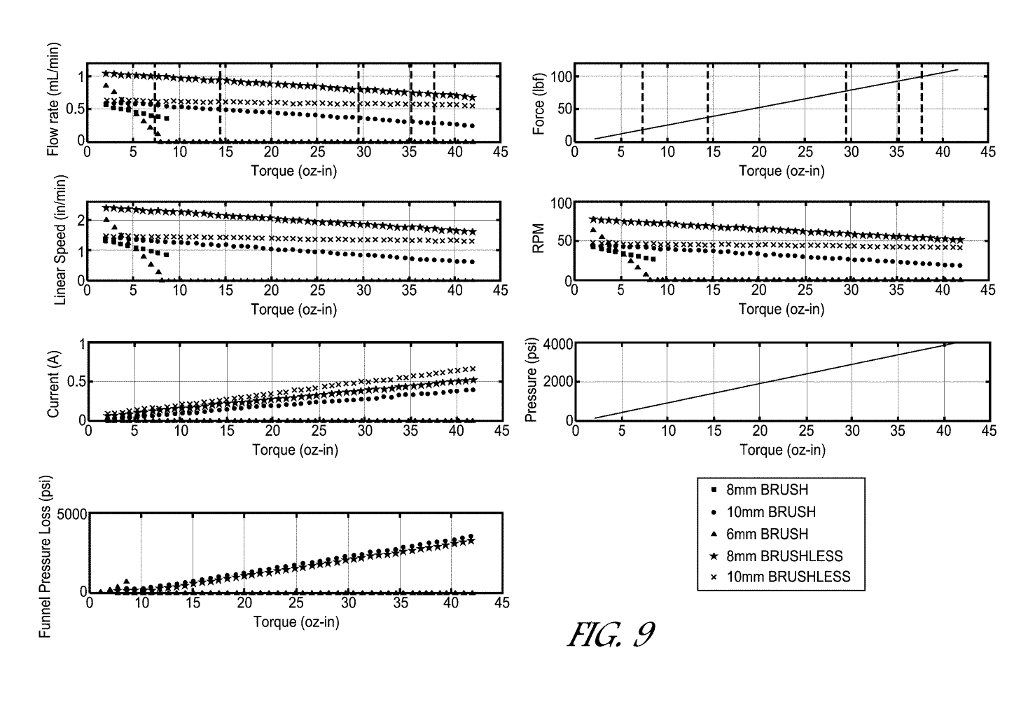

Bending stress curves for three capillaries with differing total outer diameters are shown in FIG. 8. The inner diameters of the capillaries are varied (200 μm, 220 μm and 250 μm), while the fused silica wall thickness and coating thickness are kept constant at 100 μm and 15 μm, respectively. A recommended maximum bending stress value is indicated by the dashed horizontal line; as expected from the equation above, the larger the capillary, the lower minimum bend radius.

A bend radius fixture, which consisted of posts with diameters ranging from 3-15 mm in 1 mm increments, was 3D printed. Capillaries were successively bent 180 degrees around decreasing post sizes until each capillary broke. An ultimate bend radius was defined as the smallest radius at which the capillary could be bent without breaking. Unfilled 350 μm capillaries were measured to have an ultimate bend radius of 3 mm. However, after GuttaFlow® extrusion, capillary flexibility was found to decrease, and ultimate bend radii were measured to be >15 mm, as the capillaries broke before being wrapped 180 degrees around the 15 mm bending post. Evaluation using SEM inspection revealed that the fused silica wall had been compromised. A possible explanation is that the obturation material particles, which can be bio-ceramics with a high mechanical hardness, nick and score the internal fused silica wall, continually amplifying the internal surface damage as more material elutes through the capillary. The characteristic pattern consists of a dark arc which corresponds to an initial defect site and final wall thickness shattering occurring at roughly 180 degrees. The defect initiates two waves that travels clockwise and anti-clockwise circumferentially through the fused silica wall and cause breakage where both waves meet, at roughly 180 degrees from the initial defect site. To address possible breakage, the fused silica capillary was coated internally with a protective layer, e.g., with polydimethylsiloxane (PDMS), as the PDMS coat can provide extra abrasion resistance. Various 180 μm ID capillaries with a 1 μm internal PDMS coat were obtained and bend radius tests performed using the pressure generator apparatus. Both uncoated and coated 180 μm capillaries were tested by bending around the test fixture, and the ultimate bend radius was measured. The pressure generator apparatus was set to 2000 psi and material extruded until first seen exiting the capillary. Two obturation materials, BioRoot® and Fillapex®, were also tested. The results showing the bend radius are provided in Table 5.

TABLE 5

| | Uncoated | Coated |
|---|---|---|
| | (mm) | (mm) |
| Fillapex ® | 7 | <3 |
| BioRoot ® | 4.5 | <3 |
| GuttaFlow ® | >7.5 | 5 |

The results show that coating the capillaries with PDMS assists in enabling capillary flexibility after material extrusion. In the case of GuttaFlow®, uncoated capillaries had an ultimate bend radius of much greater than 7.5 mm, e.g., between 20-30 mm, and with a coated capillary the ultimate bend radius is 5 mm in the illustrated example. These results suggest that coated fused silica capillaries may be able to access at least 91.3% of all mandibular and maxillary canals of first and second molars (see, e.g., Table 1 of Estrela et al., Brazilian Dental Journal, 26(4):351-356).

### F. Motor Selection

One goal of the embodiments described herein is to push a highly viscous, yet shear thinning, fluid through a very small tube (e.g. in a range of 0.2-0.3 mm in some embodiments) at a desired flow rate (e.g., in a range of 0.1-0.3 mL/min in some embodiments). In some embodiments, this can be performed by applying pressure imparted by a plunger connected to a leadscrew driven by an electric motor. It may further be advantageous to operate the motor within its continuous operation range. For a given motor and gearbox, the maximum continuous torque output from the gearbox is:

Γ*=GΓₘₒₜₒᵣ*η_{gearhead} (Equation 13)

where G is the gearbox ratio, η_{gearhead} is the gearhead efficiency and Γ*ₘₒₜₒᵣ is the maximum continuous torque of the motor. The maximum flow rate that this motor can provide is:

Qₘₒₜₒᵣ*=\dot{x}πr_{cartridge}² (Equation 14)

where x is the linear speed of the leadscrew and r_{cartridge} is the plunger radius. The linear speed is the revolutions per minute of the gearbox shaft (RPM) divided by the screw pitch (p):

$$\dot{x} = \frac{RPM}{p} \qquad ( Equation 15 )$$

From mass conservation of incompressible fluids, the volume flow rate created by the motor equals the volume flow rate through the capillary. The pressure, P, to create this flow rate of GuttaFlow® through the capillary is determined numerically by generating Q values (using the empirically determined values of k and n) corresponding to a range of pressures and then performing interpolation. The torque to create a certain imparted force, F, via the mechanical advantage of screw with efficiency η_{screw} is:

$$Γ = \frac{Fp}{2 π {η}_{screw}} \qquad ( Equation 16 )$$

In terms of the pressure, this torque is:

$$Γ = \frac{{Ppr}^{2}}{2 {η}_{screw}} \qquad ( Equation 17 )$$

Motor specifications include stall torque (at 0 RPM) and free run speed (at 0 torque). Assuming a linear relationship, from these two values, any speed can be determined for a given torque and vice versa. Therefore, the output gearbox RPM (motor speed divided by the gearbox ratio) corresponding to the torque value can be calculated, as can the current.

In the above equations, the efficiency of the screw is unknown. For the experiments described herein, this value was determined by measuring the force applied to stall the 8 mm brushless motor at three (3) different current settings. At each current value, three separate measurements were taken, for a total of nine measurements from which an average efficiency was calculated. The torque values for each current value were calculated via linear interpolation. The results are summarized in Table 6, giving an average efficiency of 12.55%. Therefore, the total system efficiency for a design with 8 mm brushless motor and custom leadscrew in the described example is 8.15%.

TABLE 6

| Current | Torque | Stall Force | Efficiency |
|---|---|---|---|
| (A) | (oz-in) | (lbf) | (%) |
| 0.2 | 13.138 | 23.5 | 14.232 |
| 0.2 | 13.138 | 21.2 | 12.839 |
| 0.2 | 13.138 | 24.2 | 14.656 |
| 0.391 | 29.97 | 44.2 | 11.735 |
| 0.391 | 29.97 | 45.2 | 12.000 |
| 0.391 | 29.97 | 44.3 | 11.761 |
| 0.6 | 48.38 | 69.1 | 11.364 |
| 0.6 | 48.38 | 74 | 12.170 |
| 0.6 | 48.38 | 74.2 | 12.203 |

As one example of a motor that may be used with the embodiments described herein, Maxon Motor (Switzerland) offers a product where the motor, gearbox and leadscrew are integrated and supplied as a single part. In other embodiments, different types of motors can be used.

TABLE 7

| | 8 mm | 10 mm | 6 mm | 8 mm | 10 mm |
|---|---|---|---|---|---|
| | brush | brush | brush | brushless | Brushless |
| Motor/ | 463220/ | 118396/ | 386783/ | Custom/ | 315173/ |
| Gearbox | 468996 | 218418 | 472229 | 468996 | 332425 |
| part numbers | | | | | |
| Motor/ | RE8/ | RE10/ | RE6/ | ECX/ | EC10/ |
| Gearbox | GP8A | GP10A | GP6A | GP8A | GP10A |
| product | | | | | |
| family | | | | | |
| Gear Ratio | 256 | 256 | 221 | 256 | 256 |
| Gear | 65 | 65 | 60 | 65 | 65 |
| Efficiency | | | | | |
| (%) | | | | | |
| Max | 12000 | 8000 | 40000 | 12000 | 12000 |
| Gearbox | | | | | |
| Speed | | | | | |
| (RPM) | | | | | |
| Free Current | 7.3 | 11.1 | 10.7 | 50.9 | 67.3 |
| (mA) | | | | | |
| Stall Current | 0.207 | 0.66 | 0.161 | 1.43 | 5.27 |
| (A) | | | | | |
| Max | 0.155 | 0.338 | 0.118 | 0.391 | 0.6 |
| Continuous | | | | | |
| Current (A) | | | | | |
| Voltage | 6 | 6 | 6 | 12 | 18 |
| Max | 0.616 | 1.5 | 0.316 | 1.26 | 1.61 |
| Continuous | | | | | |
| Torque | | | | | |
| (mNm) | | | | | |
| Stall Torque | 0.857 | 3.01 | 0.465 | 5.18 | 15.6 |
| (mNm) | | | | | |

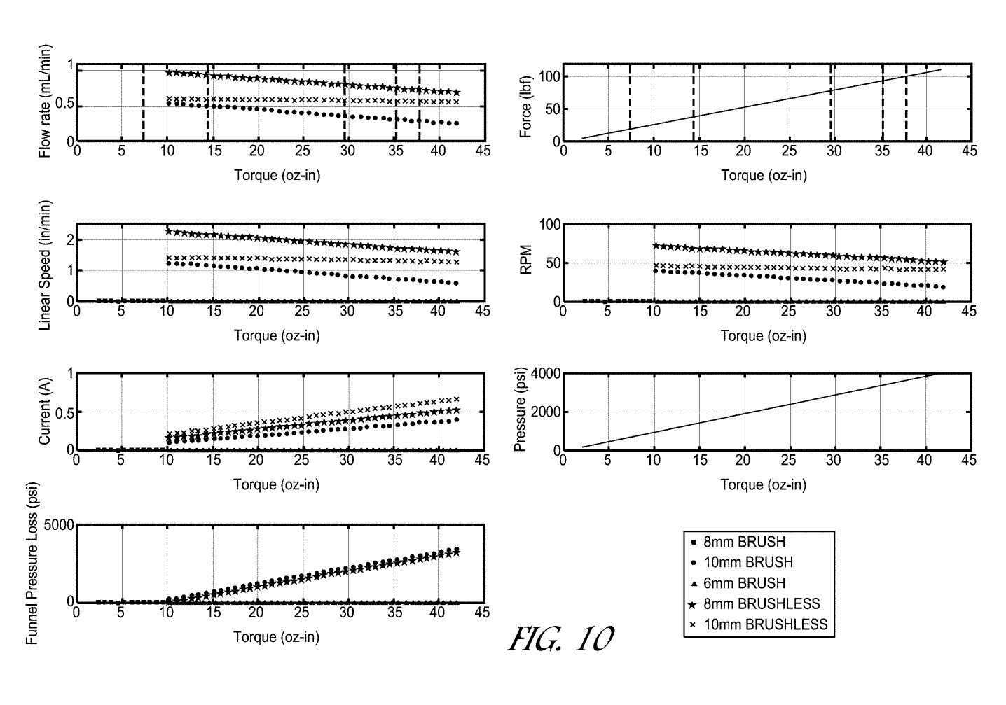

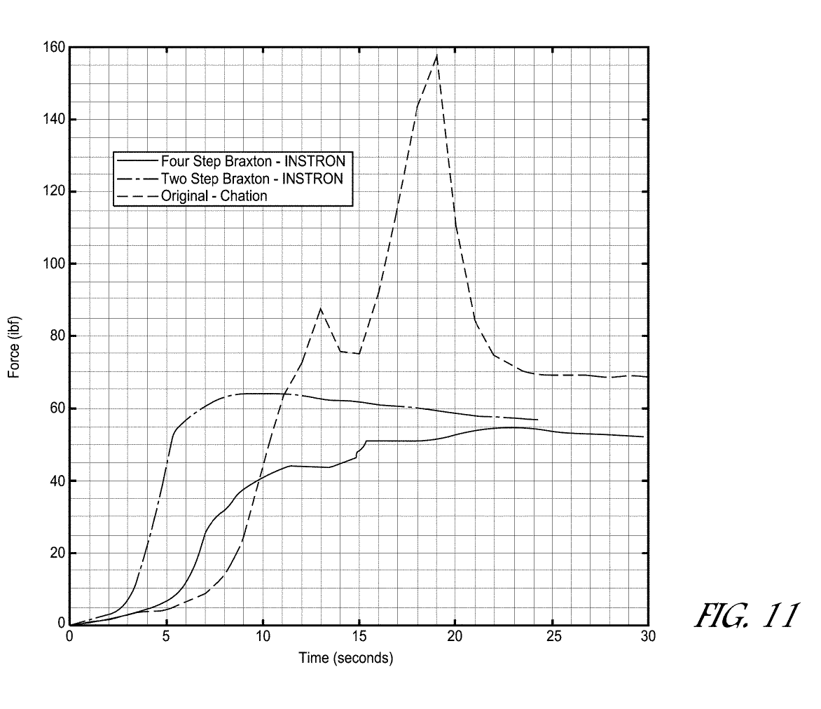

Using the analysis described in this section and a lead screw efficiency of 21% (corresponding to a total system efficiency across the five motors of 16.3-17.5%), five candidate motors (see 7) were evaluated for a 250 μm internal diameter capillary and a cartridge/housing diameter of 0.1875 in. The results are plotted in FIG. 9. Failure to extrude the obturation material from the capillary was considered for two modes: 1) the torque to generate a certain pressure is beyond the stall torque rating for a particular motor and 2) for a certain pressure, the pressure drop across the capillary is larger than the pressure at the entrance of the capillary. FIG. 9 demonstrates the performance of the motors when the first failure mode is considered and FIG. 10 demonstrates the performance when the second failure mode is also considered.

A pressure range from 200 psi to 4500 psi was considered, which was discretized at 50 psi intervals for a total of 86 values. At each pressure value, the following quantities were calculated: flow rate using Equation 8 (left first row); the force imparted by the piston, which is the product of the pressure and the surface area of the plunger; the torque output out of the gearbox, calculated using Equation 13, that can achieve this force (right first row); the RPM out of the gearbox corresponding to the torque output, which was based on predetermined specifications (right second row); the linear speed as a result of this RPM, obtained using Equation 15 (left second row); the current that can provide the torque output, obtained also via interpolation (left third row); and the pressure loss across the reduction conduit geometry using Equation 12 (left fourth row). To preserve motor lifetime, the motor can be operated at torque values below the specified continuous torque value. For each motor, on the flow rate and force-torque profiles, a maximum continuous torque value for the described example is plotted as a dashed vertical straight line, in order from right to left: 10 mm brushless, 10 mm brushed, 8 mm brushless, 8 mm brushed and 6 mm brushed; for a particular motor, in some embodiments, preferred operation can be to the left of this line.

From FIG. 9, the two smallest brushed motors (6 and 8 mm) can provide a fraction of the torque range due to low stall torque values. As shown in FIG. 10, the situation for these two brushed motors becomes prohibitive: the 6 mm and 8 mm brushed motors may not work across the entire pressure range in some embodiments.

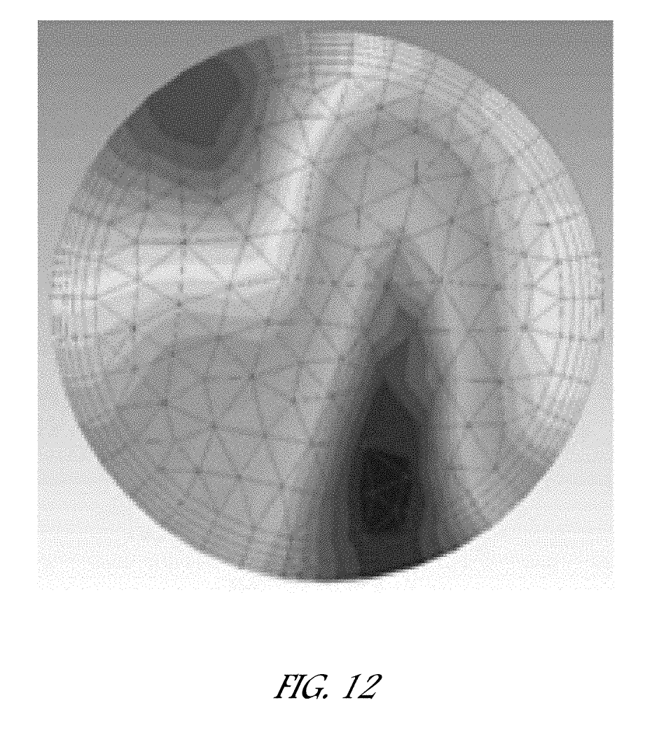

To experimentally determine how much force is used to extrude GuttaFlow®, measurements were performed using a Chatillon LTCM-500 and an Instron 5943 with 500 lb and 100 lb load cells, respectively. Four different funnel geometries were tested: the first cartridge (labeled “Original” in Table 8), a modified dual-taper cartridge (labeled “30-60” degree in Table 8) and two cartridges with multi-stepped off-the-shelf contraction tubes (Braxton 544, Braxton 873) (labeled “Braxton 2 step” and “Braxton 4 step” in Table 8) connecting the cartridge material chamber with the capillary entrance. In each of these four configurations, cartridges were filled with GuttaFlow® and the piston connected to the Chatillon drive rod. The piston was initially inserted into the cartridge at a height slightly above the GuttaFlow® fill line. After initial contact between plunger and GuttaFlow®, the force rapidly increased to a peak value, followed by a relaxation period where the force decreases to a final, reasonably constant, steady-state value. Multiple runs were performed and the average peak force and steady state values calculated. The results are summarized in Table 8. Comparison between the experimental results of Table 8 for the Original cartridge and predicted performance results of FIG. 10 show some discrepancies: the average peak force value for 0.6 in/min is 199 lbf, which is 100% higher than the max continuous force that the most powerful motor (10 mm brushless) can provide. For visual comparison, FIG. 11 graphs the average force profiles for three of the funnel geometries (original, Braxton 544 and Braxton 873). The very large peak forces can be a concern as, inside the device, these forces are transmitted back through the drivetrain and thrust bearings onto the gearbox surface. The 8 mm and 10 mm Maxon gearboxes are rated for 50 lbf and 102 lbf respectively. The described experiments were performed to explore the effect of piston speed and funnel geometry on both the peak and steady-state forces. From these results, it can be seen that slower linear speeds can result in lower peak forces. Further, it can be seen that funnel geometry can play a role in reducing the peak load. This reduction in peak load may be a function of the number of area step-downs used to go from the initial cartridge diameter to the final capillary diameter. It is contemplated that increasing the number of area step-downs may reduce the flow resistance as the velocity change is staggered, allowing the fluid some time to begin shear-thinning. Visual evidence of this reduction in peak force is shown in FIG. 11.

TABLE 8

| Capillary | | | | | Average | Average Steady | Number |
|---|---|---|---|---|---|---|---|
| Size | | | | | Peak Force | State Force | of |
| (nm) | Machine | Piston Speed | | Configuration | (lbf) | (lbf) | Runs |
| 250 | Chatillon | .6 | in/min | Original | 199 | 119 | 2 |
| 250 | Chatillon | 0.2 | in/min | Original | 70.4 | 47 | 3 |
| 250 | Chatillon | 0.6 | in/min | 30-60 degree | 77.8 | 72 | 4 |
| 250 | Chatillon | 0.2 | in/min | 30-60 degree | 48.3 | 43 | 2 |
| 250 | Instron | .6 | in/min | Braxton 2 Step | 70.56 | 63.21 | 4 |
| 250 | Instron | .6 | in/min | Braxton 4 Step | 54.77 | 53.6 | 4 |

A 10 mm brushless Maxon motor may be advantageous in certain embodiments in comparison to some of the other motors described herein. The 6 mm and 8 mm brushed motors may not function across an entire desired torque range. Steady state forces used to extrude GuttaFlow® through a 200-250 μm capillary may exceed 50 lbf, which may be beyond the continuous operation capabilities of the 6 mm, 8 mm, and 10 mm brushed motors, and the 8 mm brushless motor. Peak forces used to extrude GuttaFlow® through a 200-250 μm capillary may induce excessive forces for loads applied to an 8 mm brushless gearbox. A more powerful motor may have extended capabilities which may support a larger cartridge volume and a smaller capillary size.

### G. Static Mixer Modeling

1. Simulation Parameters

Flow of GuttaFlow 2® within a housing was modeled in various simulations, described herein. As described herein, GuttaFlow 2® is a two-part material, including a base and a catalyst having a base-to-catalyst volume ratio of 4:1. Each component composition of the two-part material can have a density of 1950 kg/cm³. Each component composition can comprise a shear-thinning material. In other words, the viscosity of each component composition may decrease with increasing strain rate. The relationship between viscosity and shear rate is described herein with respect to Equation 5. Values for the reference viscosity and power law exponent for the component compositions included in the simulations described herein are provided in Table 10.

TABLE 10

| | BASE | CATALYST |
|---|---|---|
| K | 124 | 101 |
| N | 0.43 | 0.1 |

The simulations described herein assumed a multiphase-mixture model. In certain embodiments, the housing may initially be filled with air (gaseous phase), which can be displaced from the housing and replaced with the base-catalyst mixture (liquid phase). Air introduced into the root canal system during an obturation procedure can adversely affect the obturation quality. Modeling of both the gaseous phase and liquid phase can allow for optimization of the flow domain by minimizing dead volume and ensuring that air is efficiently and completely or almost completely expelled.

The simulations described herein assume that the base and catalyst are miscible. In other words, simulations described herein assume that the base and catalyst can form a homogenous solution on a molecular level.

The simulations described herein assume that the two-part obturation material exhibits laminar flow. In some embodiments, the liquid viscosity of the two-part obturation material can be in the order of 10² Pa-s. In some embodiments, flow velocities for the two part obturation material within an obturation system can be in the order of 10⁻¹ m/s. In some embodiments, the diameter of a capillary through which the obturation material can flow can be about 0.25 mm. Based on the liquid viscosity, flow velocities, and capillary diameter described herein, the Reynolds number for the flow of the obturation material can be less than 10, and the flow can be laminar.

The simulations described herein include transient simulations, which can model the behavior of a system from a specific start time to examine the dynamic behavior of a system. Parameters chosen for the simulations described herein are summarized in Table 11.

TABLE 11

| PARAMETER | CHOICE | JUSTIFICATION |
|---|---|---|
| Flow regime | Laminar | Re << 10 |
| Type | Transient | Modeling air expulsion and start up behavior |
| | | may be relevant to design |
| Mixing model | Two-phase, Eulerian | Two choices were considered: Mixture model |
| | “Mixture Model” | and VOF (volume of fluid). VOF can be more |
| | | computationally expensive. |
| Gravity | None | Low importance to model body forces |
| Pressure-Velocity | PISO | PISO is fast solver for a transient solution |
| Scheme | | |
| Under-Relaxation | Default PISO values | Numerical stability can be achieved with these |
| Factors | | values |
| Density | Fixed at 1950 kg/cm3 for | Coltene MSDS. |
| | base and catalyst; ideal gas | |
| | for air | |
| Linear Speed | 0.4 in/min | Achieves desired flowrate. |
| Mass Diffusion | 5e−10 m²/s | This value was determined via an initial “trial |
| | | and error” study exploring D values between 10⁻⁹ |
| | | to 10⁻¹², which is the characteristic mass |
| | | diffusivity range for liquids, and comparing with |
| | | experimental results. |
| Temperature | Fixed at 300 K (heat transfer | Heat transfer was not considered relevant for |
| | not modeled) | these simulations |
| Flow domain | Domain split into 9 separate | To permit customized meshing of different flow |
| | bodies to be meshed | regions: fine-scale mesh in the mixer, port and |
| | independently | funnel regions; coarse meshing in regions such |
| | | as the material chambers; using the sweep mesh |
| | | function to permit accurate physical modeling |
| | | with low number of elements inside the |
| | | chambers, capillary and reducer conduit. |
| Meshing | Dynamic mesh (inlets move | Moving domain. |
| | at the fixed velocity of the | |
| | lead screw) | |
| | Combination of swept and | |
| | tetrahedral meshing schemes | |
| Time steps | Time step ramp for | For numerical stability; if the simulation was |
| | numerical stability: | started initially with a large time step then |
| | Time steps 1-5: 0.0001 | divergence occurred. |
| | seconds | |
| | Time steps 6-10: 0.001 | |
| | seconds | |
| | Time steps 11-15: 0.01 | |
| | seconds | |
| | Time steps 16-20: 0.1 | |
| | seconds | |
| | All remaining time steps: | |
| | 0.25 seconds | |
| Spatial Discretization | Momentum, Energy, | 2^{nd} order schemes for flow variables |
| | Species, Volume Fraction: | 1^{st} order for density because liquid phase density |
| | 2^{nd} order | is constant |
| | Density: 1^{st} order | |
| Temporal Discretization | 1^{st} order implicit | For computational efficiency |

The simulations described herein provide results and comparisons for four different housing and mixer configurations. The four configurations include different types of static mixing geometries, port geometries, and cap designs. A summary of the four designs is provided in Table 12.

TABLE 12

| | DESIGN | DESIGN | DESIGN | DESIGN |
|---|---|---|---|---|
| | 1 | 2 | 3 | 4 |
| MIXER TYPE | Stamped | One-state | Two-stage | Two-stage |
| | | helical | helical | helical |
| | | ribbon | ribbon | ribbon |
| # of | 7 | 7 | 8 | 8 |
| ELEMENTS | | | | |
| CAP STYLE | Flat | Flat | Beveled | Beveled |
| PORT | Kidney | Kidney | Bowl | Bowl with bar |
| GEOMETRY | | | | |
| REFERENCE | “Stamped | “Standard | “Multi- | “Multi- |
| NAME | Ribbon” | helical | sized | sized |
| | | ribbon” | helical | helical |
| | | | ribbon” | ribbon |
| | | | | with |
| | | | | strut” |

As shown in Table 12, two static mixer designs were considered, including a helical ribbon design (See FIGS. 4D-4E) and a stamped ribbon design (See FIG. 4G). The helical ribbon design includes a helical ribbon with alternating left and right turns or plate elements. The stamped ribbon includes a generally similar shape having flatter surfaces and less curvature.

As shown in Table 12, various numbers of static mixer plate elements were considered, including static mixers having 7 plate elements and static mixers having 8 plate elements. For the static mixer designs having 8 plate elements, a multi-sized helical ribbon mixer having one plate element upstream of a reducer conduit and seven smaller elements inside the reducer conduit was considered.

As shown in Table 12, various port shapes were considered. A kidney or arc shaped port biased to the catalyst side was considered (See FIG. 4G). An elliptical port located centrally between the two component chambers was also considered.

As shown in Table 12, various post designs were considered. Posts having flat end faces and beveled end faces (See FIGS. 4D-4E) were considered.

2. Results

Simulations were run using a 32-physical core machine (“ANSYS”) with 2.1 GHz processors. Experimental data was collected on an Instron 5943 and using several versions of an obturation devices as described herein.

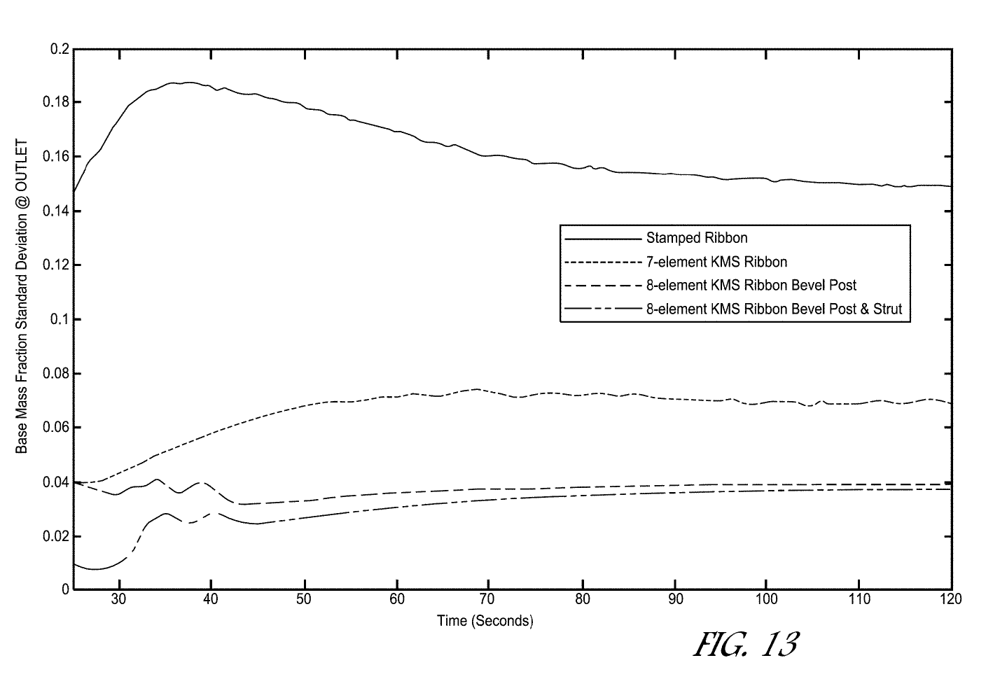

The base mass fraction standard deviation for the obturation material within a capillary was calculated in the simulations described herein. The base mass fraction standard deviation can provide an indirect measure of mixing quality across a certain area. FIG. 12 shows a cross-sectional area at a capillary outlet spatially discretized into mesh elements and at each mesh element, a base mass fraction value is calculated. The standard deviation can represent the distribution of mass fraction values across a cross-section, which can provide a measure of mixing homogeneity. Lower standard deviations can indicate superior mixing at the cross-sectional plane.

Additional experiments were conducted to measure the flow rate of the two-part obturation material for three different speed settings. The experiments involved dispensing the obturation material on a petri dish for a recorded amount of time and weighing the material dispensed. The flow rate was calculated with the following equation: flow rate=volume of flow dispensed divided by time of dispense. Table 13 shows the results of the flow rate measurements.

TABLE 13

| MOTOR SPEED | LINEAR SPEED | FLOW RATE |
|---|---|---|
| (RPM) | (in/min) | (mL/min) |
| 2000 | 0.24 | 0.12 |
| 3500 | 0.43 | 0.19 |
| 4700 | 0.57 | 0.24 |

When the base and catalyst components of GuttaFlow 2® come in contact, curing can occur. Two-part epoxies, like GuttaFlow 2® can have a pot or working time, the period of time after the component compositions come into contact over which the material are flowable and pliable to an extent that manipulation of the materials can be performed. The time at which the mixture is considered hardened is referred to as the cure time. GuttaFlow 2® can have a working or pot time of 12 minutes and a cure time of 42 minutes.

An experiment was conducted to quantity flow rate as a function of setting time for GuttaFlow 2®. The experiment was completed at 3 different setting times: 0, 5 and 10 minutes. The experiment consisted of dispensing GuttaFlow 2® for a period of 30 seconds, weighing the dispensed amount, and calculating a flow rate based on the weight of the dispensed amount and duration of time. An obturation device, as described herein, was used at a motor RPM of 2200 RPM. At each setting time, ten repetitions were performed, and an average flow rate value was calculated for each setting time. Flow rate results are provided in Table 14.

TABLE 14

| Setting Time | Flow Rate |
|---|---|
| (minutes) | (mL/min) |
| 0 | 0.13 |
| 5 | 0.10 |
| 10 | 0.09 |

Another experiment was conducted to assess the durability of a glue joint between a capillary and a reducer conduit of an obturation device. The steps of the experiment included: cutting off a proximal portion of a reducer conduit at a distance of 4 mm from the capillary, using a capillary fixture to cut a capillary segment, using a fixture to orient the capillary, covering a microapplicator in a moderate amount of glue, sliding the microapplicator on the exterior of the capillary near the entrance to a reduction conduit, using a fixture to push the microapplicator along the exterior of the capillary over a distance of 2 mm, allowing the capillary and microapplicator assembly to dry for 1 to 4 hours, placing the assembly into an Instron fixture and gluing the capillary using UV Loctite into a capillary holder fixture, perform a pull test, and recording a value at break. The experiment was performed ten times for two different setting times. Pull test results are provided in Table 15.

TABLE 15

| Setting Time | Average Force | Standard |
|---|---|---|
| (hours) | (lbf) | Deviation |
| 1 | 2.17 | 0.78 |
| 4 | 2.24 | 0.75 |

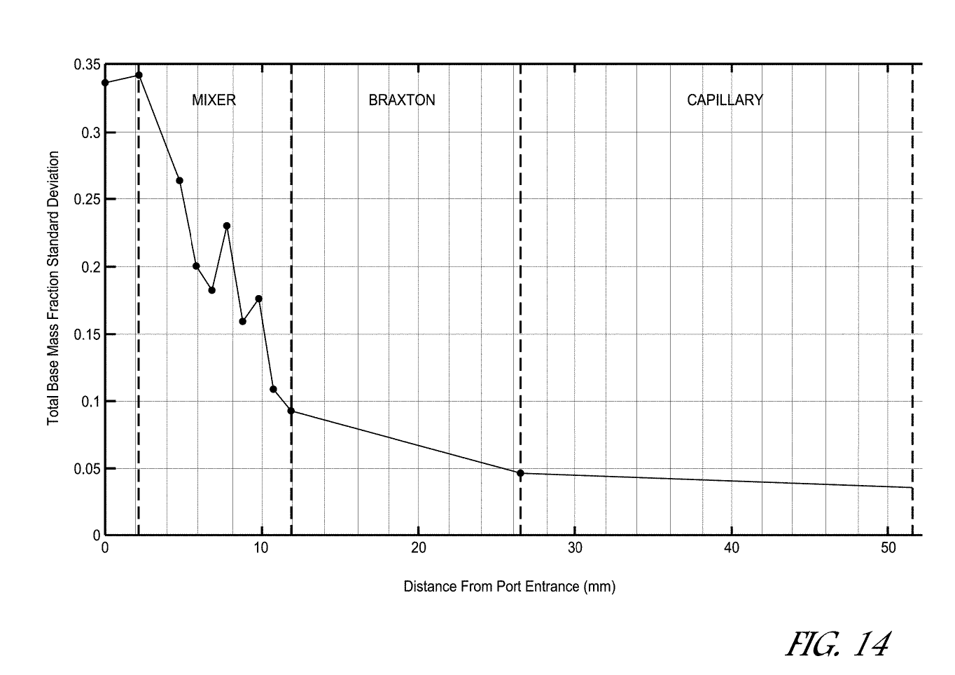

The base mass fraction standard deviation at the outlet for the four designs described in Table 12 are shown in FIG. 13. The final steady state standard deviation values are provided in Table 16. As shown in FIG. 13 and Table 16, the standard deviation for the helical ribbon mixer (Design 2) is less than standard deviation of the stamped ribbon mixer (Design 1) by a factor of 2.1. The standard deviation for a helical ribbon mixer having a multi-stage helical ribbon with an eighth plate element (Design 3) is less than the standard deviation for the helical ribbon mixer with seven plate elements (Design 2) by a factor of 1.75. The standard deviation for a multi-stage helical ribbon mixer with an eighth plate element (Design 4) and a strut is less than the standard deviation for a multi-stage helical ribbon mixer with an eighth plate element but without a strut (Design 3) by a factor of 2.1.

TABLE 16

| | Standard | Base Mass Fraction |
|---|---|---|
| Design | Deviation | Range |
| (1) STAMPED | 0.148 | 0.44 to 0.95 |
| (2) 7-ELEMENT HELICAL | 0.07 | 0.57 to 0.89 |
| RIBBON | | |
| (3) 8-ELEMENT BEVEL | 0.04 | 0.72 to 0.88 |
| (4) 8-ELEMENT BEVEL & | 0.036 | 0.74 to 0.87 |
| STRUT | | |

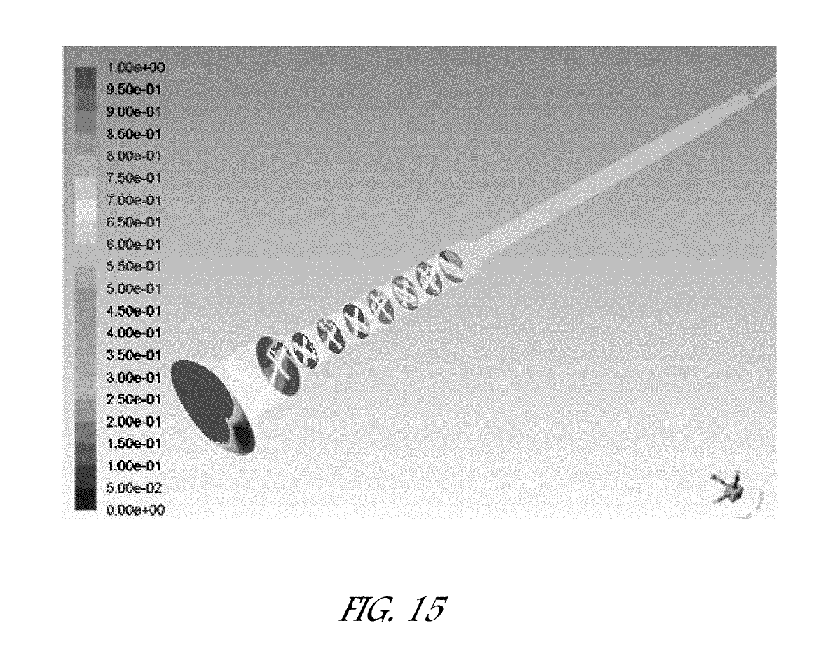

FIG. 14 depicts mixing quality as a function of axial distance for the 8-element multi-sized helical ribbon mixer with beveled post and port strut (Design 4 in Table 12). As shown in FIG. 14, approximately 82.2% of mixing can occur in the static mixer. Approximately, 13.2% of mixing can occur in the reducer conduit. Approximately 4.6% of mixing can occur in the capillary.

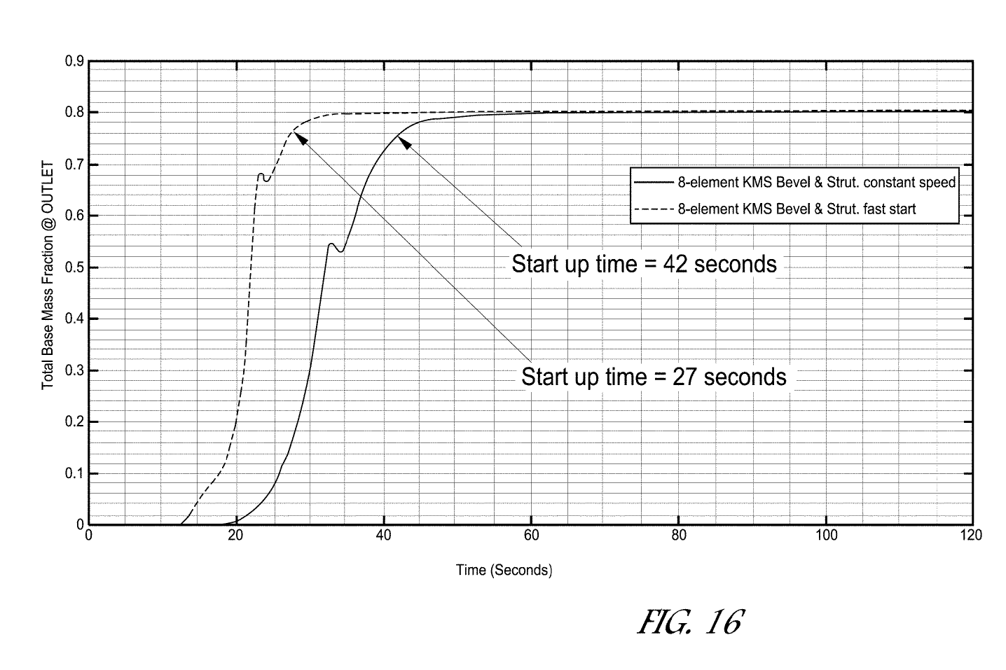

FIG. 15 depicts cross-sectional planes at different axial locations: port exit, the exits of all eight mixer elements, and the exit of the reducer conduit. As shown in FIG. 15, lateral asymmetry can hinder mixing efficiency. In some embodiments, mixing efficiency can be promoted by radially bringing the two component streams together towards the center and then splitting, folding and recombining the flow.

In some embodiments, a “steady state” condition in which the total mass fraction value of the base material is a constant 80% is desirable for a treatment procedure. The duration of time prior to steady state condition (“start up” time) can be a function of several parameters including: internal geometry and how easily air can be expelled from the system; the total volume of the housing; the difference in shear thinning behavior between the two components; and the linear speed of the actuation mechanism. FIG. 16 depicts mixing cartridge start-up profiles for Design 3 and Design 4 for a simulation run using two speeds: a first speed of 1.2 in/min for the first 15 seconds, followed by a second speed of 0.4 in/min.

The housing volume, initially filled with air, can be 0.07 mL, which for a flow rate of 0.12 mL/min (corresponds to 0.4 in/min) can take 35 seconds to fill entirely. As shown in FIG. 16, with respect to Design 4, base material can first exit the capillary at approximately 20 seconds, which may indicate that phase exchange (liquid replacing air) is not entirely binary. Instead, an overlap can occur. For example, in the start-up period, GuttaFlow 2® material can exit the capillary while simultaneously filling the housing dead space that contains air. Table 17 compares the start-up time between the different designs, along with the unusable volume, which comprises both the housing volume and volume dispensed during start up that does not include a base-to-catalyst volume ratio of 4:1.

TABLE 17

| | Start-up | Unusable Volume (mL)/ |
|---|---|---|
| Design | time | % of total volume |
| (1) STAMPED | 56 | 0.112 (37%) |
| (2) 7-ELEMENT HELICAL | 52 | 0.102 (34%) |
| RIBBON | | |
| (3) 8-ELEMENT BEVEL & | 42 | 0.084 (28%) |
| STRUT | | |
| (4) 8-ELEMENT BEVEL & | 27 | 0.096 (32%) |
| STRUT “FAST” | | |

In various embodiments disclosed herein, dimensions and ranges of dimensions are provided for various diameters of components of the systems disclosed herein. It should be appreciated, however, that the components of the system (e.g., the delivery vessels, capillaries, reduction conduits, chambers, etc.) may or may not be circular in cross-section. In various embodiments, system components can be polygonal, elliptical, or any other suitable cross-section. In such embodiments, the dimensions provided for the diameters described herein can correspond to major dimensions of the cross-sectional shape of the components.

Reference throughout this specification to “some embodiments” or “an embodiment” means that a particular feature, structure, element, act, or characteristic described in connection with the embodiment is included in at least one embodiment. Thus, appearances of the phrases “in some embodiments” or “in an embodiment” in various places throughout this specification are not necessarily all referring to the same embodiment and may refer to one or more of the same or different embodiments. Furthermore, the particular features, structures, elements, acts, or characteristics may be combined in any suitable manner (including differently than shown or described) in other embodiments. Further, in various embodiments, features, structures, elements, acts, or characteristics can be combined, merged, rearranged, reordered, or left out altogether. Thus, no single feature, structure, element, act, or characteristic or group of features, structures, elements, acts, or characteristics is necessary or required for each embodiment. All possible combinations and subcombinations are intended to fall within the scope of this disclosure.

As used in this application, the terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Similarly, it should be appreciated that in the above description of embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that any claim require more features than are expressly recited in that claim. Rather, inventive aspects lie in a combination of fewer than all features of any single foregoing disclosed embodiment.

The foregoing description sets forth various example embodiments and other illustrative, but non-limiting, embodiments of the inventions disclosed herein. The description provides details regarding combinations, modes, and uses of the disclosed inventions. Other variations, combinations, modifications, equivalents, modes, uses, implementations, and/or applications of the disclosed features and aspects of the embodiments are also within the scope of this disclosure, including those that become apparent to those of skill in the art upon reading this specification. Additionally, certain objects and advantages of the inventions are described herein. It is to be understood that not necessarily all such objects or advantages may be achieved in any particular embodiment. Thus, for example, those skilled in the art will recognize that the inventions may be embodied or carried out in a manner that achieves or optimizes one advantage or group of advantages as taught herein without necessarily achieving other objects or advantages as may be taught or suggested herein. Also, in any method or process disclosed herein, the acts or operations making up the method or process may be performed in any suitable sequence and are not necessarily limited to any particular disclosed sequence.

1. An apparatus for treating a tooth, the apparatus comprising:
a delivery vessel sized to be inserted into a treatment region of a tooth to deliver a filling material to the treatment region; and
a manifold coupled to a proximal portion of the delivery vessel, the manifold comprising a manifold chamber to receive the filling material therein, wherein the manifold is configured to couple to a device having an activation mechanism configured to apply sufficient pressure so as to cause thinning of the filling material to allow the filling material to flow into the delivery vessel.

2. The apparatus of claim 1, wherein the delivery vessel comprises at least one port positioned at a distal end of the delivery vessel.

3. (canceled)

4. The apparatus of claim 1, wherein the delivery vessel comprises a capillary.

5. The apparatus of claim 4, wherein the capillary comprises a fused silica capillary.

6. The apparatus of claim 4, wherein an internal surface of the capillary is coated with a protective coating.

7.-9. (canceled)

10. The apparatus of claim 4, wherein a diameter of an internal lumen of the capillary is between 200 μm to 250 μm.

11.-12. (canceled)

13. The apparatus of claim 1, wherein the delivery vessel comprises a reduction conduit coupled with a distal portion of the manifold, the reduction conduit having a first diameter at a proximal portion of the reduction conduit and a second diameter at a distal portion of the reduction conduit, the first diameter larger than the second diameter.

14.-16. (canceled)

17. The apparatus of claim 13, wherein the reduction conduit comprises a plurality of segments, extending between a proximal end of the reduction conduit and a distal end of the reduction conduit, wherein there is a reduction in diameter between each adjacent segment between the proximal end of the reduction conduit and the distal end of the reduction conduit.

18.-23. (canceled)

24. The apparatus of claim 1, further comprising a housing having a housing chamber, wherein the housing chamber is configured to hold and supply at least one component of a filling material to the delivery vessel.

25. The apparatus of claim 24, wherein the housing additionally comprises a second housing chamber configured to hold and supply at least a second component of the filling material to the delivery vessel.

26. The apparatus of claim 25, further comprising a mixing system configured to mix the at least one component and the second component to form the filling material.

27.-39. (canceled)

40. The apparatus of claim 1, further comprising the activation mechanism configured to apply pressure to the filling material to drive the filling material to the delivery vessel.

41. The apparatus of claim 40, further comprising a plunger coupled to the activation mechanism.

42. The apparatus of claim 41, wherein the activation mechanism comprises:
a drive element coupled to the plunger; and
a motor coupled to the drive element, the motor configured to drive the drive element to advance the plunger within the apparatus.

43.-138. (canceled)

139. An apparatus for treating a tooth, the apparatus comprising:
a delivery vessel sized to be inserted into a treatment region of a tooth and configured to supply a filling material thereto, the delivery vessel comprising:
a capillary; and
a reduction conduit having a distal end coupled to a proximal portion of the capillary, the reduction conduit being defined by a stepped reduction in diameter between a first segment having a first diameter and a second segment having a second diameter smaller than the first diameter, wherein the first segment is positioned proximal to the second segment.

140.-151. (canceled)

152. The apparatus of claim 139, wherein the first diameter is in a range of 750 microns to 1,000 microns.

153. The apparatus of claim 139, wherein the second diameter is in a range of 100 microns to 1,000 microns.

154. The apparatus of claim 139, wherein a reduction ratio of the first diameter to the second diameter is in a range of 2:1 to 5:1.

155. The apparatus of claim 139, wherein the reduction conduit comprises more than two segments, extending between a proximal end of the reduction conduit and a distal end of the reduction conduit, wherein there is a reduction in diameter between each adjacent segment between the proximal end of the reduction conduit and the distal end of the reduction conduit.

156. The apparatus of claim 139, wherein the reduction conduit comprises one or more tapered regions, each tapered region tapering distally along a length of the reduction conduit.

157. The apparatus of claim 155, wherein the reduction conduit is defined by stepped reductions in diameter between each of the more than two segments of the reduction conduit from the proximal end of the reduction conduit to the distal end of the reduction conduit.

158. The apparatus of claim 155, wherein the more than two segments of the reduction conduit comprise a third segment distal to the second segment and having a third diameter, wherein the second diameter is greater than the third diameter.

159. The apparatus of claim 158, wherein the at least a portion of the capillary is positioned within the third segment of the reduction conduit, wherein the capillary comprises a fourth diameter, wherein the third diameter is greater than the fourth diameter.

160. The apparatus of claim 139, further comprising at least one housing chamber configured to hold and supply at least one component of a filling material to the delivery vessel.

161. The apparatus of claim 160, further comprising a second housing chamber configured to hold and supply at least a second component of the filling material to the delivery vessel.

162. The apparatus of claim 161, further comprising a mixing system configured to mix the at least one component and the second component to form the filling material.

163.-227. (canceled)

228. An apparatus for treating a tooth, the apparatus comprising:
a delivery vessel sized to be inserted into a treatment region of a tooth, the delivery vessel configured to supply a filling material to the treatment region;
a housing chamber configured to hold and supply at least one component of a filling material to the delivery vessel; and
an activation mechanism configured to apply sufficient pressure to the filling material so as to cause thinning of the filling material to allow the filling material to flow into the delivery vessel.

229. The apparatus of claim 228, wherein the activation mechanism comprises a plunger.

230. The apparatus of claim 229, wherein the activation mechanism comprises:
a drive element coupled to the plunger; and
a motor coupled to the drive element, the motor configured to drive the drive element to advance the plunger within the apparatus.

231. The apparatus of claim 228, further comprising a second housing chamber configured to hold and supply at least a second component of the filling material to the delivery vessel.

232. The apparatus of claim 231, further comprising a mixer configured to mix the at least one component and the second component to form the filling material.

233.-305. (canceled)
